(19) United States
(12) Patent Application Publication
(10) Pub. No.: US 2025/0330652 A1
(43) Pub. Date: Oct. 23, 2025

(54) METHOD, APPARATUS, AND MEDIUM FOR VIDEO PROCESSING

(71) Applicants: Douyin Vision Co., Ltd., Beijing (CN); Bytedance Inc., Los Angeles, CA (US)

(72) Inventors: Chaoyi LIN, Beijing (CN); Junru LI, Beijing (CN); Ye-Kui WANG, Los Angeles, CA (US); Kai ZHANG, Los Angeles, CA (US); Li ZHANG, Los Angeles, CA (US); Yue LI, Los Angeles, CA (US)

(21) Appl. No.: 19/258,857

(22) Filed: Jul. 2, 2025

Related U.S. Application Data
(63) Continuation of application No. PCT/CN2023/143508, filed on Dec. 29, 2023.

(30) Foreign Application Priority Data
Jan. 3, 2023 (WO) PCT/CN2023/070117

(51) Int. Cl. H04N 19/80; H04N 19/154; H04N 19/70; H04N 19/85

(52) U.S. Cl. CPC H04N 19/80; H04N 19/154; H04N 19/70; H04N 19/85

(57) ABSTRACT

Embodiments of the present disclosure provide a solution for video processing. A method for video processing is proposed. The method comprises: performing a conversion between a video and a bitstream of the video, wherein at least one neural-network post-processing filter (NNPF) is applied on at least one video unit associated with the video, and the bitstream comprises a first indication indicating whether quality information of the at least one video unit associated with the applying of the at least one NNPF is present in the bitstream.

### CROSS REFERENCE TO RELATED APPLICATIONS

This application is a continuation of International Application No. PCT/CN2023/143508, filed on Dec. 29, 2023, which claims the benefit of International Application No. PCT/CN2023/070117, filed on Jan. 3, 2023. The entire contents of these applications are hereby incorporated by reference in their entireties.

### FIELDS

Embodiments of the present disclosure relates generally to video processing techniques, and more particularly, to a neural-network post-processing filter (NNPF).

### BACKGROUND

In nowadays, digital video capabilities are being applied in various aspects of peoples' lives. Multiple types of video compression technologies, such as MPEG-2, MPEG-4, ITU-TH.263, ITU-TH.264/MPEG-4 Part 10 Advanced Video Coding (AVC), ITU-TH.265 high efficiency video coding (HEVC) standard, versatile video coding (VVC) standard, have been proposed for video encoding/decoding. However, coding quality of video coding techniques is generally expected to be further improved.

### SUMMARY

Embodiments of the present disclosure provide a solution for video processing.

In a first aspect, a method for video processing is proposed. The method comprises: performing a conversion between a video and a bitstream of the video, wherein at least one neural-network post-processing filter (NNPF) is applied on at least one video unit associated with the video, and the bitstream comprises a first indication indicating whether quality information of the at least one video unit associated with the applying of the at least one NNPF is present in the bitstream.

According to the method in accordance with the first aspect of the present disclosure, an indication indicating whether quality information of at least one video unit associated with the applying of the at least one NNPF is present in the bitstream. Compared with the conventional solution, the proposed method can advantageously enable the application of NNPF based on the quality information, and thus the coding quality can be improved.

In a second aspect, an apparatus for video processing is proposed. The apparatus comprises a processor and a non-transitory memory with instructions thereon. The instructions upon execution by the processor, cause the processor to perform a method in accordance with the first aspect of the present disclosure.

In a third aspect, a non-transitory computer-readable storage medium is proposed. The non-transitory computer-readable storage medium stores instructions that cause a processor to perform a method in accordance with the first aspect of the present disclosure.

In a fourth aspect, another non-transitory computer-readable recording medium is proposed. The non-transitory computer-readable recording medium stores a bitstream of a video which is generated by a method performed by an apparatus for video processing. The method comprises: performing a conversion between the video and the bitstream, wherein at least one neural-network post-processing filter (NNPF) is applied on at least one video unit associated with the video, and the bitstream comprises a first indication indicating whether quality information of the at least one video unit associated with the applying of the at least one NNPF is present in the bitstream.

In a fifth aspect, a method for storing a bitstream of a video is proposed. The method comprises: performing a conversion between the video and the bitstream, wherein at least one neural-network post-processing filter (NNPF) is applied on at least one video unit associated with the video, and the bitstream comprises a first indication indicating whether quality information of the at least one video unit associated with the applying of the at least one NNPF is present in the bitstream; and storing the bitstream in a non-transitory computer-readable recording medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 illustrates a block diagram that illustrates an example video coding system, in accordance with some embodiments of the present disclosure;

FIG. 2 illustrates a block diagram that illustrates a first example video encoder, in accordance with some embodiments of the present disclosure;

FIG. 3 illustrates a block diagram that illustrates an example video decoder, in accordance with some embodiments of the present disclosure;

FIG. 4 illustrates an example of raster-scan slice partitioning of a picture;

FIG. 5 illustrates an example of rectangular slice partitioning of a picture;

FIG. 6 illustrates an example of a picture partitioned into tiles and rectangular slices;

FIG. 7 illustrates an example of subpicture partitioning of a picture;

FIG. 8A illustrates an example of CTBs crossing picture borders;

FIG. 8B illustrates a further example of CTBs crossing picture borders;

FIG. 8C illustrates a still further example of CTBs crossing picture borders;

FIG. 9 illustrates an illustration of luma data channels;

FIG. 10 illustrates a flowchart of a method for video processing in accordance with embodiments of the present disclosure; and

FIG. 11 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

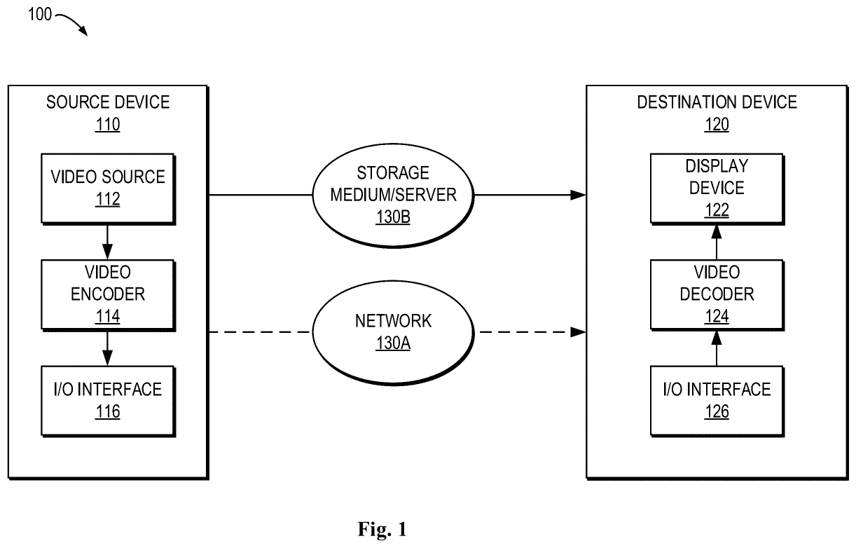

FIG. 1 is a block diagram that illustrates an example video coding system 100 that may utilize the techniques of this disclosure. As shown, the video coding system 100 may include a source device 110 and a destination device 120. The source device 110 can be also referred to as a video encoding device, and the destination device 120 can be also referred to as a video decoding device. In operation, the source device 110 can be configured to generate encoded video data and the destination device 120 can be configured to decode the encoded video data generated by the source device 110. The source device 110 may include a video source 112, a video encoder 114, and an input/output (I/O) interface 116.

The video source 112 may include a source such as a video capture device. Examples of the video capture device include, but are not limited to, an interface to receive video data from a video content provider, a computer graphics system for generating video data, and/or a combination thereof.

The video data may comprise one or more pictures. The video encoder 114 encodes the video data from the video source 112 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. The I/O interface 116 may include a modulator/demodulator and/or a transmitter. The encoded video data may be transmitted directly to destination device 120 via the I/O interface 116 through the network 130A. The encoded video data may also be stored onto a storage medium/server 130B for access by destination device 120.

The destination device 120 may include an I/O interface 126, a video decoder 124, and a display device 122. The I/O interface 126 may include a receiver and/or a modem. The I/O interface 126 may acquire encoded video data from the source device 110 or the storage medium/server 130B. The video decoder 124 may decode the encoded video data. The display device 122 may display the decoded video data to a user. The display device 122 may be integrated with the destination device 120, or may be external to the destination device 120 which is configured to interface with an external display device.

The video encoder 114 and the video decoder 124 may operate according to a video compression standard, such as the High Efficiency Video Coding (HEVC) standard, Versatile Video Coding (VVC) standard and other current and/or further standards.

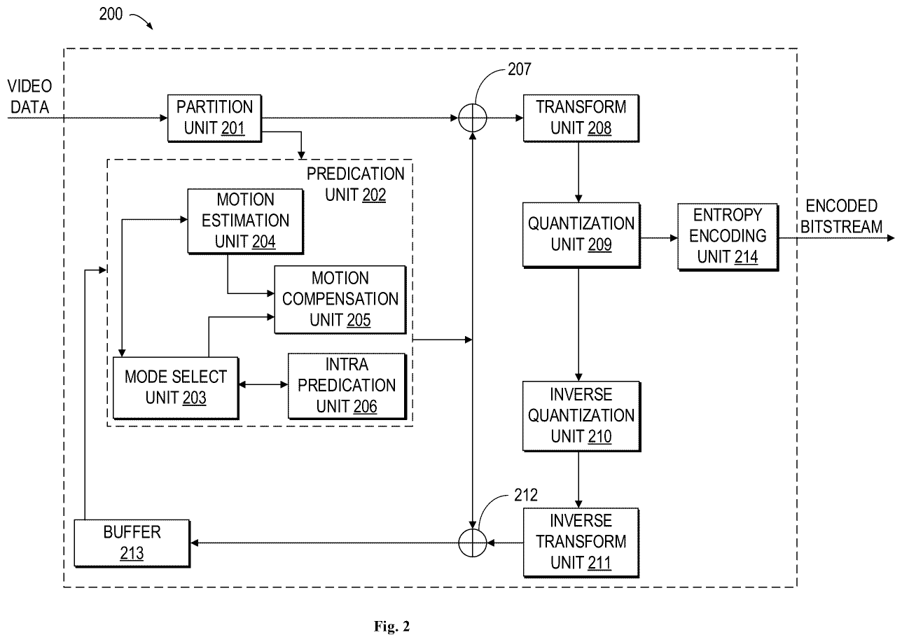

FIG. 2 is a block diagram illustrating an example of a video encoder 200, which may be an example of the video encoder 114 in the system 100 illustrated in FIG. 1, in accordance with some embodiments of the present disclosure.

The video encoder 200 may be configured to implement any or all of the techniques of this disclosure. In the example of FIG. 2, the video encoder 200 includes a plurality of functional components. The techniques described in this disclosure may be shared among the various components of the video encoder 200. In some examples, a processor may be configured to perform any or all of the techniques described in this disclosure.

In some embodiments, the video encoder 200 may include a partition unit 201, a prediction unit 202 which may include a mode select unit 203, a motion estimation unit 204, a motion compensation unit 205 and an intra-prediction unit 206, a residual generation unit 207, a transform unit 208, a quantization unit 209, an inverse quantization unit 210, an inverse transform unit 211, a reconstruction unit 212, a buffer 213, and an entropy encoding unit 214.

In other examples, the video encoder 200 may include more, fewer, or different functional components. In an example, the prediction unit 202 may include an intra block copy (IBC) unit. The IBC unit may perform prediction in an IBC mode in which at least one reference picture is a picture where the current video block is located.

Furthermore, although some components, such as the motion estimation unit 204 and the motion compensation unit 205, may be integrated, but are represented in the example of FIG. 2 separately for purposes of explanation.

The partition unit 201 may partition a picture into one or more video blocks. The video encoder 200 and the video decoder 300 may support various video block sizes.

The mode select unit 203 may select one of the coding modes, intra or inter, e.g., based on error results, and provide the resulting intra-coded or inter-coded block to a residual generation unit 207 to generate residual block data and to a reconstruction unit 212 to reconstruct the encoded block for use as a reference picture. In some examples, the mode select unit 203 may select a combination of intra and inter prediction (CIIP) mode in which the prediction is based on an inter prediction signal and an intra prediction signal. The mode select unit 203 may also select a resolution for a motion vector (e.g., a sub-pixel or integer pixel precision) for the block in the case of inter-prediction.

To perform inter prediction on a current video block, the motion estimation unit 204 may generate motion information for the current video block by comparing one or more reference frames from buffer 213 to the current video block. The motion compensation unit 205 may determine a predicted video block for the current video block based on the motion information and decoded samples of pictures from the buffer 213 other than the picture associated with the current video block.

The motion estimation unit 204 and the motion compensation unit 205 may perform different operations for a current video block, for example, depending on whether the current video block is in an I-slice, a P-slice, or a B-slice. As used herein, an “I-slice” may refer to a portion of a picture composed of macroblocks, all of which are based upon macroblocks within the same picture. Further, as used herein, in some aspects, “P-slices” and “B-slices” may refer to portions of a picture composed of macroblocks that are not dependent on macroblocks in the same picture.

In some examples, the motion estimation unit 204 may perform uni-directional prediction for the current video block, and the motion estimation unit 204 may search reference pictures of list 0 or list 1 for a reference video block for the current video block. The motion estimation unit 204 may then generate a reference index that indicates the reference picture in list 0 or list 1 that contains the reference video block and a motion vector that indicates a spatial displacement between the current video block and the reference video block. The motion estimation unit 204 may output the reference index, a prediction direction indicator, and the motion vector as the motion information of the current video block. The motion compensation unit 205 may generate the predicted video block of the current video block based on the reference video block indicated by the motion information of the current video block.

Alternatively, in other examples, the motion estimation unit 204 may perform bi-directional prediction for the current video block. The motion estimation unit 204 may search the reference pictures in list 0 for a reference video block for the current video block and may also search the reference pictures in list 1 for another reference video block for the current video block. The motion estimation unit 204 may then generate reference indexes that indicate the reference pictures in list 0 and list 1 containing the reference video blocks and motion vectors that indicate spatial displacements between the reference video blocks and the current video block. The motion estimation unit 204 may output the reference indexes and the motion vectors of the current video block as the motion information of the current video block. The motion compensation unit 205 may generate the predicted video block of the current video block based on the reference video blocks indicated by the motion information of the current video block.

In some examples, the motion estimation unit 204 may output a full set of motion information for decoding processing of a decoder. Alternatively, in some embodiments, the motion estimation unit 204 may signal the motion information of the current video block with reference to the motion information of another video block. For example, the motion estimation unit 204 may determine that the motion information of the current video block is sufficiently similar to the motion information of a neighboring video block.

In one example, the motion estimation unit 204 may indicate, in a syntax structure associated with the current video block, a value that indicates to the video decoder 300 that the current video block has the same motion information as the another video block.

In another example, the motion estimation unit 204 may identify, in a syntax structure associated with the current video block, another video block and a motion vector difference (MVD). The motion vector difference indicates a difference between the motion vector of the current video block and the motion vector of the indicated video block. The video decoder 300 may use the motion vector of the indicated video block and the motion vector difference to determine the motion vector of the current video block.

As discussed above, video encoder 200 may predictively signal the motion vector. Two examples of predictive signaling techniques that may be implemented by video encoder 200 include advanced motion vector prediction (AMVP) and merge mode signaling.

The intra prediction unit 206 may perform intra prediction on the current video block. When the intra prediction unit 206 performs intra prediction on the current video block, the intra prediction unit 206 may generate prediction data for the current video block based on decoded samples of other video blocks in the same picture. The prediction data for the current video block may include a predicted video block and various syntax elements.

The residual generation unit 207 may generate residual data for the current video block by subtracting (e.g., indicated by the minus sign) the predicted video block(s) of the current video block from the current video block. The residual data of the current video block may include residual video blocks that correspond to different sample components of the samples in the current video block.

In other examples, there may be no residual data for the current video block for the current video block, for example in a skip mode, and the residual generation unit 207 may not perform the subtracting operation.

The transform processing unit 208 may generate one or more transform coefficient video blocks for the current video block by applying one or more transforms to a residual video block associated with the current video block.

After the transform processing unit 208 generates a transform coefficient video block associated with the current video block, the quantization unit 209 may quantize the transform coefficient video block associated with the current video block based on one or more quantization parameter (QP) values associated with the current video block.

The inverse quantization unit 210 and the inverse transform unit 211 may apply inverse quantization and inverse transforms to the transform coefficient video block, respectively, to reconstruct a residual video block from the transform coefficient video block. The reconstruction unit 212 may add the reconstructed residual video block to corresponding samples from one or more predicted video blocks generated by the prediction unit 202 to produce a reconstructed video block associated with the current video block for storage in the buffer 213.

After the reconstruction unit 212 reconstructs the video block, loop filtering operation may be performed to reduce video blocking artifacts in the video block.

The entropy encoding unit 214 may receive data from other functional components of the video encoder 200. When the entropy encoding unit 214 receives the data, the entropy encoding unit 214 may perform one or more entropy encoding operations to generate entropy encoded data and output a bitstream that includes the entropy encoded data.

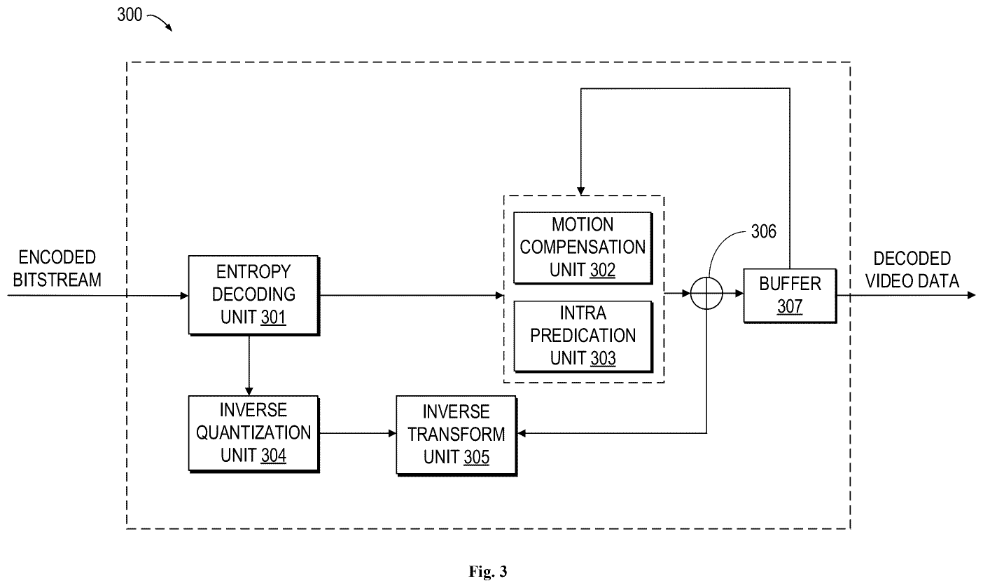

FIG. 3 is a block diagram illustrating an example of a video decoder 300, which may be an example of the video decoder 124 in the system 100 illustrated in FIG. 1, in accordance with some embodiments of the present disclosure.

The video decoder 300 may be configured to perform any or all of the techniques of this disclosure. In the example of FIG. 3, the video decoder 300 includes a plurality of functional components. The techniques described in this disclosure may be shared among the various components of the video decoder 300. In some examples, a processor may be configured to perform any or all of the techniques described in this disclosure.

In the example of FIG. 3, the video decoder 300 includes an entropy decoding unit 301, a motion compensation unit 302, an intra prediction unit 303, an inverse quantization unit 304, an inverse transformation unit 305, and a reconstruction unit 306 and a buffer 307. The video decoder 300 may, in some examples, perform a decoding pass generally reciprocal to the encoding pass described with respect to video encoder 200.

The entropy decoding unit 301 may retrieve an encoded bitstream. The encoded bitstream may include entropy coded video data (e.g., encoded blocks of video data). The entropy decoding unit 301 may decode the entropy coded video data, and from the entropy decoded video data, the motion compensation unit 302 may determine motion information including motion vectors, motion vector precision, reference picture list indexes, and other motion information. The motion compensation unit 302 may, for example, determine such information by performing the AMVP and merge mode. AMVP is used, including derivation of several most probable candidates based on data from adjacent PBs and the reference picture. Motion information typically includes the horizontal and vertical motion vector displacement values, one or two reference picture indices, and, in the case of prediction regions in B slices, an identification of which reference picture list is associated with each index. As used herein, in some aspects, a “merge mode” may refer to deriving the motion information from spatially or temporally neighboring blocks.

The motion compensation unit 302 may produce motion compensated blocks, possibly performing interpolation based on interpolation filters. Identifiers for interpolation filters to be used with sub-pixel precision may be included in the syntax elements.

The motion compensation unit 302 may use the interpolation filters as used by the video encoder 200 during encoding of the video block to calculate interpolated values for sub-integer pixels of a reference block. The motion compensation unit 302 may determine the interpolation filters used by the video encoder 200 according to the received syntax information and use the interpolation filters to produce predictive blocks.

The motion compensation unit 302 may use at least part of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter-encoded block, and other information to decode the encoded video sequence. As used herein, in some aspects, a “slice” may refer to a data structure that can be decoded independently from other slices of the same picture, in terms of entropy coding, signal prediction, and residual signal reconstruction. A slice can either be an entire picture or a region of a picture.

The intra prediction unit 303 may use intra prediction modes for example received in the bitstream to form a prediction block from spatially adjacent blocks. The inverse quantization unit 304 inverse quantizes, i.e., de-quantizes, the quantized video block coefficients provided in the bitstream and decoded by entropy decoding unit 301. The inverse transform unit 305 applies an inverse transform.

The reconstruction unit 306 may obtain the decoded blocks, e.g., by summing the residual blocks with the corresponding prediction blocks generated by the motion compensation unit 302 or intra-prediction unit 303. If desired, a deblocking filter may also be applied to filter the decoded blocks in order to remove blockiness artifacts. The decoded video blocks are then stored in the buffer 307, which provides reference blocks for subsequent motion compensation/intra prediction and also produces decoded video for presentation on a display device.

Some exemplary embodiments of the present disclosure will be described in detailed hereinafter. It should be understood that section headings are used in the present document to facilitate ease of understanding and do not limit the embodiments disclosed in a section to only that section. Furthermore, while certain embodiments are described with reference to Versatile Video Coding or other specific video codecs, the disclosed techniques are applicable to other video coding technologies also. Furthermore, while some embodiments describe video coding steps in detail, it will be understood that corresponding steps decoding that undo the coding will be implemented by a decoder. Furthermore, the term video processing encompasses video coding or compression, video decoding or decompression and video transcoding in which video pixels are represented from one compressed format into another compressed format or at a different compressed bitrate.

### 1. Brief Summary

This disclosure is related to image/video coding technologies. Specifically, it is related to usage and controlling for neural network post processing filters signaled in a video bitstream. Herein usage and controlling can be applied in a video unit (e.g., picture/slice/CTU). The ideas may be applied individually or in various combinations, for video bitstreams coded by any codec, e.g., the versatile video coding (VVC) standard and/or the versatile SEI messages for coded video bitstreams (VSEI) standard.

### 2. Abbreviations

APS Adaptation Parameter Set
AU Access Unit
CLVS Coded Layer Video Sequence
CLVSS Coded Layer Video Sequence Start
CRC Cyclic Redundancy Check
CVS Coded Video Sequence
FIR Finite Impulse Response
IRAP Intra Random Access Point
NAL Network Abstraction Layer
PPS Picture Parameter Set
PU Picture Unit
RASL Random Access Skipped Leading
SEI Supplemental Enhancement Information
STSA Step-wise Temporal Sublayer Access
VCL Video Coding Layer
VSEI versatile supplemental enhancement information (Rec. ITU-T H.274|ISO/IEC 23002-7)
VUI Video Usability Information
VVC versatile video coding (Rec. ITU-T H.266|ISO/IEC 23090-3)

### 3. Introduction

### 3.1. Video Coding Standards

Video coding standards have evolved primarily through the development of the well-known ITU-T and ISO/IEC standards. The ITU-T produced H.261 and H.263, ISO/IEC produced MPEG-1 and MPEG-4 Visual, and the two organizations jointly produced the H.262/MPEG-2 Video and H.264/MPEG-4 Advanced Video Coding (AVC) and H.265/HEVC standards. Since H.262, the video coding standards are based on the hybrid video coding structure wherein temporal prediction plus transform coding are utilized. To explore the future video coding technologies beyond HEVC, the Joint Video Exploration Team (JVET) was founded by VCEG and MPEG jointly in 2015. Since then, many new methods have been adopted by JVET and put into the reference software named Joint Exploration Model (JEM). The JVET was later renamed to be the Joint Video Experts Team (JVET) when the Versatile Video Coding (VVC) project officially started. VVC is the new coding standard, targeting at 50% bitrate reduction as compared to HEVC, that has been finalized by the JVET at its 19th meeting ended at Jul. 1, 2020.

The Versatile Video Coding (VVC) standard (ITU-T H.266|ISO/IEC 23090-3) and the associated Versatile Supplemental Enhancement Information for coded video bitstreams (VSEI) standard (ITU-T H.274|ISO/IEC 23002-7) have been designed for use in a maximally broad range of applications, including both the traditional uses such as television broadcast, video conferencing, or playback from storage media, and also newer and more advanced use cases such as adaptive bit rate streaming, video region extraction, composition and merging of content from multiple coded video bitstreams, multiview video, scalable layered coding, and viewport-adaptive 360° immersive media.

The Essential Video Coding (EVC) standard (ISO/IEC 23094-1) is another video coding standard that has recently been developed by MPEG.

### 3.2 Definitions of Video Units

A picture is divided into one or more tile rows and one or more tile columns. A tile is a sequence of CTUs that covers a rectangular region of a picture. The CTUs in a tile are scanned in raster scan order within that tile.

A slice consists of an integer number of complete tiles or an integer number of consecutive complete CTU rows within a tile of a picture. Consequently, each vertical slice boundary is always also a vertical tile boundary. It is possible that a horizontal boundary of a slice is not a tile boundary but consists of horizontal CTU boundaries within a tile: this occurs when a tile is split into multiple rectangular slices, each of which consists of an integer number of consecutive complete CTU rows within the tile.

Two modes of slices are supported, namely the raster-scan slice mode and the rectangular slice mode. In the raster-scan slice mode, a slice contains a sequence of complete tiles in a tile raster scan of a picture. In the rectangular slice mode, a slice contains either a number of complete tiles that collectively form a rectangular region of the picture or a number of consecutive complete CTU rows of one tile that collectively form a rectangular region of the picture. Tiles within a rectangular slice are scanned in tile raster scan order within the rectangular region corresponding to that slice.

A subpicture contains one or more slices that collectively cover a rectangular region of a picture. Consequently, each subpicture boundary is also always a slice boundary, and each vertical subpicture boundary is always also a vertical tile boundary.

One or both of the following conditions shall be fulfilled for each subpicture and tile:
All CTUs in a subpicture belong to the same tile.
All CTUs in a tile belong to the same subpicture.

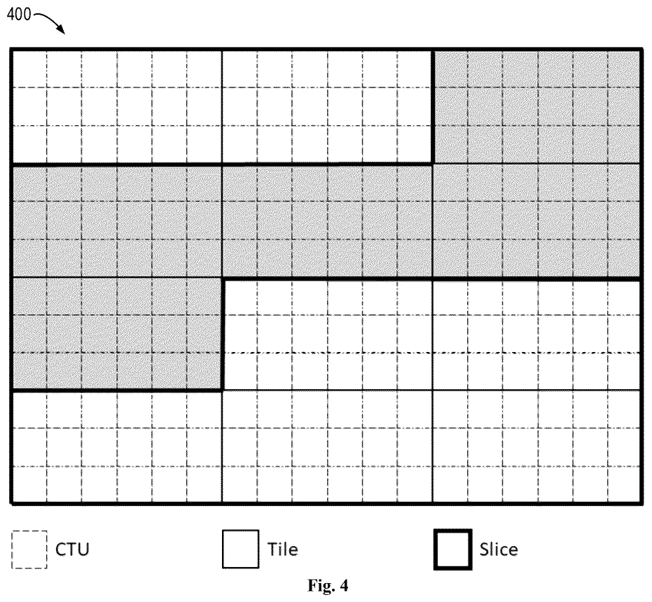

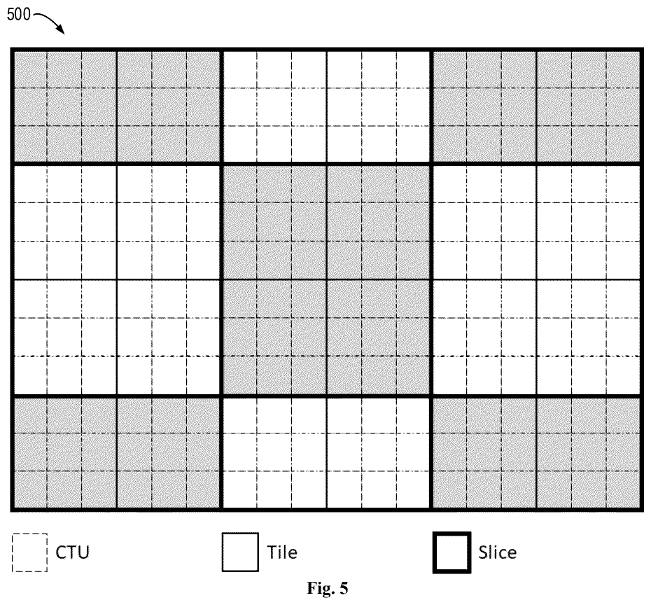

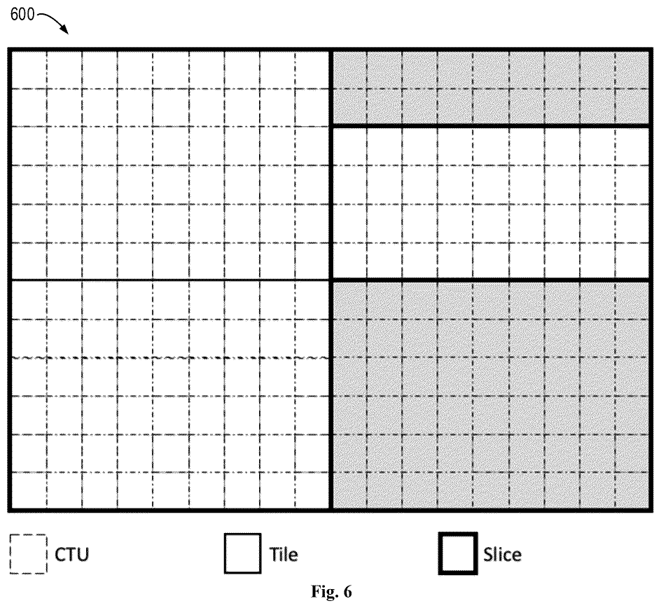

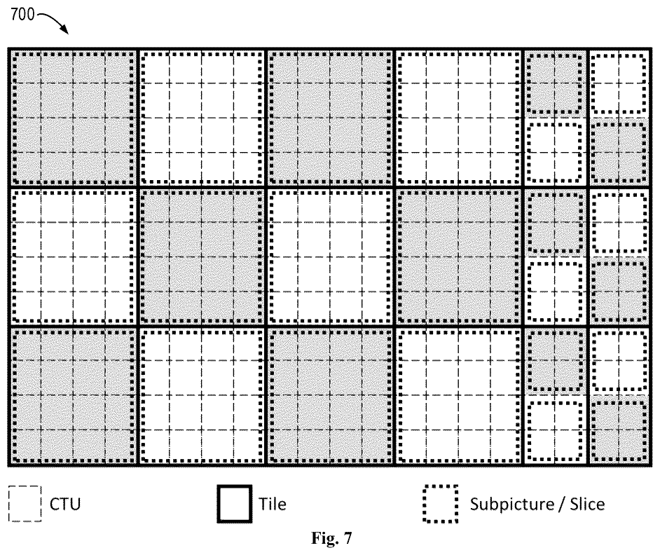

FIG. 4 shows an example of raster-scan slice partitioning of a picture, where the picture is divided into 12 tiles and 3 raster-scan slices. More specifically, a picture with 18 by 12 luma CTUs is partitioned into 12 tiles and 3 raster-scan slices. FIG. 5 shows an example of rectangular slice partitioning of a picture, where the picture is divided into 24 tiles (6 tile columns and 4 tile rows) and 9 rectangular slices. More specifically, a picture with 18 by 12 luma CTUs is partitioned into 24 tiles and 9 rectangular slices. FIG. 6 shows an example of a picture partitioned into tiles and rectangular slices, where the picture is divided into 4 tiles (2 tile columns and 2 tile rows) and 4 rectangular slices. FIG. 7 shows an example of subpicture partitioning of a picture, where a picture is partitioned into 18 tiles, 12 tiles on the left-hand side each covering one slice of 4 by 4 CTUs and 6 tiles on the right-hand side each covering 2 vertically-stacked slices of 2 by 2 CTUs, altogether resulting in 24 slices and 24 subpictures of varying dimensions (each slice is a subpicture).

### 3.2.1. CTU/CTB Sizes

In VVC, the CTU size, signaled in SPS by the syntax element log2_ctu_size_minus2, could be as small as 4×4.

7.3.2.3 Sequence parameter set RBSP syntax

| | Descriptor |
|---|---|
| seq_parameter_set_rbsp( ) { | |
| sps_{—}decoding_{—}parameter_{—}set_{—}id | u(4) |
| sps_{—}video_{—}parameter_{—}set_{—}id | u(4) |
| sps_{—}max_{—}sub_{—}layers_{—}minus1 | u(3) |
| sps_{—}reserved_{—}zero_{—}5bits | u(5) |
| profile_tier_level( sps_max_sub_layers_minus1 ) | |
| gra_{—}enabled_{—}flag | u(1) |
| sps_{—}seq_{—}parameter_{—}set_{—}id | ue(v) |
| chroma_{—}format_{—}idc | ue(v) |
| if( chroma_format_idc = = 3 ) | |
| separate_{—}colour_{—}plane_{—}flag | u(1) |
| pic_{—}width_{—}in_{—}luma_{—}samples | ue(v) |
| pic_{—}height_{—}in_{—}luma_{—}samples | ue(v) |
| conformance_{—}window_{—}flag | u(1) |
| if( conformance_window_flag ) { | |
| conf_{—}win_{—}left_{—}offset | ue(v) |
| conf_{—}win_{—}right_{—}offset | ue(v) |
| conf_{—}win_{—}top_{—}offset | ue(v) |
| conf_{—}win_{—}bottom_{—}offset | ue(v) |
| } | |
| bit_{—}depth_{—}luma_{—}minus8 | ue(v) |
| bit_{—}depth_{—}chroma_{—}minus8 | ue(v) |
| log2_{—}max_{—}pic_{—}order_{—}cnt_{—}lsb_{—}minus4 | ue(v) |
| sps_{—}sub_{—}layer_{—}ordering_{—}info_{—}present_{—}flag | u(1) |
| for( i = ( sps_sub_layer_ordering_info_present_flag ? 0 : | |
| sps_max_sub_layers_minus1 ); | |
| i <= sps_max_sub_layers_minus1; i++ ) { | |
| sps_{—}max_{—}dec_{—}pic_{—}buffering_{—}minus1[ i ] | ue(v) |
| sps_{—}max_{—}num_{—}reorder_{—}pics[ i ] | ue(v) |
| sps_{—}max_{—}latency_{—}increase_{—}plus1[ i ] | ue(v) |
| } | |
| long_{—}term_{—}ref_{—}pics_{—}flag | u(1) |
| sps_{—}idr_{—}rpl_{—}present_{—}flag | u(1) |
| rpl1_{—}same_{—}as_{—}rpl0_{—}flag | u(1) |
| for( i= 0; i < !rpl1_same_as_rpl0_flag ? 2 : 1; i++ ) { | |
| num_{—}ref_{—}pic_{—}lists_{—}in_{—}sps[ i ] | ue(v) |
| for( j = 0; j < num_ref_pic_lists_in_sps[ i ]; j++) | |
| ref_pic_list_struct( i, j ) | |
| } | |
| qtbtt_{—}dual_{—}tree_{—}intra_{—}flag | u(1) |
| log2_{—}ctu_{—}size_{—}minus2 | ue(v) |
| log2_{—}min_{—}luma_{—}coding_{—}block_{—}size_{—}minus2 | ue(v) |
| partition_{—}constraints_{—}override_{—}enabled_{—}flag | u(1) |
| sps_{—}log2_{—}diff_{—}min_{—}qt_{—}min_{—}cb_{—}intra_{—}slice_{—}luma | ue(v) |
| sps_{—}log2_{—}diff_{—}min_{—}qt_{—}min_{—}cb_{—}inter_{—}slice | ue(v) |
| sps_{—}max_{—}mtt_{—}hierarchy_{—}depth_{—}inter_{—}slice | ue(v) |
| sps_{—}max_{—}mtt_{—}hierarchy_{—}depth_{—}intra_{—}slice_{—}luma | ue(v) |
| if( sps_max_mtt_hierarchy_depth_intra_slice_luma != 0 ) { | |
| sps_{—}log2_{—}diff_{—}max_{—}bt_{—}min_{—}qt_{—}intra_{—}slice_{—}luma | ue(v) |
| sps_{—}log2_{—}diff_{—}max_{—}tt_{—}min_{—}qt_{—}intra_{—}slice_{—}luma | ue(v) |
| } | |
| if( sps_max_mtt_hierarchy_depth_inter_slices != 0 ) { | |
| sps_{—}log2_{—}diff_{—}max_{—}bt_{—}min_{—}qt_{—}inter_{—}slice | ue(v) |
| sps_{—}log2_{—}diff_{—}max_{—}tt_{—}min_{—}qt_{—}inter_{—}slice | ue(v) |
| } | |
| if( qtbtt_dual_tree_intra_flag ) { | |
| sps_{—}log2_{—}diff_{—}min_{—}qt_{—}min_{—}cb_{—}intra_{—}slice_{—}chroma | ue(v) |
| sps_{—}max_{—}mtt_{—}hierarchy_{—}depth_{—}intra_{—}slice_{—}chroma | ue(v) |
| if ( sps_max_mtt_hierarchy_depth_intra_slice_chroma != 0 ) { | |
| sps_{—}log2_{—}diff_{—}max_{—}bt_{—}min_{—}qt_{—}intra_{—}slice_{—}chroma | ue(v) |
| sps_{—}log2_{—}diff_{—}max_{—}tt_{—}min_{—}qt_{—}intra_{—}slice_{—}chroma | ue(v) |
| } | |
| } | |
| ... | |
| rbsp_trailing_bits( ) | |
| } | |

log2_{—}ctu_{—}size_{—}minus2 plus 2 specifies the luma coding tree block size of each CTU.
log2_{—}min_{—}luma_{—}coding_{—}block_{—}size_{—}minus2 plus 2 specifies the minimum luma coding block size.
The variables CtbLog2SizeY, CtbSizeY, MinCbLog2SizeY, MinCbSizeY, MinTbLog2SizeY,
MaxTbLog2SizeY, MinTbSizeY, MaxTbSizeY, PicWidthInCtbsY, PicHeightInCtbsY, PicSizeInCtbsY,
PicWidthInMinCbsY, PicHeightInMinCbsY, PicSizeInMinCbsY, PicSizeInSamplesY,
PicWidthInSamplesC and PicHeightInSamplesC are derived as follows.

| | |
|---|---|
| CtbLog2SizeY = log2_ctu_size_minus2 + 2 | (7-9) |
| CtbSizeY = 1 << CtbLog2SizeY | (7-10) |
| MinCbLog2SizeY = log2_min_luma_coding_block_size_minus2 + 2 | (7-11) |

| | |
|---|---|
| MinCbSizeY = 1 << MinCbLog2SizeY | (7-12) |
| MinTbLog2SizeY = 2 | (7-13) |

| | |
|---|---|
| MaxTbLog2SizeY = 6 | (7-14) |
| MinTbSizeY = 1 << MinTbLog2SizeY | (7-15) |
| MaxTbSizeY = 1 << MaxTbLog2SizeY | (7-16) |
| PicWidthInCtbsY = Ceil( pic_width_in_luma_samples ÷ CtbSizeY ) | (7-17) |
| PicHeightInCtbsY = Ceil( pic_height_in_luma_samples ÷ CtbSizeY ) | (7-18) |
| PicSizeInCtbsY = PicWidthInCtbsY * PicHeightInCtbsY | (7-19) |
| PicWidthInMinCbsY = pic_width_in_luma_samples / MinCbSizeY | (7-20) |
| PicHeightInMinCbsY = pic_height_in_luma_samples / MinCbSizeY | (7-21) |
| PicSizeInMinCbsY = PicWidthInMinCbsY * PicHeightInMinCbsY | (7-22) |
| PicSizeInSamplesY = pic_width_in_luma_samples * pic_height_in_luma_samples | (7-23) |
| PicWidthInSamplesC = pic_width_in_luma_samples / SubWidthC | (7-24) |
| PicHeightInSamplesC = pic_height_in_luma_samples / SubHeightC | (7-25) |

### 3.2.2. CTUs in a Picture

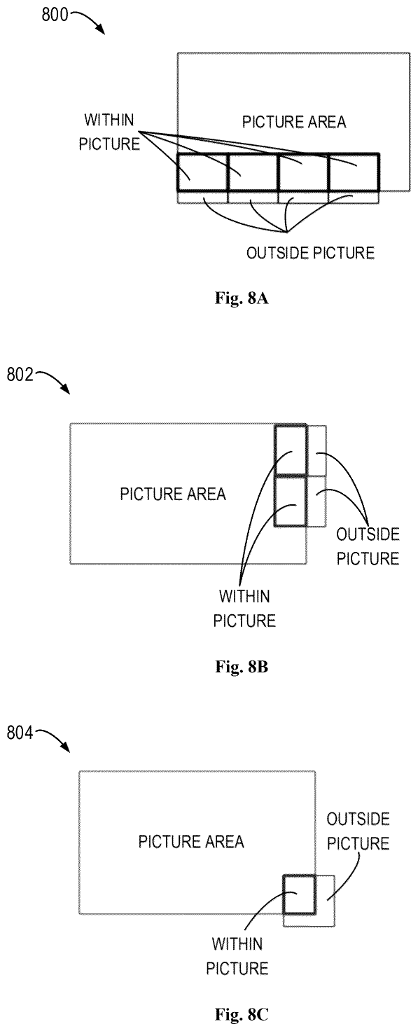

Suppose the CTB/LCU size indicated by M×N (typically M is equal to N, as defined in HEVC/VVC), and for a CTB located at picture (or tile or slice or other kinds of types, picture border is taken as an example) border, K×L samples are within picture border wherein either K<M or L<N. For those CTBs as depicted in FIGS. 8A-8C, the CTB size is still equal to M×N, however, the bottom boundary/right boundary of the CTB is outside the picture. FIG. 8A is a diagram 800 illustrating an example of CTBs crossing picture borders, where K=M, L<N, and CTBs cross the bottom picture border. FIG. 8B is a diagram 802 illustrating a further example of CTBs crossing picture borders, where K<M, L=N, and CTBs cross the right picture border. FIG. 8C is a diagram 804 illustrating a still further example of CTBs crossing picture borders, where K<M, L<N and CTBs cross the right bottom picture border.

### 3.3 SEI Messages in General and in VVC and VSEI

SEI messages assist in processes related to decoding, display or other purposes. However, SEI messages are not required for constructing the luma or chroma samples by the decoding process. Conforming decoders are not required to process this information for output order conformance. Some SEI messages are required for checking bitstream conformance and for output timing decoder conformance. Other SEI messages are not required for check bitstream conformance.

Annex D of VVC specifies syntax and semantics for SEI message payloads for some SEI messages, and specifies the use of the SEI messages and VUI parameters for which the syntax and semantics are specified in ITU-T H.274 | ISO/IEC 23002-7.

### 3.4. Signalling of Neural-Network Post-Filters

An existing design includes the specification of two SEI messages for signalling of neural-network post-filters, as follows.

### 8.28 Neural-Network Post-Filter Characteristics SEI Message

### 8.28.1 Neural-Network Post-Filter Characteristics SEI Message Syntax

| | Descriptor |
|---|---|
| nn_post_filter_characteristics( payloadSize ) { | |
| nnpfc_{—}id | ue(v) |
| nnpfc_{—}mode_{—}idc | ue(v) |
| nnpfc_{—}purpose_{—}and_{—}formatting_{—}flag | u(1) |
| if( nnpfc_purpose_and_formatting_flag ) { | |
| nnpfc_{—}purpose | ue(v) |
| if( nnpfc_purpose = = 2 \|\| nnpfc_purpose = = 4 ) | |
| nnpfc_{—}out_{—}sub_{—}c_{—}flag | u(1) |
| if( nnpfc_purpose = = 3 \|\| nnpfc_purpose = = 4 ) { | |
| nnpfc_{—}pic_{—}width_{—}in_{—}luma_{—}samples | ue(v) |
| nnpfc_{—}pic_{—}height_{—}in_{—}luma_{—}samples | ue(v) |
| } | |
| nnpfc_{—}component_{—}last_{—}flag | u(1) |
| nnpfc_{—}inp_{—}format_{—}flag | u(1) |
| if( nnpfc_inp_format_flag = = 1 ) | |
| nnpfc_{—}inp_{—}tensor_{—}bitdepth_{—}minus8 | ue(v) |
| nnpfc_{—}inp_{—}order_{—}idc | ue(v) |
| nnpfc_{—}auxiliary_{—}inp_{—}idc | ue(v) |
| nnpfc_{—}separate_{—}colour_{—}description_{—}present_{—}flag | u(1) |
| if( nnpfc_separate_colour_description_present_flag ) | |
| { | |
| nnpfc_{—}colour_{—}primaries | u(8) |
| nnpfc_{—}transfer_{—}characteristics | u(8) |
| nnpfc_{—}matrix_{—}coeffs | u(8) |
| } | |
| nnpfc_{—}out_{—}format_{—}flag | u(1) |
| if( nnpfc_out_format_flag = = 1 ) | |
| nnpfc_{—}out_{—}tensor_{—}bitdepth_{—}minus8 | ue(v) |
| nnpfc_{—}out_{—}order_{—}idc | ue(v) |
| nnpfc_{—}constant_{—}patch_{—}size_{—}flag | u(1) |
| nnpfc_{—}patch_{—}width_{—}minus1 | ue(v) |
| nnpfc_{—}patch_{—}height_{—}minus1 | ue(v) |
| nnpfc_{—}overlap | ue(v) |
| nnpfc_{—}padding_{—}type | ue(v) |
| if( nnpfc_padding_type = = 4 ){ | |
| nnpfc_{—}luma_{—}padding_{—}val | ue(v) |
| nnpfc_{—}cb_{—}padding_{—}val | ue(v) |
| nnpfc_{—}cr_{—}padding_{—}val | ue(v) |
| } | |
| nnpfc_{—}complexity_{—}idc | ue(v) |
| if( nnpfc_complexity_idc > 0 ) | |
| nnpfc_complexity_element( nnpfc_complexity_idc ) | |
| if( nnpfc_mode_idc = = 2 ) { | |
| while( !byte_aligned( ) ) | |
| nnpfc_{—}reserved_{—}zero_{—}bit | u(1) |
| nnpfc_{—}uri_{—}tag[ i ] | st(v) |
| nnpfc_{—}uri[ i ] | st(v) |
| } | |
| } | |
| /* filter specified or updated by ISO/IEC 15938-17 | |
| bitstream */ | |
| if( nnpfc_mode_idc = = 1 ) { | |
| while( !byte_aligned( ) ) | |
| nnpfc_{—}reserved_{—}zero_{—}bit | u(1) |
| for( i = 0; more_data_in_payload( ); i++ ) | |
| nnpfc_{—}payload_{—}byte[ i ] | b(8) |
| } | |
| } | |

| | Descriptor |
|---|---|
| nnpfc_complexity_element( nnpfc_complexity_idc ) { | |
| if( nnpfc_complexity_idc = = 1 ) { | |
| nnpfc_{—}parameter_{—}type_{—}idc | u(2) |
| if (nnpfc_parameter_type_idc ! = 2) | |
| nnpfc_{—}log2_{—}parameter_{—}bit_{—}length_{—}minus3 | u(2) |
| nnpfc_{—}num_{—}parameters_{—}idc | u(6) |
| nnpfc_{—}num_{—}kmac_{—}operations_{—}idc | ue(v) |
| } | |
| } | |

### 8.28.2 Neural-Network Post-Filter Characteristics SEI Message Semantics

This SEI message specifies a neural network that may be used as a post-processing filter. The use of specified post-processing filters for specific pictures is indicated with neural-network post-filter activation SEI messages.

Use of this SEI message requires the definition of the following variables:
Cropped decoded output picture width and height in units of luma samples, denoted herein by CroppedWidth and CroppedHeight, respectively.
Luma sample array CroppedYPic[x][y] and chroma sample arrays CroppedCbPic[x][y] and CroppedCrPic[x][y], when present, of the cropped decoded output picture for vertical coordinates y and horizontal coordinates x, where the top-left corner of the sample array has coordinates y equal to 0 and x equal to 0.
Bit depth BitDepthy for the luma sample array of the cropped decoded output picture.
Bit depth BitDepthc for the chroma sample arrays, if any, of the cropped decoded output picture.
A chroma format indicator, denoted herein by ChromaFormatIdc, as described in clause 7.3.
When nnpfc_auxiliary_inp_idc is equal to 1, a quantization strength value StrengthControlVal.

When this SEI message specifies a neural network that may be used as a post-processing filter, the semantics specify the derivation of the luma sample array Filtered YPic[x][y] and chroma sample arrays FilteredCbPic[x][y] and FilteredCrPic[x][y], as indicated by the value of nnpfc_out_order_idc, that contain the output of the post-processing filter.

The variables SubWidthC and SubHeightC are derived from ChromaFormatIdc as specified by Table 2.

TABLE 2
Sub WidthC and SubHeightC values derived
from sps_chroma_format_idc

| sps_chroma_format_idc | Chroma format | SubWidthC | SubHeightC |
|---|---|---|---|
| 0 | Monochrome | 1 | 1 |
| 1 | 4:2:0 | 2 | 2 |
| 2 | 4:2:2 | 2 | 1 |
| 3 | 4:4:4 | 1 | 1 |

nnpfc_id contains an identifying number that may be used to identify a post-processing filter. The value of nnpfc_id shall be in the range of 0 to 2³²-2, inclusive.

Values of nnpfc_id from 256 to 511, inclusive, and from 2³¹ to 2³²-2, inclusive, are reserved for future use by ITU-T|ISO/IEC. Decoders encountering a value of nnpfc_id in the range of 256 to 511, inclusive, or in the range of 2³¹ to 2³²-2, inclusive, shall ignore it.

nnpfc_mode_idc equal to 0 specifies that the post-processing filter associated with the nnpfc_id value is determined by external means not specified in this Specification.

nnpfc_mode_idc equal to 1 specifies that the post-processing filter associated with the nnpfc_id value is a neural network represented by the ISO/IEC 15938-17 bitstream contained in this SEI message.

nnpfc_mode_idc equal to 2 specifies that the post-processing filter associated with the nnpfc_id value is a neural network identified by a specified tag Uniform Resource Identifier (URI) (nnpfc_uri_tag[i]) and neural network information URI (nnpfc_uri[i]).

The value of nnpfc_mode_idc shall be in the range of 0 to 255, inclusive. Values of nnpfc_mode_idc greater than 2 are reserved for future specification by ITU-T|ISO/IEC and shall not be present in bitstreams conforming to this version of this Specification. Decoders conforming to this version of this Specification shall ignore SEI messages that contain reserved values of nnpfc_mode_idc.

nnpfc_purpose_and_formatting_flag equal to 0 specifies that no syntax elements related to the filter purpose, input formatting, output formatting, and complexity are present.

nnpfc_purpose_and_formatting_flag equal to 1 specifies that syntax elements related to the filter purpose, input formatting, output formatting, and complexity are present.

When nnpfc_mode_idc is equal to 1 and the current CLVS does not contain a preceding neural-network post-filter characteristics SEI message, in decoding order, that has the value of nnpfc_id equal to the value of nnpfc_id in this SEI message, nnpfc_purpose_and_formatting_flag shall be equal to 1.

When the current CLVS contains a preceding neural-network post-filter characteristics SEI message, in decoding order, that has the same value of nnpfc_id equal to the value of nnpfc_id in this SEI message, at least one of the following conditions shall apply:
This SEI message has nnpfc_mode_idc equal to 1 and nnpfc_purpose_and_formatting_flag equal to 0 in order to provide a neural network update.
This SEI message has the same content as the preceding neural-network post-filter characteristics SEI message.

When this SEI message is the first neural-network post-filter characteristics SEI message, in decoding order, that has a particular nnpfc_id value within the current CLVS, it specifies a base post-processing filter that pertains to the current decoded picture and all subsequent decoded pictures of the current layer, in output order, until the end of the current CLVS. When this SEI message is not the first neural-network post-filter characteristics SEI message, in decoding order, that has a particular nnpfc_id value within the current CLVS, this SEI message pertains to the current decoded picture and all subsequent decoded pictures of the current layer, in output order, until the end of the current CLVS or the next neural-network post-filter characteristics SEI message having that particular nnpfc_id value, in output order, within the current CLVS. nnpfc_purpose indicates the purpose of post-processing filter as specified in Table 20. The value of nnpfc_purpose shall be in the range of 0 to 2³²-2, inclusive. Values of nnpfc_purpose that do not appear in Table 20 are reserved for future specification by ITU-T|ISO/IEC and shall not be present in bitstreams conforming to this version of this Specification. Decoders conforming to this version of this Specification shall ignore SEI messages that contain reserved values of nnpfc_purpose.

TABLE 20
Definition of nnpfc_purpose

| Value | Interpretation |
|---|---|
| 0 | Unknown or unspecified |
| 1 | Visual quality improvement |
| 2 | Chroma upsampling from the 4:2:0 chroma format to the 4:2:2 or |
| | 4:4:4 chroma format, or from the 4:2:2 chroma format to the 4:4:4 |
| | chroma format |
| 3 | Increasing the width or height of the cropped decoded output |
| | picture without changing the chroma format |
| 4 | Increasing the width or height of the cropped decoded output |
| | picture and upsampling the chroma format |

NOTE 1 -
When a reserved value of nnpfc_purpose is taken into use in the future by ITU-T | ISO/IEC, the syntax of this SEI message could be extended with syntax elements whose presence is conditioned by nnpfc_purpose being equal to that value.

When SubWidthC is equal to 1 and SubHeightC is equal to 1, nnpfc purpose shall not be equal to 2 or 4.

nnpfc_out_sub_c_flag equal to 1 specifies that outSubWidthC is equal to 1 and outSubHeightC is equal to 1. nnpfc_out_sub_c_flag equal to 0 specifies that outSub WidthC is equal to 2 and outSubHeightC is equal to 1. When nnpfc_out_sub_c_flag is not present, outSubWidthC is inferred to be equal to SubWidthC and outSubHeightC is inferred to be equal to SubHeightC. If SubWidthC is equal to 2 and SubHeightC is equal to 1, nnpfc_out_sub_c_flag shall not be equal to 0.

nnpfc_pic_width_in_luma_samples and nnpfc_pic_height_in_luma_samples specify the width and height, respectively, of the luma sample array of the picture resulting by applying the post-processing filter identified by nnpfc_id to a cropped decoded output picture. When nnpfc_pic_width_in_luma_samples and nnpfc_pic_height_in_luma samples are not present, they are inferred to be equal to CroppedWidth and CroppedHeight, respectively.

nnpfc_component_last_flag equal to 0 specifies that the second dimension in the input tensor inputTensor to the post-processing filter and the output tensor outputTensor resulting from the post-processing filter is used for the channel. nnpfc_component_last_flag equal to 1 specifies that the last dimension in the input tensor inputTensor to the post-processing filter and the output tensor outputTensor resulting from the post-processing filter is used for the channel.
NOTE 2—The first dimension in the input tensor and in the output tensor is used for the batch index, which is a practice in some neural network frameworks. While the semantics of this SEI message use batch size equal to 1, it is up to the post-processing implementation to determine the batch size used as input to the neural network inference.
NOTE 3—A colour component is an example of a channel.

nnpfc_inp_format_flag indicates the method of converting a sample value of the cropped decoded output picture to an input value to the post-processing filter. When nnpfc_inp_format_flag is equal to 0, the input values to the post-processing filter are real numbers and the functions InpY and InpC are specified as follows.

$$InpY ( x ) = x \div ( ( 1 ≪ {BitDepth}_{Y} ) - 1 ) \qquad ( 75 )$$

$$InpC ( x ) = x \div ( ( 1 ≪ {BitDepth}_{C} ) - 1 ) \qquad ( 76 )$$

When nnpfc_inp_format_flag is equal to 1, the input values to the post-processing filter are unsigned integer numbers and the functions InpY and InpC are specified as follows.

```
shift = BitDepth_{Y} − inpTensorBitDepth
if( inpTensorBitDepth >= BitDepth_{Y})
  InpY( x ) = x << ( inpTensorBitDepth − BitDepth_{Y} )
else
  InpY( x ) = Clip3(0, ( 1 << inpTensorBitDepth ) − 1, ( x + ( 1 << (
shift − 1 ) ) ) >> shift ) (77)
shift = BitDepth_{C} − inpTensorBitDepth
if( inpTensorBitDepth >= BitDepth_{C} )
  InpC( x ) = x << ( inpTensorBitDepth − BitDepth_{C} )
else
  InpC( x ) = Clip3(0, ( 1 << inpTensorBitDepth ) − 1, ( x + ( 1 << (
shift − 1 ) ) ) >> shift )
```

The variable inpTensorBitDepth is derived from the syntax element nnpfc_inp_tensor_bitdepth_minus8 as specified below.

nnpfc_inp_tensor_bitdepth_minus8 plus 8 specifies the bit depth of luma sample values in the input integer tensor. The value of inpTensorBitDepth is derived as follows.

$$inpTensorBitDepth = nnpfc\_inp \_tensor \_bitdepth \_minus 8 + 8 \qquad ( 78 )$$

It is a requirement of bitstream conformance that the value of nnpfc_inp_tensor_bitdepth_minus8 shall be in the range of 0 to 24, inclusive.

nnpfc_auxiliary_inp_idc not equal to 0 specifies auxiliary input data is present in the input tensor of the neural-network post-filter. nnpfc_auxiliary_inp_idc equal to 0 indicates that auxiliary input data is not present in the input tensor. nnpfc_auxiliary_inp_idc equal to 1 specifies that auxiliary input data is derived as specified in Table 23. The value of nnpfc_auxiliary_inp_idc shall be in the range of 0 to 255, inclusive. Values of nnpfc_auxiliary_inp_idc greater than 1 are reserved for future specification by ITU-T|ISO/IEC and shall not be present in bitstreams conforming to this version of this Specification. Decoders conforming to this version of this Specification shall ignore SEI messages that contain reserved values of nnpfc_auxiliary_inp_idc.

nnpfc_separate_colour_description_present_flag equal to 1 indicates that a distinct combination of colour primaries, transfer characteristics, and matrix coefficients for the picture resulting from the post-processing filter is specified in the SEI message syntax structure.

nnfpc_separate_colour_description present_flag equal to 0 indicates that the combination of colour primaries, transfer characteristics, and matrix coefficients for the picture resulting from the post-processing filter is the same as indicated in VUI parameters for the CLVS.

nnpfc_colour_primaries has the same semantics as specified for the vui_colour_primaries syntax element, except as follows.
nnpfc_colour primaries specifies the colour primaries of the picture resulting from applying the neural-network post-filter specified in the SEI message, rather than the colour primaries used for the CLVS.
When nnpfc_colour primaries is not present in the neural-network post-filter characteristics SEI message, the value of nnpfc_colour primaries is inferred to be equal to vui_colour_primaries. nnpfc_transfer_characteristics has the same semantics as specified for the vui_transfer_characteristics syntax element, except as follows.
nnpfc_transfer_characteristics specifies the transfer characteristics of the picture resulting from applying the neural-network post-filter specified in the SEI message, rather than the transfer characteristics used for the CLVS.
When nnpfc_transfer_characteristics is not present in the neural-network post-filter characteristics SEI message, the value of nnpfc_transfer_characteristics is inferred to be equal to vui_transfer_characteristics.

nnpfc_matrix_coeffs has the same semantics as specified for the vui_matrix_coeffs syntax element, except as follows.
nnpfc_matrix_coeffs specifies the matrix coefficients of the picture resulting from applying the neural-network post-filter specified in the SEI message, rather than the matrix coefficients used for the CLVS.
When nnpfc_matrix_coeffs is not present in the neural-network post-filter characteristics SEI message, the value of nnpfc_matrix_coeffs is inferred to be equal to vui_matrix_coeffs.
The values allowed for nnpfc_matrix_coeffs are not constrained by the chroma format of the decoded video pictures that is indicated by the value of ChromaFormatIdc for the semantics of the VUI parameters.
When nnpfc_matrix_coeffs is equal to 0, nnpfc_out_order_idc shall not be equal to 1 or 3.

nnpfc_inp_order_idc indicates the method of ordering the sample arrays of a cropped decoded output picture as the input to the post-processing filter. Table 21 contains an informative description of nnpfc_inp_order_idc values. The semantics of nnpfc_inp_order_idc in the range of 0 to 3, inclusive, are specified in Table 23, which specifies a process for deriving the input tensors inputTensor for different values of nnpfc_inp_order_idc and a given vertical sample coordinate cTop and a horizontal sample coordinate cLeft specifying the top-left sample location for the patch of samples included in the input tensors. When the chroma format of the cropped decoded output picture is not 4:2:0, nnpfc_inp_order_idc shall not be equal to 3. The value of nnpfc_inp_order_idc shall be in the range of 0 to 255, inclusive. Values of nnpfc_inp_order_idc greater than 3 are reserved for future specification by ITU-T|ISO/IEC and shall not be present in bitstreams conforming to this version of this Specification. Decoders conforming to this version of this Specification shall ignore SEI messages that contain reserved values of nnpfc_inp_order_idc.

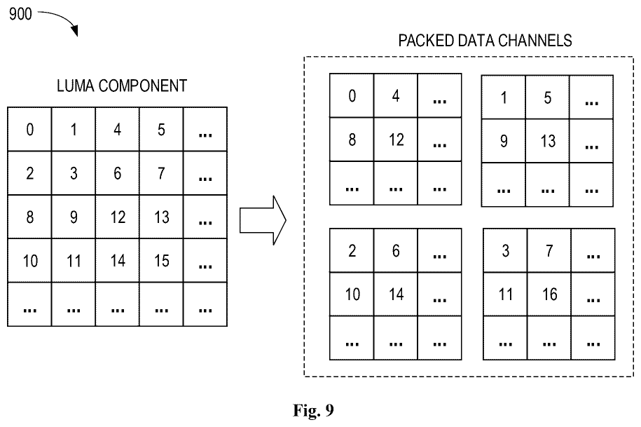

TABLE 21
Informative description of nnpfc_inp_order_idc values

| nnpfc_inp_order_idc | Description |
|---|---|
| 0 | If nnpfc_auxiliary_inp_idc is equal to 0, one luma matrix is present in the input tensor, |
| | thus the number of channels is 1. Otherwise, nnpfc_auxiliary_inp_idc is not equal to 0 |
| | and one luma matrix and one auxiliary input matrix are present, thus the number of |
| | channels is 2. |
| 1 | If nnpfc_auxiliary_inp_idc is equal to 0, two chroma matrices are present in the input |
| | tensor, thus the number of channels is 2. Otherwise, nnpfc_auxiliary_inp_idc is not equal |
| | to 0 and two chroma matrices and one auxiliary input matrix are present, thus the number |
| | of channels is 3. |
| 2 | If nnpfc_auxiliary_inp_idc is equal to 0, one luma and two chroma matrices are present |
| | in the input tensor, thus the number of channels is 3. Otherwise, nnpfc_auxiliary_inp_idc |
| | is not equal to 0 and one luma matrix, two chroma matrices and one auxiliary input |
| | matrix are present, thus the number of channels is 4. |
| 3 | If nnpfc_auxiliary_inp_idc is equal to 0, four luma matrices and two chroma matrices are |
| | present in the input tensor, thus the number of channels is 6. Otherwise, |
| | nnpfc_auxiliary_inp_idc is not equal to 0 and four luma matrices, two chroma matrices, |
| | and one auxiliary input matrix are present in the input tensor, thus the number of |
| | channels is 7. The luma channels are derived in an interleaved manner as illustrated in |
| | FIG. 9 (which is an information illustration 900 of luma data channels of |
| | nnpfc_inp_order_idc equal to 3). This nnpfc_inp_order_idc can only be used when the |
| | chroma format is 4:2:0. |
| 4 . . . 255 | reserved |

A patch is a rectangular array of samples from a component (e.g., a luma or chroma component) of a picture.

nnpfc_constant_patch_size_flag equal to 0 specifies that the post-processing filter accepts any patch size that is a positive integer multiple of the patch size indicated by nnpfc_patch_width_minus1 and nnpfc_patch_height_minus1 as input. When nnpfc_constant_patch_size_flag is equal to 0 the patch size width shall be less than or equal to CroppedWidth. When nnpfc_constant_patch_size_flag is equal to 0 the patch size height shall be less than or equal to CroppedHeight. nnpfc_constant_patch_size_flag equal to 1 specifies that the post-processing filter accepts exactly the patch size indicated by nnpfc_patch_width_minus1 and nnpfc_patch_height_minus1 as input.

nnpfc_patch_width_minus1+1, when nnpfc_constant_patch_size_flag equal to 1, specifies the horizontal sample counts of the patch size required for the input to the post-processing filter. When nnpfc_constant_patch_size_flag is equal to 0, any positive integer multiple of (nnpfc_patch_width_minus1+1) may be used as the horizontal sample counts of the patch size used for the input to the post-processing filter. The value of nnpfc_patch_width_minus1 shall be in the range of 0 to Min(32766, CroppedWidth−1), inclusive.

nnpfc_patch_height_minus1+1, when nnpfc_constant_patch_size_flag equal to 1, specifies the vertical sample counts of the patch size required for the input to the post-processing filter. When nnpfc_constant patch_size_flag is equal to 0, any positive integer multiple of (nnpfc_patch_height_minus1+1) may be used as the vertical sample counts of the patch size used for the input to the post-processing filter. The value of nnpfc_patch_height_minus1 shall be in the range of 0 to Min(32766, CroppedHeight−1), inclusive.

nnpfc_overlap specifies the overlapping horizontal and vertical sample counts of adjacent input tensors of the post-processing filter. The value of nnpfc_overlap shall be in the range of 0 to 16383, inclusive.

The variables inpPatch Width, inpPatchHeight, outPatch Width, outPatchHeight, horCScaling, verCScaling, outPatchCWidth, outPatchCHeight, and overlapSize are derived as follows.

$$inpPatchWidth = nnpfc\_patch \_width \_minus1 + 1 \qquad ( 79 )$$

$$inpPatchHeight = nnpfc\_patch \_height \_minus1 + 1$$

$$outPatchWidth = ( nnpfc\_pic \_width \_in \_luma \_samples * inpPatchWidth ) / CroppedWidth$$

$$outPatchHeight = ( nnpfc\_pic \_height \_in \_luma \_samples * inpPatchHeight ) / CroppedHeight$$

$$horCScaling = SubWidthC / outSubWidthC$$

$$verCScaling = SubHeightC / outSubHeightC$$

$$outPatchCWidth = outPatchWidth * horCScaling$$

$$outPatchCHeight = outPatchHeight * verCScaling$$

$$overlapSize = nnpfc\_overlap$$

It is a requirement of bitstream conformance that outPatch Width*CroppedWidth shall be equal to nnpfc_pic_width_in_luma_samples*inpPatch Width and outPatchHeight*CroppedHeight shall be equal to nnpfc_pic_height_in_luma_samples*inpPatchHeight.

nnpfc_padding_type specifies the process of padding when referencing sample locations outside the boundaries of the cropped decoded output picture as described in Table 22. The value of nnpfc_padding_type shall be in the range of 0 to 15, inclusive.

TABLE 22
Informative description of nnpfc_padding_type values

| nnpfc_padding_type | Description |
|---|---|
| 0 | zero padding |
| 1 | replication padding |
| 2 | reflection padding |
| 3 | wrap-around padding |
| 4 | fixed padding |
| 5 . . . 15 | reserved |

nnpfc_luma_padding_val specifies the luma value to be used for padding when nnpfc_padding_type is equal to 4.

nnpfc_cb_padding_val specifies the Cb value to be used for padding when nnpfc_padding_type is equal to 4.

nnpfc_cr_padding_val specifies the Cr value to be used for padding when nnpfc_padding_type is equal to 4.

The function InpSampleVal(y, x, picHeight, picWidth, croppedPic) with inputs being a vertical sample location y, a horizontal sample location x, a picture height picHeight, a picture width picWidth, and sample array croppedPic returns the value of sample Val derived as follows.

```
if( nnpfc_padding_type = = 0 )
  if( y < 0 || x < 0 || y >= picHeight || x >= picWidth )
    sampleVal = 0
  else
    sampleVal = croppedPic[ x ][ y ] (80)
else if( nnpfc_padding_type = = 1 )
  sampleVal = croppedPic[ Clip3( 0, picWidth − 1, x ) ][ Clip3( 0, picHeight − 1, y ) ]
else if( nnpfc_padding_type = = 2 )
  sampleVal = croppedPic[ Reflect( pic Width − 1, x ) ][ Reflect( picHeight − 1, y ) ]
else if( nnpfc_padding_type = = 3 )
  if(y >= 0 && y < picHeight)
    sampleVal = croppedPic[ Wrap( picWidth − 1, x ) ][ y ]
else if( nnpfc_padding_type = = 4 )
  if( y < 0 || x < 0 || y >= picHeight || x >= picWidth )
    sampleVal[ 0 ] = nnpfc_luma_padding_val
      sampleVal[ 1 ] = nnpfc_cb_padding_val
    sampleVal[ 2 ] = nnpfc_cr_padding_val
  else
    sampleVal = croppedPic[ x ][ y ]
```

TABLE 23
Process for deriving the input tensors inputTensor for a given vertical sample coordinate cTop and a horizontal sample
coordinate cLeft specifying the top-left sample location for the patch of samples included in the input tensors

| nnpfc_inp_order_idc | Process DeriveInputTensors( ) for deriving input tensors |
|---|---|
| 0 | for( yP = −overlapSize; yP < inpPatchHeight + overlapSize; yP++) |
| | for( xP = −overlapSize; xP < inpPatchWidth + overlapSize; xP++ ) { |
| | inpVal = InpY( InpSampleVal( cTop + yP, cLeft + xP, CroppedHeight, |
| | CroppedWidth, CroppedYPic ) ) |
| | if( nnpfc_component_last_flag = = 0 ) |
| | inputTensor[ 0 ][ 0 ][ yP + overlapSize ][ xP + overlapSize ] = inpVal |
| | else |
| | inputTensor[ 0 ][ yP + overlapSize ][ xP + overlapSize ][ 0 ] = inpVal |
| | if(nnpfc_auxiliary_inp_idc = = 1) { |
| | if( nnpfc_component_last_flag = = 0 ) |
| | inputTensor[ 0 ][ 1 ][ yP + overlapSize ][ xP + overlapSize ] = 2^{(StrengthControlVal - 42)/6} |
| | else |
| | inputTensor[ 0 ][ yP + overlapSize ][ xP + overlapSize ][ 1 ] = 2^{(StrengthControlVal - 42)/6} |
| | } |
| | } |
| 1 | for( yP = −overlapSize; yP < inpPatchHeight + overlapSize; yP++) |
| | for( xP = −overlapSize; xP < inpPatchWidth + overlapSize; xP++ ) { |
| | inpCbVal = InpC( InpSampleVal( cTop + yP, cLeft + xP, CroppedHeight / |
| | SubHeightC, |
| | CroppedWidth / SubWidthC, CroppedCbPic ) ) |
| | inpCrVal = InpC( InpSampleVal( cTop + yP, cLeft + xP, CroppedHeight / |
| | SubHeightC, |
| | CroppedWidth / SubWidthC, CroppedCrPic ) ) |
| | if( nnpfc_component_last_flag = = 0 ) { |
| | inputTensor[ 0 ][ 0 ][ yP + overlapSize ][ xP + overlapSize ] = inpCbVal |
| | inputTensor[ 0 ][ 1 ][ yP + overlapSize ][ xP + overlapSize ] = inpCrVal |
| | } else { |
| | inputTensor[ 0 ][ yP + overlapSize ][ xP + overlapSize ][ 0 ] = inpCbVal |
| | inputTensor[ 0 ][ yP + overlapSize ][ xP + overlapSize ][ 1 ] = inpCrVal |
| | } |
| | if(nnpfc_auxiliary_inp_idc = = 1) { |
| | if( nnpfc_component_last_flag = = 0 ) |
| | inputTensor[ 0 ][ 2 ][ yP + overlapSize ][ xP + overlapSize ] = 2^{(StrengthControlVal - 42)/6} |
| | else |
| | inputTensor[ 0 ][ yP + overlapSize ][ xP + overlapSize ][ 2 ] = 2^{(StrengthControlVal - 42)/6} |
| | } |
| | } |
| 2 | for( yP = −overlapSize; yP < inpPatchHeight + overlapSize; yP++) |
| | for( xP = −overlapSize; xP < inpPatchWidth + overlapSize; xP++ ) { |
| | yY =cTop + yP |
| | xY = cLeft + xP |
| | yC = yY / SubHeightC |
| | xC = xY / Sub WidthC |
| | inpYVal = InpY( InpSampleVal( yY, xY, CroppedHeight, |
| | CroppedWidth, CroppedYPic ) ) |
| | inpCbVal = InpC( InpSampleVal( yC, xC, CroppedHeight / SubHeightC, |
| | CroppedWidth / SubWidthC, CroppedCbPic ) ) |
| | inpCrVal = InpC( InpSampleVal( yC, xC, CroppedHeight / SubHeightC, |
| | CroppedWidth / SubWidthC, CroppedCrPic ) ) |
| | if( nnpfc_component_last_flag = = 0 ) { |
| | inputTensor[ 0 ][ 0 ][ yP + overlapSize ][ xP + overlapSize ] = inpYVal |
| | inputTensor[ 0 ][ 1 ][ yP + overlapSize ][ xP + overlapSize ] = inpCbVal |
| | inputTensor[ 0 ][ 2 ][ yP + overlapSize ][ xP + overlapSize ] = inpCrVal |
| | } else { |
| | inputTensor[ 0 ][ yP + overlapSize ][ xP + overlapSize ][ 0 ] = inpYVal |
| | inputTensor[ 0 ][ yP + overlapSize ][ xP + overlapSize ][ 1 ] = inpCbVal |
| | inputTensor[ 0 ][ yP + overlapSize ][ xP + overlapSize ][ 2 ] = inpCrVal |
| | } |
| | if(nnpfc_auxiliary_inp_idc = = 1) { |
| | if( nnpfc_component_last_flag = = 0 ) |
| | inputTensor[ 0 ][ 3 ][ yP + overlapSize ][ xP + overlapSize ] = 2^{(StrengthControlVal - 42)/6} |
| | else |
| | inputTensor[ 0 ][ yP + overlapSize ][ xP + overlapSize ][ 3 ] = 2^{(StrengthControlVal - 42)/6} |
| | } |
| | } |
| 3 | for( yP = −overlapSize; yP < inpPatchHeight + overlapSize; yP++) |
| | for( xP = −overlapSize; xP < inpPatchWidth + overlapSize; xP++ ) { |
| | yTL = cTop + yP * 2 |
| | xTL = cLeft + xP * 2 |
| | yBR = yTL + 1 |
| | xBR = xTL + 1 |
| | yC =cTop / 2 + yP |
| | xC = cLeft / 2 + xP |
| | inpTLVal = InpY( InpSampleVal( yTL, xTL, CroppedHeight, |
| | CroppedWidth, CroppedYPic ) ) |
| | inpTRVal = InpY( InpSampleVal( yTL, xBR, CroppedHeight, |
| | CroppedWidth, CroppedYPic ) ) |
| | inpBLVal = InpY( InpSampleVal( yBR, xTL, CroppedHeight, |
| | CroppedWidth, CroppedYPic ) ) |
| | inpBRVal = InpY( InpSampleVal( yBR, xBR, CroppedHeight, |
| | CroppedWidth, CroppedYPic ) ) |
| | inpCbVal = InpC( InpSampleVal( yC, xC, CroppedHeight / 2, |
| | CroppedWidth / 2, CroppedCbPic ) ) |
| | inpCrVal = InpC( InpSampleVal( yC, xC, CroppedHeight / 2, |
| | CroppedWidth / 2, CroppedCrPic ) ) |
| | if( nnpfc_component_last_flag = = 0 ) { |
| | inputTensor[ 0 ][ 0 ][ yP + overlapSize ][ xP + overlapSize ] = inpTLVal |
| | inputTensor[ 0 ][ 1 ][ yP + overlapSize ][ xP + overlapSize ] = inpTRVal |
| | inputTensor[ 0 ][ 2 ][ yP + overlapSize ][ xP + overlapSize ] = inpBLVal |
| | inputTensor[ 0 ][ 3 ][ yP + overlapSize ][ xP + overlapSize ] = inpBRVal |
| | inputTensor[ 0 ][ 4 ][ yP + overlapSize ][ xP + overlapSize ] = inpCbVal |
| | inputTensor[ 0 ][ 5 ][ yP + overlapSize ][ xP + overlapSize ] = inpCrVal |
| | inputTensor[ 0 ][ 6 ][ yP + overlapSize ][ xP + overlapSize ] = 2^{(StrengthControlVal - 42)/6} |
| | } else { |
| | inputTensor[ 0 ][ yP + overlapSize ][ xP + overlapSize ][ 0 ] = inpTLVal |
| | inputTensor[ 0 ][ yP + overlapSize ][ xP + overlapSize ][ 1 ] = inpTRVal |
| | inputTensor[ 0 ][ yP + overlapSize ][ xP + overlapSize ][ 2 ] = inpBLVal |
| | inputTensor[ 0 ][ yP + overlapSize ][ xP + overlapSize ][ 3 ] = inpBRVal |
| | inputTensor[ 0 ][ yP + overlapSize ][ xP + overlapSize ][ 4 ] = inpCbVal |
| | inputTensor[ 0 ][ yP + overlapSize ][ xP + overlapSize ][ 5 ] = inpCrVal |
| | } |
| | if(nnpfc_auxiliary_inp_idc = = 1) { |
| | if( nnpfc_component_last_flag = = 0 ) |
| | inputTensor[ 0 ][ 6 ][ yP + overlapSize ][ xP + overlapSize ] = 2^{(StrengthControlVal - 42)/6} |
| | else |
| | inputTensor[ 0 ][ yP + overlapSize ][ xP + overlapSize ][ 6 ] = 2^{(StrengthControlVal - 42)/6} |
| | } |
| | } |
| 4 . . . 255 | reserved |

nnpfc_complexity_idc greater than 0 specifies that one or more syntax elements that indicate the complexity of the post-processing filter associated with the nnpfc_id may be present. nnpfc_complexity_idc equal to 0 specifies that no syntax element that indicates the complexity of the post-processing filter associated with the nnpfc_id is present. The value nnpfc_complexity_idc shall be in the range of 0 to 255, inclusive. Values of nnpfc_complexity_idc greater than I are reserved for future specification by ITU-T|ISO/IEC and shall not be present in bitstreams conforming to this version of this Specification. Decoders conforming to this version of this Specification shall ignore SEI messages that contain reserved values of nnpfc_complexity_idc.

nnpfc_out_format_flag equal to 0 indicates that the sample values output by the post-processing filter are real numbers and the functions OutY and OutC for converting luma sample values and chroma sample values, respectively, output by the post-processing, to integer values at bit depths BitDepthy and BitDepthc, respectively, are specified as follows.

$$OutY ( x ) = Clip 3 ( 0 , ( 1 ≪ {BitDepth}_{Y} ) - 1 , Round ( x * ( ( 1 ≪ {BitDepth}_{Y} ) - 1 ) ) ) \qquad ( 81 )$$

$$OutC ( x ) = Clip 3 ( 0 , ( 1 ≪ {BitDepth}_{C} ) - 1 , Round ( x * ( ( 1 ≪ {BitDepth}_{C} ) - 1 ) ) ) \qquad ( 82 )$$

nnpfc_out_format_flag equal to 1 indicates that the sample values output by the post-processing filter are unsigned integer numbers and the functions OutY and OutC are specified as follows.

```
shift = outTensorBitDepth − BitDepth_{Y}
if( shift > 0 )
  OutY( x ) = Clip3( 0, ( 1 << BitDepth_{Y} ) − 1, ( x + ( 1 << ( shift − 1 ) ) ) >> shift )
else
  OutY( x ) = x << ( BitDepth_{Y} − outTensorBitDepth ) (83)
shift = outTensorBitDepth − BitDepth_{C}
if( shift > 0 )
  OutC( x )= Clip3( 0, ( 1 << BitDepth_{C} ) − 1, ( x + ( 1 << ( shift − 1 ) ) ) >> shift )
else
  OutC( x ) = x << ( BitDepth_{C} − outTensorBitDepth )
```

The variable outTensorBitDepth is derived from the syntax element nnpfc_out_tensor_bitdepth_minus8 as described below.

nnpfc_out_tensor_bitdepth_minus8 plus 8 specifies the bit depth of sample values in the output integer tensor. The value of outTensorBitDepth is derived as follows.

$$outTensorBitDepth = nnpfc\_out \_tensor \_bitdepth \_minus8 + 8 \qquad ( 84 )$$

It is a requirement of bitstream conformance that the value of nnpfc_out_tensor_bitdepth_minus8 shall be in the range of 0 to 24, inclusive.

nnpfc_out_order_idc indicates the output order of samples resulting from the post-processing filter. Table 24 contains an informative description of nnpfc_out_order_idc values. The semantics of nnpfc_out_order_idc in the range of 0 to 3, inclusive, are specified in Table 25, which specifies a process for deriving sample values in the filtered output sample arrays FilteredYPic, FilteredCbPic, and FilteredCrPic from the output tensors outputTensor for different values of nnpfc_out_order_idc and a given vertical sample coordinate cTop and a horizontal sample coordinate cLeft specifying the top-left sample location for the patch of samples included in the input tensors. When nnpfc_purpose is equal to 2 or 4, nnpfc_out_order_idc shall not be equal to 3. The value of nnpfc_out_order_idc shall be in the range of 0 to 255, inclusive. Values of nnpfc_out_order_idc greater than 3 are reserved for future specification by ITU-T|ISO/IEC and shall not be present in bitstreams conforming to this version of this Specification. Decoders conforming to this version of this Specification shall ignore SEI messages that contain reserved values of nnpfc_out_order_idc.

TABLE 24
Informative description of nnpfc_out_order_idc values

| nnpfc_out_order_idc | Description |
|---|---|
| 0 | Only the luma matrix is present in the output |
| | tensor, thus the number of channels is 1. |
| 1 | Only the chroma matrices are present in the |
| | output tensor, thus the number of channels is 2. |
| 2 | The luma and chroma matrices are present in the |
| | output tensor, thus the number of channels is 3. |
| 3 | Four luma matrices and two chroma matrices are |
| | present in the output tensor, thus the number of |
| | channels is 6. This nnpfc_out_order_idc can |
| | only be used when the chroma format is 4:2:0. |
| 4 . . . 255 | reserved |

TABLE 25
Process for deriving sample values in the filtered output sample arrays FilteredYPic, FilteredCbPic, and FilteredCrPic
from the output tensors outputTensor for a given vertical sample coordinate cTop and a horizontal sample coordinate
cLeft specifying the top-left sample location for the patch of samples included in the input tensors

| | Process StoreOutputTensors( ) for deriving sample values in the filtered picture from |
|---|---|
| nnpfc_out_order_idc | the output tensors |
| 0 | for( yP = 0; yP < outPatchHeight; yP++) |
| | for( xP = 0; xP < outPatchWidth; xP++ ) { |
| | yY = cTop * outPatchHeight / inpPatchHeight + yP |
| | xY = cLeft * outPatchWidth / inpPatchWidth + xP |
| | if ( yY < nnpfc_pic_height_in_luma_samples && xY < |
| | nnpfc_pic_width_in_luma_samples ) |
| | if( nnpfc_component_last_flag = = 0 ) |
| | FilteredYPic[ xY ][yY ] = OutY( outputTensor[ 0 ][ 0 ][ yP ][ xP ] ) |
| | else |
| | FilteredYPic[ xY ][ yY ] = OutY( outputTensor[ 0 ][ yP ][ xP ][ 0 ] ) |
| | } |
| 1 | for( yP = 0; yP < outPatchCHeight; yP++) |
| | for( xP = 0; xP < outPatchCWidth; xP++ ) { |
| | xSrc = cLeft * horCScaling + xP |
| | ySrc = cTop * verCScaling + yP |
| | if ( ySrc < nnpfc_pic_height_in_luma_samples / outSubHeightC && |
| | xSrc < nnpfc_pic_width_in_luma_samples / outSubWidthC ) |
| | if( nnpfc_component_last_flag = = 0 ) { |
| | FilteredCbPic[ xSrc ][ ySrc ] = OutC( outputTensor[ 0 ][ 0 ][ yP ][ xP ] ) |
| | FilteredCrPic[ xSrc ][ ySrc ] = OutC( outputTensor[ 0 ][ 1 ][ yP ][ xP ] ) |
| | } else { |
| | FilteredCbPic[ xSrc ][ ySrc ] = OutC( outputTensor[ 0 ][ yP ][ xP ][ 0 ] ) |
| | FilteredCrPic[ xSrc ][ ySrc ] = OutC( outputTensor[ 0 ][ yP ][ xP ][ 1 ] ) |
| | } |
| | } |
| 2 | for( yP = 0; yP < outPatchHeight; yP++) |
| | for( xP = 0; xP < outPatchWidth; xP++ ) { |
| | yY = cTop * outPatchHeight / inpPatchHeight + yP |
| | xY = cLeft * outPatchWidth / inpPatchWidth + xP |
| | yC = yY / outSubHeightC |
| | xC = xY / outSubWidthC |
| | yPc = ( yP / outSubHeightC ) * outSubHeightC |
| | xPc = ( xP / outSubWidthC ) * outSubWidthC |
| | if ( yY < nnpfc_pic_height_in_luma_samples && xY < |
| | nnpfc_pic_width_in_luma_samples) |
| | if( nnpfc_component_last_flag = = 0 ) { |
| | FilteredYPic[ xY ][ yY ] = OutY( outputTensor[ 0 ][ 0 ][ yP ][ xP ] ) |
| | FilteredCbPic[ xC ][ yC ] = OutC( outputTensor[ 0 ][ 1 ][ yPc ][ xPc ] ) |
| | FilteredCrPic[ xC ][ yC ] = OutC( outputTensor[ 0 ][ 2 ][ yPc ][ xPc ] ) |
| | } else { |
| | FilteredYPic[ xY ][ yY ] = OutY( outputTensor[ 0 ][ yP ][ xP ][ 0 ] ) |
| | FilteredCbPic[ xC ][ yC ] = OutC( outputTensor[ 0 ][ yPc ][ xPc ][ 1 ] ) |
| | FilteredCrPic[ xC ][ yC ] = OutC( outputTensor[ 0 ][ yPc ][ xPc ][ 2 ] ) |
| | } |
| | } |
| 3 | for( yP = 0; yP < outPatchHeight; yP++ ) |
| | for( xP = 0; xP < outPatchWidth; xP++ ) { |
| | ySrc = cTop / 2 * outPatchHeight / inpPatchHeight + yP |
| | xSrc = cLeft / 2 * outPatchWidth / inpPatchWidth + xP |
| | if ( ySrc < nnpfc_pic_height_in_luma_samples / 2 && |
| | xSrc < nnpfc_pic_width_in_luma_samples / 2 ) |
| | if( nnpfc_component_last_flag = = 0 ) { |
| | FilteredYPic[ xSrc * 2 ][ ySrc * 2 ] = OutY( outputTensor[ 0 ][ 0 ][ yP ][ xP ] ) |
| | FilteredYPic[ xSrc * 2 + 1 ][ ySrc * 2 ] = OutY( outputTensor[ 0 ][ 1 ][ yP ][ xP ] ) |
| | FilteredYPic[ xSrc * 2 ][ ySrc * 2 + 1 ] = OutY( outputTensor[ 0 ][ 2 ][ yP ][ xP ] ) |
| | FilteredYPic[ xSrc * 2 + 1][ ySrc * 2 + 1 ] = |
| | OutY( outputTensor[ 0 ][ 3 ][ yP ][ xP ] ) |
| | FilteredCbPic[ xSrc ][ ySrc ] = OutC( outputTensor[ 0 ][ 4 ][ yP ][ xP ] ) |
| | FilteredCrPic[ xSrc ][ ySrc ] = OutC( outputTensor[ 0 ][ 5 ][ yP ][ xP ] ) |
| | } else { |
| | FilteredYPic[ xSrc * 2 ][ ySrc * 2 ] = OutY( outputTensor[ 0 ][ yP ][ xP ][ 0 ] ) |
| | FilteredYPic[ xSrc * 2 + 1 ][ ySrc * 2 ] = OutY( outputTensor[ 0 ][ yP ][ xP ][ 1 ] ) |
| | FilteredYPic[ xSrc * 2 ][ ySrc * 2 + 1 ] = OutY( outputTensor[ 0 ][ yP ][ xP ][ 2 ] ) |
| | FilteredYPic[ xSrc * 2 + 1][ ySrc * 2 + 1 ] = |
| | OutY( outputTensor[ 0 ][ yP ][ xP ][ 3 ] ) |
| | FilteredCbPic[ xSrc ][ ySrc ] = OutC( outputTensor[ 0 ][ yP ][ xP ][ 4 ] ) |
| | FilteredCrPic[ xSrc ][ ySrc ] = OutC( outputTensor[ 0 ][ yP ][ xP ][ 5 ] ) |
| | } |
| | } |
| 4 . . . 255 | reserved |

A base post-processing filter for a cropped decoded output picture picA is the filter that is identified by the first neural-network post-filter characteristics SEI message, in decoding order, that has a particular nnpfc_id value within a CLVS.

If there is another neural-network post-filter characteristics SEI message that has the same nnpfc_id value, has nnpfc_mode_idc equal to 1, has different content than the neural-network post-filter characteristics SEI message that defines the base post-processing filter, and pertains to the picture picA, the base post-processing filter is updated by decoding the ISO/IEC 15938-17 bitstream in that neural-network post-filter characteristics SEI message to obtain a post-processing filter PostProcessingFilter( ) Otherwise, the post-processing processing filter PostProcessingFilter( ) is assigned to be the same as the base post-processing filter.

The following process is used to filter the cropped decoded output picture with the post-processing filter PostProcessingFilter( ) to generate the filtered picture, which contains Y, Cb, and Cr sample arrays FilteredYPic, FilteredCbPic, and FilteredCrPic, respectively, as indicated by nnpfc_out_order_idc.

```
if( nnpfc_inp_order_idc = = 0 )
  for( cTop = 0; cTop < CroppedHeight; cTop += inpPatchHeight )
    for( cLeft = 0; cLeft < CroppedWidth; cLeft += inpPatchWidth ) {
      DeriveInputTensors( )
      outputTensor = PostProcessingFilter( inputTensor )
      StoreOutputTensors( )
    }
else if( nnpfc_inp_order_idc = = 1 )
  for( cTop = 0; cTop < CroppedHeight / SubHeightC; cTop += inpPatchHeight )
    for( cLeft = 0; cLeft < CroppedWidth / SubWidthC; cLeft += inpPatchWidth ) {
      DeriveInputTensors( )
      outputTensor = PostProcessingFilter( inputTensor )
      StoreOutputTensors( )
    }
else if( nnpfc_inp_order_idc = = 2 )
  for( cTop = 0; cTop < CroppedHeight; cTop += inpPatchHeight) (85)
    for( cLeft = 0; cLeft < CroppedWidth; cLeft += inpPatch Width) {
      DeriveInputTensors( )
      outputTensor = PostProcessingFilter( inputTensor )
      StoreOutputTensors( )
    }
else if( nnpfc_inp_order_idc = = 3 )
  for( cTop = 0; cTop < CroppedHeight; cTop += inpPatchHeight * 2 )
    for( cLeft = 0; cLeft < CroppedWidth; cLeft += inpPatchWidth * 2 ) {
      DeriveInputTensors( )
      outputTensor = PostProcessingFilter( inputTensor )
      StoreOutputTensors( )
    }
```

nnpfc_reserved_zero_bit shall be equal to 0.

nnpfc_uri_tag[i] contains a NULL-terminated UTF-8 character string specifying a tag URI. The UTF-8 character string contains a URI, with syntax and semantics as specified in IETF RFC 4151, uniquely identifying the format and associated information about the neural network used as the post-processing filter specified by nnrpf_uri[i] values.
NOTE 4—nnrpf_uri_tag[i] elements represent a ‘tag’ URI, which allows uniquely identifying the format of neural network data specified by nnrpf_uri[i] values without needing a central registration authority.

nnpfc_uri[i] contains a NULL-terminated UTF-8 character string, as specified in IETF Internet Standard 63. The UTF-8 character string contains a URI, with syntax and semantics as specified in IETF Internet Standard 66, identifying the neural network information (e.g. data representation) used as the post-processing filter.

nnpfc_payload_byte[i] contains the i-th byte of a bitstream conforming to ISO/IEC 15938-17. The byte sequence nnpfc_payload_byte[i] for all present values of i shall be a complete bitstream that conforms to ISO/IEC 15938-17.

nnpfc_parameter_type_idc equal to 0 indicates that the neural network uses only integer parameters. nnpfc_parameter_type_flag equal to 1 indicates that the neural network may use floating point or integer parameters. nnpfc_parameter_type_idc equal to 2 indicates that the neural network uses only binary parameters. nnpfc_parameter_type_idc equal to 3 is reserved for future specification by ITU-T|ISO/IEC and shall not be present in bitstreams conforming to this version of this Specification. Decoders conforming to this version of this Specification shall ignore SEI messages that contain reserved value of nnpfc_parameter_type_idc.

nnpfc_log2_parameter_bit_length_minus3 equal to 0, 1, 2, and 3 indicates that the neural network does not use parameters of bit length greater than 8, 16, 32, and 64, respectively. When nnpfc_parameter_type_idc is present and nnpfc_log2_parameter_bit_length_minus3 is not present the neural network does not use parameters of bit length greater than 1.

nnpfc_num_parameters_idc indicates the maximum number of neural network parameters for the post processing filter in units of a power of 2048. nnpfc_num_parameters_idc equal to 0 indicates that the maximum number of neural network parameters is not specified. The value nnpfc_num_parameters_idc shall be in the range of 0 to 52, inclusive. Values of nnpfc_num_parameters_idc greater than 52 are reserved for future specification by ITU-T|ISO/IEC and shall not be present in bitstreams conforming to this version of this Specification. Decoders conforming to this version of this Specification shall ignore SEI messages that contain reserved values of nnpfc_num_parameters_idc.

If the value of nnpfc_num_parameters_idc is greater than zero, the variable maxNumParameters is derived as follows.

$$maxNumParameters = ( 2048 ≪ nnpfc\_num \_parameters \_idc ) - 1 \qquad ( 86 )$$

It is a requirement of bitstream conformance that the number of neural network parameters of the post-processing filter shall be less than or equal to maxNumParameters.

nnpfc_num_kmac_operations_idc greater than 0 specifies that the maximum number of multiply-accumulate operations per sample of the post-processing filter is less than or equal to nnpfc_num_kmac_operations_idc*1000. nnpfc_num_kmac_operations_idc equal to 0 specifies that the maximum number of multiply-accumulate operations of the network is not specified. The value of nnpfc_num_kmac_operations_idc shall be in the range of 0 to 2³²-1, inclusive.

### 8.29 Neural-Network Post-Filter Activation SEI Message

### 8.29.1 Neural-Network Post-Filter Activation SEI Message Syntax

| | Descriptor |
|---|---|
| nn_post_filter_activation( payloadSize ) { | |
| nnpfa_{—}id | ue(v) |
| } | |

### 8.29.2 Neural-Network Post-Filter Activation SEI Message Semantics

This SEI message specifies the neural-network post-processing filter that may be used for post-processing filtering for the current picture.

The neural-network post-processing filter activation SEI message persists only for the current picture.
NOTE—There may be several neural-network post-processing filter activation SEI messages present for the same picture, for example, when the post-processing filters are meant for different purposes or filter different colour components.

nnpfa_id specifies that the neural-network post-processing filter specified by one or more neural-network post-processing filter characteristics SEI messages that pertain to the current picture and have nnpfc_id equal to nnfpa_id may be used for post-processing filtering for the current picture.

### 4. Problems

There are some problems in the current design of neural-network post-filter activation (NNPFA) and neural-network post-filter characteristics (NNPFC) SEI message.
1) The NNPFA and/or NNPFC SEI message persists only for the current picture. However, the neural-network post-processing filter (NNPF) may be effective only for part region of the current picture, such as slice, coding tree unit, coding unit, coding block, region of interest. And NNPF may be also effective for whole sequence such that it is efficient to only signal one NNPFA and/or NNPFC message instead of signal NNPFA and/or NNPFC message for every picture. Therefore, it is necessary to supplement certain region information into NNPFA and/or NNPFC.
2) There may be several NNPFA and/or NNPFC SEI messages present for the same picture. And only one post-processing filter specified by nnpfa_id is activated in one SEI message. However, various content in video unit (such as picture, slice, coding unit, etc. . . . ) may require different post-processing filters. Multiple set of filters may be useful for different content such that multiple groups of syntax elements for multiple sets of filters should be added into one NNPFA and/or NNPFC SEI message and how to use/switch the post-processing filters for video units need to be supplemented in NNPFA and/or NNPFC SEI message.
3) The neural-network post-processing filter could improve the performance of visual quality. Generally speaking, NNPF with higher complexity may produce better performance improvement. In current design, SEI message only provides the complexity characteristic. But the performance characteristic is ignored.

### 5. Detailed Solutions

To solve the above problems, methods as summarized below are disclosed. The solutions should be considered as examples to explain the general concepts and should not be interpreted in a narrow way. Furthermore, these solutions can be applied individually or combined in any manner.
1) It is proposed that the activation and/or enabling and/or presence and/or usage of neural-network post-filter (NNPF) for video units may be controlled by one or multiple groups of syntax elements in a video message unit.
   a. In one example, the video message unit may be a SEI message, such as NNPFA SEI message.
   b. In one example, the group of syntax elements may be expressed as SE_activation.
      i. In one example, SE_activation may comprise multiple syntax elements.
         1. In one example, one or multiple nnpfa_id may be involved in SE_activation.
         a. In one example, multiple filters may be indicated by nnpfa_id[i].
         i. In one example, i is the index of filters.
         2. In one example, the number of NNPF may be involved in SE_activation.
         a. In one example, the number of NNPF may be indicated by nnpfa_num_minus1.
         3. In one example, purpose of range information of color components may be involved in SE_activation.
         4. In one example, the range of color components may be involved in SE_activation.
   c. A video unit may be whole or part or sub-region of a video/sequence/image in the following bullets.
      i. In one example, video unit may be a sequence.
      ii. In one example, video unit may be a picture.
      iii. In one example, video unit may be a slice.
      iv. In one example, video unit may be a tile/brick.
      v. In one example, video unit may be a subpicture.
      vi. In one example, video unit may be one or multiple CTUs/CTBs.
      vii. In one example, video unit may be a CTU/CTB row.
      viii. In one example, video unit may be one or multiple CUs/CBs.
      ix. In one example, video unit may be one or multiple VPDU (Virtual Pipeline Data Unit).
      x. In one example, video unit may be a sub-region within a picture/slice/tile/brick.
   d. A video unit may be one or multiple patches of picture in the following bullets.
      i. In one example, patch is a rectangular array of samples from a component of a picture.
         1. In one example, component may be a luma or chroma component.
         2. In one example, component may be a Y or U(Cb) or V(Cr) component.
         3. In one example, component may be a R or G or B component.
      ii. In one example, patch may be defined in the video message.
         1. In one example, patch size may be acquired from NNPFC SEI message.
         a. In one example, the patch width may be nnpfc_patch_width_minus1+1.
         b. In one example, the patch height may be multiple of (nnpfc_patch_width_minus1+1).
         c. In one example, the patch width may be nnpfc_patch_height_minus1+1.
         d. In one example, the patch height may be multiple of (nnpfc_patch_height_minus1+1).
   e. A video unit may be one or multiple regions of interest (ROI) in the following bullets.
      i. In one example, one ROI may include one or multiple initial point.
         1. In one example, initial point may include horizontal coordinate (x₀).
         2. In one example, initial point may include vertical coordinate (y₀).
      ii. In one example, one ROI may include one or multiple ending point.
         1. In one example, ending point may include horizontal coordinate (xₙ).
         2. In one example, ending point may include vertical coordinate (yₙ).
      iii. In one example, one ROI may include one or multiple size information.
         1. In one example, one ROI may include horizontal samples (width) of region.
         2. In one example, one ROI may include vertical samples (height) of region.
      iv. In one example, one ROI may be specified or decided according to the output of applying image/video segmentation algorithms on the decoded output picture.
         1. In one example, all foreground regions are considered as ROI.
         2. In one example, all background regions are considered as ROI.
         3. In one example, regions corresponding to certain types of content (e.g. car, people, cat, sky, etc.) are considered as ROI.
      v. In one example, one ROI may be specified or decided according to the output of applying image/video object classification/detection algorithms on the decoded output picture.
         1. In one example, regions corresponding to certain/all classes of detected objects are considered as ROI.
         2. In one example, regions not containing any detected objects are considered as ROI.
   f. In one example, whether one or multiple groups of syntax elements should be applied to a video unit (such as a picture or a slice) may depend on the relative relationship when signaling the video unit and the video message unit.
      i. In one example, one or multiple groups of syntax elements should be applied to a video unit signaled after the video message unit.
      ii. In one example, one or multiple groups of syntax elements should be applied to a video unit signaled before the video message unit.
2) The group of syntax elements (expressed as SE_activation) indicating the activation and/or enabling and/or presence and/or usage may depend on color components and/or color formats.
   a. In one example, syntax elements (expressed as SE_color_purpose) indicating the purpose of range information of color components may be added into NNPFA SEI message.
      i. In one example, one (1^{st}) purpose may be that only one group of SE_activation need to be involved in NNPFA SEI message and the activation and/or enabling and/or presence and/or usage controlled by SE_activation are commonly used for available color components specified in NNPFC SEI message.
         1. In one example, the NNPFC SEI message may define the available color components for a post-processing filter identified by syntax element nnpfc_id or it is limited that the filter can be only used for specific color components which are determined by the design of the post filer.
         2. In one example, the value of one syntax element of SE_color_purpose equal to 0 specifies 1^{st} purpose.
      ii. In one example, one (2^{nd}) purpose may be that only one group of SE_activation need to be involved in NNPFA SEI message and the activation and/or enabling and/or presence and/or usage controlled by SE_activation are commonly used for all color components in specified color range (SE_color_range in the following discussion).
         1. In one example, the value of one syntax element of SE_color_purpose equal to 1 specifies 2^{nd} purpose.
      iii. In one example, one (3^{rd}) purpose may be that multiple groups of SE_activation need to be involved in NNPFA SEI message and need to be used for different color components in specified color range (SE_color_range in the following discussion).
         1. In one example, the value of one syntax element of SE_color_purpose equal to 2 specifies 3^{rd} purpose.
      iv. In one example, the syntax elements SE_color purpose may be not signaled.
         1. In one example, one purpose (in above discussion or not) may be set as default purpose.
   b. In one example, syntax elements (expressed as SE_color_range) indicating the range of color components may be added into NNPFA SEI message. SE_activation may be used for all color components in specified color range indicated by SE_color_range.
      i. In one example, the usage of SE_color_range may be depended on the SE_color_purpose.
         1. In one example, when the value of one syntax element of SE_color_purpose equals to 1 or 2 (be equivalent to the 2^{nd} purpose or 3^{rd} purpose in the above discussion) the SE_color_range may be signaled.
         2. In one example, when the value of one syntax element of SE_color_purpose equals to 0 (be equivalent to the 1^{st} purpose in the above discussion) the SE_color_range may be not signaled.
      ii. In one example, SE_activation may be used for color components in specified color range indicated by SE_color_range.
         1. In one example, one group of SE_activation need to be involved in NNPFA SEI message and is commonly used for all available color components.
         2. In one example, multiple groups of SE_activation need to be involved in NNPFA SEI message and are used for different available color components.
         a. In one example, the number of groups of SE_activation may equal to the number of available color components.
      iii. In one example, color range may include Y and/or U(Cb) and/or V(Cr) component.
      iv. In one example, color range may include R and/or G and/or B component.
      v. In one example, the max number of color components in color range may be 3, 2, 1.
   c. In one example, the syntax elements (expressed as SE_activation) may be unified for more than one color components.
      i. In one example, the syntax elements may indicate the activation and/or enabling and/or presence and/or usage of all color component.
         1. In one example, color components include Y and/or Cb and/or Cr components.
         2. In one example, color components include R and/or G and/or B components.
      ii. In one example, the syntax elements may indicate the activation and/or enabling and/or presence and/or usage of chroma components.
         1. In one example, color components include Cb and Cr components.
   d. In one example, the syntax elements (expressed as SE_activation) may be separate for color components.
      i. In one example, the syntax elements may be different for all color components.
         1. In one example, first group of syntax elements may be used for first color component.
         a. In one example, first color component may be Y and/or Cb and/or Cr components. b. In one example, first color component may be R and/or G and/or B components.
         2. In one example, second group of syntax elements may be used for second color component.
         a. In one example, second color component may be Cb and/or Y and/or Cr components.
         b. In one example, second color component may be G and/or R and/or B components.
         3. In one example, third group of syntax elements may be used for third color component.
         a. In one example, third color component may be Cr and/or Y and/or Cb components.
         b. In one example, third color component may be B and/or G and/or R components.
      ii. In one example, the syntax elements (expressed as SE_activation) may be different for luma and chroma color components.
         1. In one example, first group of syntax elements may be used for luma component.
         2. In one example, second group of syntax elements may be used for chroma component.
         a. In one example, second group of syntax elements may be same for Cb and Cr components.
3) How to/whether to signal the group of syntax elements (expressed as SE_activation) indicating the activation and/or enabling and/or presence and/or usage may depend on the number of NNPF.
   a. In one example, one or more syntax elements indicating the number of NNPF may be added into NNPFA SEI message.
      i. In one example, the syntax element may be expressed as nnpfa_num_minus1.
         1. In one example, the number of NNPF may be equal to nnpfa_num_minus1+1.
         2. In one example, the value of nnpfa_num_minus1 shall be in the range of 0 to 2^{k}-1, inclusive. a. In one example, k may be integer, such as 0,1,2,3,4,5,6,7, . . . ,32.
         3. In one example, the value of nnpfa_num_minus1 shall be in the range of 0 to 255, inclusive.
         4. In one example, when nnpfa_num_minus1 is not present, the value of nnpfa_num_minus1 is inferred to be equal to 0.
         5. In one example, nnpfa_num_minus1 may be dependent on the region type of NNPF.
         a. In one example, region type of NNPF may be indicated by nnpfa_region_type.
         b. In one example, nnpfa_num_minus1 may be NOT signaled when nnpfa_region_type is equal to specific value.
         c. In one example, nnpfa_num_minus1 may be NOT signaled when nnpfa_region_type is equal to 0.
      ii. In one example, the number of NNPF may be ue(v)-coded.
   b. In one example, the number of NNPF may be smaller than the max value of nnpfc_id plus one.
   c. In one example, the number of NNPF may be not signaled into NNPFA SEI message.
      i. In one example, the number of NNPF may be set as default value.
      ii. In one example, the number of NNPF may be 1.
4) One or more syntax elements indicating the identification of NNPF may be added into NNPFA SEI message.
   a. In one example, identification of NNPF may be nnpfa_id.
   b. In one example, identification of NNPF may be involved in SE_activation.
   c. In one example, more than one of identification of NNPF may be added into NNPFA SEI message.
      i. In one example, i-th filter may be indicated by nnpfa_id[i].
      ii. In one example, nnpfa_id[i] specifies that the i-th neural-network post-processing filter specified by one or more neural-network post-processing filter characteristics SEI messages that pertain to the current picture and have nnpfc_id equal to nnfpa_id[i] may be used for post-processing filtering for the current picture.
   d. In one example, the number of identifications of NNPF may depend on the color component.
   e. In one example, the number of identifications of NNPF may depend on the number of NNPF.
      i. In one example, the number of NNPF may be indicated by nnpfa_num_minus1.
      ii. In one example, the number of identifications of NNPF may be equal to the number of NNPF (nnpfa_num_minus1+1).
5) One or more syntax elements (expressed as SE_region_type) indicating the region type of NNPF may be added into NNPFA and/or NNPFC SEI message.
   a. In one example, region type of NNPF may be involved in SE_activation.
      i. In one example, region type of NNPF may be indicated by nnpfa_region_type.
   b. In one example, a region may be one type of video unit.
   c. In one example, one or more syntax elements indicating the region scope (SE_region_scope) of NNPF may be added into NNPFA SEI message for corresponding region type.
      i. In one example, region scope of NNPF may be involved in SE_activation.
         1. In one example, region scope of NNPF may be involved when region type is ROI.
      ii. In one example, region scope may depend on the region type.
      iii. In one example, region scope may be or be NOT signaled when the region type is identical to setting value.
         1. In one example, region type is a picture.
   d. In one example, a region may be whole or part or sub-region of a video/sequence/image.
      i. In one example, a region may be a sequence.
      ii. In one example, a region may be a picture.
      iii. In one example, a region may be a slice.
      iv. In one example, a region may be a tile/brick.
      v. In one example, a region may be a subpicture.
      vi. In one example, a region may be one or multiple CTUs/CTBs.
         1. In one example, one or more syntax elements indicating the identification of CTUs/CTBs of NNPF may be added into NNPFA SEI message when the region type is CTUs/CTBs.
         a. In one example, identification of CTUs/CTBs may be indicated by coordinate.
         b. In one example, identification of CTUs/CTBs may be indicated by index one by one (in sequence).
      vii. In one example, a region may be a CTU/CTB row.
         1. In one example, one or more syntax elements indicating the identification of CTU/CTB row of NNPF may be added into NNPFA SEI message when the region type is CTU/CTB row.
         a. In one example, identification of CTU/CTB row may be indicated by coordinate of CTU/CTB row.
         b. In one example, identification of CTU/CTB row may be indicated by index of CTU/CTB row one by one (in sequence).
      viii. In one example, a region may be one or multiple CUs/CBs.
         1. In one example, one or more syntax elements indicating the identification of CUs/CBs of NNPF may be added into NNPFA SEI message when the region type is CTUs/CTBs.
         a. In one example, identification of CUs/CBs may be indicated by coordinate.
         b. In one example, identification of CUs/CBs may be indicated by index one by one (in sequence).
      ix. In one example, a region may be one or multiple VPDU (Virtual Pipeline Data Unit).
         1. In one example, one or more syntax elements indicating the identification of VPDU of NNPF may be added into NNPFA SEI message when the region type is CTUs/CTBs.
         a. In one example, identification of VPDU may be indicated by coordinate.
         b. In one example, identification of VPDU may be indicated by index one by one (in sequence).
      x. In one example, a region may be a sub-region within a picture/slice/tile/brick.
   e. In one example, a region may be one or multiple patches of picture.
      i. In one example, one or more syntax elements indicating the size of patch of NNPF may be added into NNPFA SEI message when the region type is patch.
      ii. In one example, one or more syntax elements indicating the horizontal and/or vertical and/or total number of patches of NNPF may be added into NNPFA SEI message when the region type is patch.
   f. In one example, a region may be one or multiple regions of interest (ROI).
      i. In one example, one or more syntax elements indicating the initial point of ROI of NNPF may be added into NNPFA SEI message when the region type is ROI.
      ii. In one example, one or more syntax elements indicating the ending point of ROI of NNPF may be added into NNPFA SEI message when the region type is ROI.
      iii. In one example, one or more syntax elements indicating the horizontal samples (width) of ROI of NNPF may be added into NNPFA SEI message when the region type is ROI.
      iv. In one example, one or more syntax elements indicating the vertical samples (height) of ROI of NNPF may be added into NNPFA SEI message when the region type is ROI.
   g. In one example, a region may be one or multiple new regions when region type is different with common region type, such as picture, slice and CTU.
      i. In one example, the new regions may be represented by additional information such as dimension and/or position and/or coordinate. And the type of the new region may be different with region type registered in the standards, such as picture, slice, CTU.
         1. In one example, the dimension information of new region may include horizontal samples (width) and/or vertical samples (height).
         2. In one example, the position information of new region may include coordinates of start points such as (x0, y0).
         3. In one example, the position information of new region may include coordinates of end points, such as (x1, y1).
      ii. In one example, one new region may be overlapped with other new regions.
      iii. In one example, one new region may be NOT overlapped with other new regions.
      iv. In one example, the dimension information may be same for all new regions.
         1. In one example, the unified dimension information may be signaled.
      v. In one example, the dimension information may be NOT same for all new regions.
         1. In one example, the dimension information may be signaled for each region.
   h. In one example, region type of NNPF may be NOT signaled.
      i. In one example, region type may be set as a default type.
         1. In one example, region type may be picture level.
      ii. In one example, region type may have a lowest level.
         1. In one example, lowest level of region type may be patch level.
      iii. In one example, usage and/or switch and/or activation of NNPF may be indicated by a certain order.
         1. In one example, sequence level may be applied before picture level.
      i. In one example, nnpfa_region_type equal to 0 indicates that the SEI message activates one neural-network post-filter (NNPF) that is applied for the current picture.
      i. In one example, nnpfa_num_minus1 may be NOT signaled when nnpfa_region_type equal to 0.
   j. In one example, nnpfa_region_type greater than 0 indicates that the SEI message activates one or more NNPFs.
      i. In one example, when nnpfa_region_type is equal to 1, for each slice of the current picture, it is either indicated that no neural-network post-filtering is applied or the applied NNPF is indicated.
      ii. In one example, when nnpfa_region_type is equal to 2, for each CTU of the current picture, it is either indicated that no neural-network post-filtering is applied or the applied NNPF is indicated.
      iii. In one example, when nnpfa_region_type is equal to 3, for picture, and/or each slice, and/or each CTU of the current picture, it is either indicated that no neural-network post-filtering is applied or the applied NNPF is indicated.
      iv. In one example, when nnpfa_region_type is equal to 4, for each sub-region of the current picture, it is either indicated that no neural-network post-filtering is applied or the applied NNPF is indicated.
   k. In one example, the value of nnpfa_region_type shall be in the range of 0 to 31, inclusive. Values of nnpfa_region_type greater than 2 or 3 or 4 are reserved for future specification by ITU-T|ISO/IEC and shall not be present in bitstreams conforming to this version of this Specification.
   l. In one example, decoders conforming to the Specification shall ignore NNPFA SEI messages with nnpfa_region_type greater than 2 or 3 or 4.
   m. In one example, nnpfa_region_type may be ue(v)-coded.
6) One or more syntax elements indicating usage and/or switch and/or activation of NNPF may be added into NNPFA SEI message.
   a. The syntax elements may depend on the region type.
      i. In one example, only syntax elements at the region level of specified region type may be added into NNPFA SEI message.
         1. In one example, NNPFA SEI message may comprise syntax element indicating NNPF at picture level when region type is picture.
         a. In one example, the usage of NNPF at picture level may be indicated by nnpfa_picture_enabling_flag[i].
         i. In one example, only one NNPF is indicated by nnpfa_id in NNPFA SEI message.
         b. In one example, the usage of NNPF at picture level may be indicated by nnpfa_picture_index[i].
         i. In one example, one or multiple NNPF are indicated by nnpfa_id[i] in NNPFA SEI message.
         2. In one example, NNPFA SEI message may comprise syntax element indicating NNPF at slice level when region type is slice.
         a. In one example, the usage of NNPF at slice level may be indicated by nnpfa_slice_enabling_flag[i].
         i. In one example, only one NNPF is indicated by nnpfa_id in NNPFA SEI message.
         b. In one example, the usage of NNPF at slice level may be indicated by nnpfa_slice_index[i].
         i. In one example, one or multiple NNPF are indicated by nnpfa_id[i] in NNPFA SEI message.
         3. In one example, NNPFA SEI message may comprise syntax element indicating NNPF at CTU level when region type is CTU.
         a. In one example, the usage of NNPF at CTU level may be indicated by nnpfa_ctu_enabling_flag[i].
         i. In one example, only one NNPF is indicated by nnpfa_id in NNPFA SEI message.
         b. In one example, the usage of NNPF at CTU level may be indicated by nnpfa_ctu_index[i]. i. In one example, one or multiple NNPF are indicated by nnpfa_id[i] in NNPFA SEI message.
      4. In one example, NNPFA SEI message may comprise syntax element indicating NNPF at new region level when region type is new region type which may be represented by additional information such as dimension and/or position and/or coordinate.
         a. In one example, the usage of NNPF at CTU level may be indicated by nnpfa_region_enabling_flag[i].
         i. In one example, only one NNPF is indicated by nnpfa_id in NNPFA SEI message.
         b. In one example, the usage of NNPF at CTU level may be indicated by nnpfa_region_index[i].
         i. In one example, one or multiple NNPF are indicated by nnpfa_id[i] in NNPFA SEI message.
   b. One or more syntax elements indicating usage of NNPF at the region (video unit) level may be added into NNPFA SEI message.
      i. In one example, syntax elements for different region level may be signaled following certain order.
         1. In one example, syntax element of higher region level may be signaled before lower region level.
         2. In one example, syntax element of region may be signaled when the region type is equal to nnpfa_region_type.
         a. In one example, nnpfa_picture_index[i] is signaled when nnpfa_region_type is equal to 0 or 3.
         b. In one example, nnpfa_picture_enabling_flag[i] is signaled when nnpfa_region_type is equal to 0 or 3.
         c. In one example, nnpfa_slice_index[i] is signaled when nnpfa_region_type is equal to 1 or 3.
         d. In one example, nnpfa_slice_enabling_flag[i] is signaled when nnpfa_region_type is equal to 1 or 3.
         e. In one example, nnpfa_ctu_index[i] is signaled when nnpfa_region_type is equal to 2 or 3.
         f. In one example, nnpfa_ctu_enabling_flag[i] is signaled when nnpfa_region_type is equal to 2 or 3.
         g. In one example, nnpfa_region_index[i] is signaled when nnpfa_region_type is equal to 4.
      ii. In one example, one syntax element may indicate whether the NNPF is used in the current region level.
         1. In one example, syntax element equal to 0 may indicates that the NNPF is not used in current region.
         a. In one example, syntax element may be nnpfa_slice_enabling_flag[i], nnpfa_ctu_enabling_flag[i].
         b. In one example, syntax element may be nnpfa_slice_index[i], nnpfa_ctu_index[i].
         2. In one example, syntax element equal to 1 may indicates that the NNPF is used in current region.
         a. In one example, syntax element may be nnpfa_slice_enabling_flag[i], nnpfa_ctu_enabling_flag[i].
         3. In one example, syntax element greater than 0 may indicates that the NNPF is used in current region.
         a. In one example, syntax element may be nnpfa_slice_index[i], nnpfa_ctu_index[i].
         b. In one example, syntax element should be smaller than nnpfa_num_minus1+2.
         4. In one example, syntax element equal to nnpfa_num_minus1+2 may indicate that the NNPF is used in sub-region of the current region.
         a. In one example, syntax element may be nnpfa_slice_index[i], nnpfa_ctu_index[i].
      iii. In one example, one syntax element may indicate how to select the NNPF in the current region level or which NNPF is used in the current region level.
         1. In one example, syntax element greater than 0 may indicates that the NNPF with index (syntax element−1) is used in current region.
         a. In one example, syntax element may be nnpfa_slice_index[i], nnpfa_ctu_index[i].
         2. In one example, syntax element smaller than maxNnpfNum may indicates that the NNPF with index (syntax element) is used in current region.
      iv. In one example, one syntax element may indicate whether the NNPF is adaptively used in the next (lower) region level.
         1. In one example, syntax element equal to 0 may indicates that the NNPF is adaptively selected in next region level.
         2. In one example, syntax element equal to maxNnpfNum may indicates that the NNPF is adaptively selected in next region level.
         3. In one example, syntax element equal to (maxNnpfNum−1) may indicates that the NNPF is adaptively selected in next region level.
      v. In one example, the signaling of syntax element at current region level may depend on the syntax element at previous (higher) region level.
      vi. In one example, area of region A is larger than the area of region B may indicates that level of region A is greater than level of region B and level of region B is lower than level of region A.
         1. In one example, picture level is lower than sequence level.
         2. In one example, slice level is lower than picture level.
         3. In one example, CTU level is lower than slice level.
         4. In one example, CU level is lower than CTU level.
         5. In one example, CU level is lower than CTU level.
   c. One or more syntax elements indicating usage of NNPF at the sequence level may be added into NNPFA SEI message.
      i. In one example, syntax element may indicate that NNPF is applied at sequence level or a lower level.
      ii. In one example, syntax element at sequence level may be NOT signaled.
   d. One or more syntax elements indicating usage of NNPF at the TID level may be added into NNPFA SEI message.
      i. In one example, syntax element at TID level may depend on the syntax element at higher level.
      ii. In one example, syntax element may indicate that NNPF is applied at TID level or a lower level.
         1. In one example, syntax element indicating TID index may be added into NNPFA SEI message.
      iii. In one example, syntax element at TID level may be NOT signaled.
   e. One or more syntax elements indicating usage of NNPF at the picture level may be added into NNPFA SEI message.
      i. In one example, syntax element at picture level may depend on the syntax element at higher level.
      ii. In one example, syntax element may indicate that NNPF is applied at picture level or a lower level.
      iii. In one example, syntax element may indicate that NNPF is applied or not at picture level.
      iv. In one example, syntax element may indicate that index of NNPF which is applied at picture level.
      v. In one example, syntax element at picture level may be NOT signaled.
      vi. In one example, usage of NNPF at the picture level may be indicated by nnpfa_picture_enabling_flag.
         1. In one example, nnpfa_picture_enabling_flag equal to 2 indicates that the post-processing filter is used for sub-region of the current picture.
         a. In one example, sub-region of the current picture may be in slice/sub block/CTU/CTB/patch level.
         b. In one example, the usage of i-th sub-region of the current picture may be indicated by nnpfa_slice_enabling_flag[i].
         c. In one example, the usage of i-th sub-region of the current picture may be indicated by nnpfa_ctu_enabling_flag[i].
         d. In one example, the usage of i-th sub-region of the current picture may be indicated by nnpfa_region_enabling_flag[i].
         2. In one example, nnpfa_picture_enabling_flag equal to 1 indicates that the post-processing filter is used for the current picture.
         3. In one example, nnpfa_picture_enabling_flag equal to 0 indicates that the post-processing filter is not used for the current picture.
   vii. In one example, usage of NNPF at the picture level may be indicated by nnpfa_picture_index.
      1. n one example, nnpfa_picture_index equal to 0 indicates that neural-network post-filtering is not used for the current picture.
      2. In one example, nnpfa_picture_index greater than 0 indicates that the NNPF with nnpfc_id equal to nnpfa_id[nnpfa_picture_index−1] is used for the current picture.
         a. In one example, nnpfa_picture_index should be smaller than nnpfa_num_minus1+2.
      3. In one example, nnpfa_picture_index equal to nnpfa_num_minus1+2 indicates that the post-processing filter may be used for sub-region of the current picture.
         a. In one example, sub-region of the current picture may be in slice/sub block/CTU/CTB/patch level.
         b. In one example, the usage of i-th sub-region of the current picture may be indicated by nnpfa_slice_index[i].
         c. In one example, the usage of i-th sub-region of the current picture may be indicated by nnpfa_ctu_index[i].
         d. In one example, the usage of i-th sub-region of the current picture may be indicated by nnpfa_region_index[i].
      4. In one example, the value of nnpfa_picture_index shall be in the range of 0 to nnpfa_num_minus1+1, inclusive.
      5. In one example, the value of nnpfa_picture_index shall be in the range of 0 to nnpfa_num_minus1+2, inclusive.
   f. One or more syntax elements indicating usage of NNPF at the slice level may be added into NNPFA SEI message.
      i. In one example, syntax element at slice level may depend on the syntax element at higher level.
      ii. In one example, syntax element may indicate that NNPF is applied at slice level or a lower level.
      iii. In one example, syntax element at slice level may be NOT signaled.
      iv. In one example, usage of NNPF at the slice level may be indicated by nnpfa_slice_enabling_flag[i].
         1. In one example, nnpfa_slice_enabling_flag[i] equal to 2 indicates that the post-processing filter is used for sub-region of the i-th slice of the current picture.
         a. In one example, sub-region of the i-th slice of the current picture may be in sub block/CTU/CTB/patch level.
         b. In one example, the usage of j-th sub-region of the i-th slice of the current picture may be indicated by nnpfa_ctu_enabling_flag[j].
         2. In one example, nnpfa_slice_enabling_flag[i] equal to 1 indicates that the post-processing filter is used for the i-th slice of the current picture.
         3. In one example, nnpfa_slice_enabling_flag[i] equal to 0 indicates that the post-processing filter is not used for the i-th slice of the current picture.
      v. In one example, usage of NNPF at the slice level may be indicated by nnpfa_slice_index[i].
         1. In one example, nnpfa_slice_index[i] equal to 0 indicates that neural-network post-filtering is not used for the i-th slice of the current picture.
         2. In one example, nnpfa_slice_index[i] greater than 0 indicates that the NNPF with nnpfc_id equal to nnpfa_id[nnpfa_slice_index[i]−1] is used for the i-th slice of the current picture.
         a. In one example, nnpfa_slice_index[i] should be smaller than nnpfa_num_minus1+2.
         3. In one example, nnpfa_slice_index[i] equal to nnpfa_num_minus1+2 indicates that the post-processing filter may be used for sub-region of the i-th slice of the current picture.
         a. In one example, sub-region of the i-th slice of the current picture may be in sub block/CTU/CTB/patch level.
         b. In one example, the usage of j-th sub-region of the i-th slice of the current picture may be indicated by nnpfa_ctu_index[j].
         4. In one example, the value of nnpfa_slice_index[i] shall be in the range of 0 to nnpfa_num_minus1+1, inclusive.
         5. In one example, the value of nnpfa_slice_index[i] shall be in the range of 0 to nnpfa_num_minus1+2, inclusive.
   g. One or more syntax elements indicating usage of NNPF at the sub block/CTU/CTB/patch level may be added into NNPFA SEI message.
      i. In one example, syntax element at sub block/CTU/CTB/patch level may depend on the syntax element at higher level (e.g., picture/slice/sequence level).
      ii. In one example, syntax element may indicate that NNPF is applied or not at block/CTU/CTB/patch level.
      iii. In one example, syntax element may indicate that index of NNPF which is applied at block/CTU/CTB/patch level.
      iv. In one example, syntax element may indicate that NNPF is applied at sub block/CTU/CTB/patch level or a lower level.
      v. In one example, syntax element at sub block/CTU/CTB/patch level may be NOT signaled.
      vi. In one example, usage of NNPF at the CTU level may be indicated by nnpfa_ctu_enabling_flag[i].
         1. In one example, nnpfa_ctu_enabling_flag[i] equal to 1 indicates that the post-processing filter is used for the i-th CTU of the current picture.
         2. In one example, nnpfa_ctu_enabling_flag[i] equal to 0 indicates that the post-processing filter is not used for the i-th CTU of the current picture.
      vii. In one example, usage of NNPF at the CTU level may be indicated by nnpfa_ctu_index[i].
         1. In one example, nnpfa_ctu_index[i] equal to 0 indicates that neural-network post-filtering is not used for the i-th CTU of the current picture.
         2. In one example, nnpfa_ctu_index[i] greater than 0 indicates that the NNPF with nnpfc_id equal to nnpfa_id[nnpfa_ctu_index[i]−1] is used for the i-th CTU of the current picture.
         3. In one example, the value of nnpfa_ctu_index[i] shall be in the range of 0 to nnpfa_num_minus1+1, inclusive.
   h. One or more syntax elements indicating usage of NNPF at the ROI level may be added into NNPFA SEI message.
      i. In one example, syntax element at ROI level may depend on the syntax element at higher level.
      ii. In one example, syntax element may indicate that NNPF is applied at ROI level or a lower level.
      iii. In one example, syntax element at ROI level may be NOT signaled.
   i. One or more syntax elements indicating usage of NNPF at the new region level may be added into NNPFA SEI message.
      i. In one example, syntax element at new region level may depend on the syntax element at higher level (e.g., picture/slice/sequence level).
      ii. In one example, syntax element may indicate that NNPF is applied or not at new region level.
      iii. In one example, syntax element may indicate that index of NNPF which is applied at new region level.
      iv. In one example, syntax element may indicate that NNPF is applied at new region level or a lower level.
      v. In one example, syntax element at new region level may be NOT signaled.
      vi. In one example, usage of NNPF at the new region level may be indicated by nnpfa_region_enabling_flag[i].
         1. In one example, nnpfa_region_enabling_flag[i] equal to 1 indicates that the post-processing filter is used for the i-th new region of the current picture.
         2. In one example, nnpfa_region_enabling_flag[i] equal to 0 indicates that the post-processing filter is not used for the i-th new region of the current picture.
      vii. In one example, usage of NNPF at the new region level may be indicated by nnpfa_region_index[i].
         1. In one example, nnpfa_region_index[i] equal to 0 indicates that neural-network post-filtering is not used for the i-th new region of the current picture.
         2. In one example, nnpfa_region_index[i] greater than 0 indicates that the NNPF with nnpfc_id equal to nnpfa_id[nnpfa_region_index[i]−1] is used for the i-th new region of the current picture.
         3. In one example, the value of nnpfa_region_index[i] shall be in the range of 0 to nnpfa_num_minus1+1, inclusive.
      viii. In one example, additional information such dimension and/or position as of new region may be indicated by adding syntax element into NNPF SEI message.
         1. In one example, horizontal samples or width of i-th new region may be indicated by nnpfa_region_width[i].
         2. In one example, vertical samples or height of i-th new region may be indicated by nnpfa_region_height[i].
         3. In one example, starting point in horizontal or x direction of i-th new region may be indicated by nnpfa_region_x0[i].
         4. In one example, starting point in vertical or y direction of i-th new region may be indicated by nnpfa_region_v0[i].
         5. In one example, ending point in horizontal or x direction of i-th new region may be indicated by nnpfa_region_x1[i].
         6. In one example, ending point in vertical or y direction of i-th new region may be indicated by nnpfa_region_v1[i].
         7. In one example, whether the dimension is same for all new regions may be indicated by nnpfa_region_dim_flag.
         a. In one example, nnpfa_region_dim_flag equal to 0 indicated that width and height may be same for all new regions.
         b. In one example, nnpfa_region_dim_flag equal to 1 indicated that width and height may be different for all new regions.
         8. In one example, whether new regions are overlapped may be indicated by nnpfa_region_overlap_flag.
         a. In one example, nnpfa_region_overlap_flag equal to 0 indicated that new regions are NOT overlapped.
         b. In one example, nnpfa_region_overlap_flag equal to 1 indicated that there are some common samples or areas for new regions.
   j. In one example, the syntax element in NNPFA SEI message may be used for the same video unit/region until meeting a new sequence/SEI.
   k. In one example, the syntax element in NNPFA SEI message may be used for the nearest video unit/region.
7) One or more syntax elements indicating improvement/promotion of NNPF may be added into NNPFA and/or NNPFC SEI message.
   a. One or more syntax elements indicating performance indicator (or purpose) of NNPF may be added into NNPFA and/or NNPFC SEI message.
      i. In one example, purpose may be improving subjective/objective quality.
   b. One or more syntax elements indicating performance level of NNPF may be added into NNPFA and/or NNPFC SEI message.
      i. In one example, performance level may be normalized value.
      ii. In one example, performance level may be different or same for different performance indicator (purpose).
   c. One or more syntax elements indicating complexity level of NNPF may be added into NNPFA and/or NNPFC SEI message.
      i. In one example, complexity level may be normalized value.
8) It is proposed that the multiple NNPF and/or characteristics of NNPF may be indicated by adding one or multiple groups of syntax elements into NNPFC SEI message.
   a. In one example, one or more syntax elements indicating the number of NNPF may be added into NNPFC SEI message.
      i. In one example, the syntax element may be expressed as nnpfc_num_minus1.
         1. In one example, the number of NNPF may be equal to nnpfc_num_minus1+1.
         2. In one example, the value of nnpfc_num_minus1 shall be in the range of 0 to 2^{k}-1, inclusive.
         a. In one example, k may be integer, such as 0,1,2,3,4,5,6,7, . . . ,32.
      ii. In one example, the number of NNPF may be ue (v)-coded.
      iii. In one example, the number of NNPF may be smaller than the max value of nnpfc_id plus one.
   b. In one example, the number of NNPF may be not signaled into NNPFC SEI message.
      i. In one example, the number of NNPF may be set as default value.
      ii. In one example, the number of NNPF may be 1, 2, 3, 4, 5.
   c. In one example, the number of multiple groups of syntax elements indicating characteristics of NNPF may depend on the number of multiple sets of NNPF.
      i. In one example, the number of groups of syntax elements indicating characteristics of NNPF may equal to the number of NNPF.
   d. In one example, multiple groups of syntax elements indicating characteristics of NNPF may be signaled for each/all/different NNPF.
      i. In one example, every NNPF may have one group of syntax elements indicating characteristics of NNPF.
      ii. In one example, multiple groups of syntax elements may be signaled following a certain order.
         1. In one example, the group of syntax elements may be signaled one by one.
      iii. In one example, i^{th} group of syntax elements indicating characteristics of NNPF may be used for i^{th} NNPF.
         1. In one example, 1^{st} group of syntax elements indicating characteristics of NNPF may be used for 1^{st} NNPF.
         2. In one example, 2^{nd} group of syntax elements indicating characteristics of NNPF may be used for 2^{nd} NNPF.
         3. In one example, 3^{rd} group of syntax elements indicating characteristics of NNPF may be used for 3^{rd} NNPF.
      iv. In one example, the design of each group of syntax elements may be same.
         1. In one example, the number and/or items of each group of syntax elements may be same.
         2. In one example, nnpfc_id may be involved in every group of syntax elements.
         3. In one example, nnpfc_mode_idc may be involved in every group of syntax elements.
9) To solve problem 3, one or more of the following syntax elements indicating information of quality improvements brought by NNPF may be signalled in the NNPFA SEI message.
   a. In one example, an indication is signalled to indicate whether the quality improvements information is signalled.
      i. In one example, when it is indicated that the quality improvements information is signalled, one or more of the following syntax elements indicating quality changes and quality metric types are signalled.
         1. In one example, these elements indicate the quality improvements of the whole video sequence.
         2. In one example, these elements indicate the quality improvements of one or more pictures.
         3. In one example, the quality metric type is signalled.
         a. In one example, the quality metric type may be PSNR.
         b. In one example, the quality metric type may be SSIM.
         c. In one example, the quality metric type may be MS-SSIM.
         d. In one example, the quality metric type may be VMAF.
         4. In one example, the quality change is signalled and indicated by the signalled quality metric type.
         a. In one example, the quality change is the video quality difference between applying and not applying NNPF.
         b. In one example, alternatively, the quality change is the video quality difference between not applying and applying NNPF.
         5. In one example, multiple quality metric types and quality changes are signalled for one NNPFA SEI message.
         a. In one example, an indication is signalled to indicate the number of quality metric types.
         i. In one example, multiple quality metric types and quality changes are signalled after this indication.
      ii. In one example, when it is indicated that the quality improvements information is not signalled, no further syntax elements are signalled.
   b. In one example the quality improvements information is always signalled in the NNPFA SEI message.

### 6. Embodiments

Below are some example embodiments for the solution aspects summarized above in Section 5. Most relevant parts that have been added or modified are shown by using bolded words (e.g., this format indicates added text), and some of the deleted parts are shown by using words in italics between double curly brackets (e.g., {{this format indicates deleted text}}). There may be some other changes that are editorial in nature and thus not highlighted. It should be understood that only markings in this section are intended to emphasize at least part of proposed changes.

### 6.1. Embodiment 1

8.28.1 Neural-network post-filter
characteristics SEI message syntax

| | Descriptor |
|---|---|
| nn_post_filter_characteristics( payloadSize ) { | |
| nnpfc_{—}num_{—}minus1 | ue(v) |
| for( n = 0; n < nnpfcNum; n++ ) { | |
| nnpfc_id | ue(v) |
| nnpfc_mode_idc | ue(v) |
| nnpfc_purpose_and_formatting_flag | u(1) |
| if( nnpfc_purpose_and_formatting_flag ) { | |
| nnpfc_purpose | ue(v) |
| if( nnpfc_purpose = = 2 \|\| nnpfc_purpose = = 4 ) | |
| nnpfc_out_sub_c_flag | u(1) |
| if( nnpfc_purpose = = 3 \|\| nnpfc_purpose = = 4 ) { | |
| nnpfc_pic_width_in_luma_samples | ue(v) |
| nnpfc_pic_height_in_luma_samples | ue(v) |
| } | |
| /* input and output formatting */ | |
| nnpfc_component_last_flag | u(1) |
| nnpfc_inp_format_flag | u(1) |
| if( nnpfc_inp_format_flag = = 1 ) | |
| nnpfc_inp_tensor_bitdepth_minus8 | ue(v) |
| nnpfc_inp_order_idc | ue(v) |
| nnpfc_auxiliary_inp_idc | ue(v) |
| nnpfc_separate_colour_description_present_flag | u(1) |
| if( nnpfc_separate_colour_description_present_flag | |
| ) { | |
| nnpfc_colour_primaries | u(8) |
| nnpfc_transfer_characteristics | u(8) |
| nnpfc_matrix_coeffs | u(8) |
| } | |
| nnpfc_out_format_flag | u(1) |
| if( nnpfc_out_format_flag = = 1 ) | |
| nnpfc_out_tensor_bitdepth_minus8 | ue(v) |
| nnpfc_out_order_idc | ue(v) |
| nnpfc_constant_patch_size_flag | u(1) |
| nnpfc_patch_width_minus1 | ue(v) |
| nnpfc_patch_height_minus1 | ue(v) |
| nnpfc_overlap | ue(v) |
| nnpfc_padding_type | ue(v) |
| if( nnpfc_padding_type = = 4 ){ | |
| nnpfc_luma_padding_val | ue(v) |
| nnpfc_cb_padding_val | ue(v) |
| nnpfc_cr_padding_val | ue(v) |
| } | |
| nnpfc_complexity_idc | ue(v) |
| if( nnpfc_complexity_idc > 0 ) | |
| nnpfc_complexity_element( | |
| nnpfc_complexity_idc ) | |
| if( nnpfc_mode_idc = = 2 ) { | |
| while( !byte_aligned( ) ) | |
| nnpfc_reserved_zero_bit | u(1) |
| nnpfc_uri_tag[ i ] | st(v) |
| nnpfc_uri[ i ] | st(v |
| } | |
| } | |
| /* filter specified or updated by ISO/IEC 15938-17 | |
| bitstream */ | |
| if( nnpfc_mode_idc = = 1 ) { | |
| while( !byte_aligned( ) ) | |
| nnpfc_reserved_zero_bit | u(1) |
| for( i = 0; more_data_in_payload( ); i++ ) | |
| nnpfc_payload_byte[ i ] | b(8) |
| } | |
| } | |
| } | |

### 8.28.2 Neural-Network Post-Filter Characteristics SEI Message Semantics

nnpfc_num_minus1 indicates the maximum number of neural-network post processing filter. The value nnpfc_num_minus1 shall be in the range of 0 to 2³²-2, inclusive. The variable nnpfcNum is derived as:

$$nnpfcNum = nnpfc\_num \_minus1 + 1 \qquad ( 1 )$$

### 6.2. Embodiment 2

### 8.29.1 Neural-Network Post-Filter Activation SEI Message Syntax

| | Descriptor |
|---|---|
| nn_post_filter_activation( payloadSize ) { | |
| nnpfa_{—}num_{—}minus1 | ue(v) |
| for( n = 0; n < nnpfaNum; n++ ) { | |
| nnpfa_id | ue(v) |
| } | |
| } | |

### 8.29.2 Neural-Network Post-Filter Activation SEI Message Semanitcs

nnpfa_num_minus1 indicates the maximum number of neural-network post processing filter. The value nnpfa_num_minus1 shall be in the range of 0 to 2³²-2, inclusive. The variable nnpfcNum is derived as:

$$nnpfaNum = nnpfa\_num \_minus1 + 1 \qquad ( 2 )$$

### 6.3. Embodiment 3

### 8.29.1 Neural-Network Post-Filter Activation SEI Message Syntax

| | Descriptor |
|---|---|
| nn_post_filter_activation( payloadSize ) { | |
| nnpfa_id | ue(v) |
| nnpfa_{—}region_{—}type | ue(v) |
| if (nnpfa_{—}region_{—}type == 1) { | |
| for (i = 0; i < maxSliceNum; i++) { | |
| nnpfa_{—}slice_{—}enabling_{—}flag | u(1) |
| } | |
| } else if (nnpfa_{—}region_{—}type == 2) { | |
| for (i = 0; i < maxCtuNum; i++) { | |
| nnpfa_{—}ctu_{—}enabling_{—}flag | u(1) |
| } | |
| } | |
| } | |

### 8.29.2 Neural-Network Post-Filter Activation SEI Message Semanitcs

maxSliceNum is the max number of slices in current picture.

maxCtuNum is the max number of coding tree unit in current picture.

nnpfa_region_type indicates the region type of using the post-processing filter as specified in Table 1. The value of nnpfa_region_type shall be in the range of 0 to 2³²-2, inclusive.

nnpfa_region_type equal to 0 specifies that post-processing filter is used in picture.

nnpfa_region_type equal to 1 specifies that post-processing filter is applied in slice and usage in slice may be determined later. nnpfa_region_type equal to 2 specifies that post-processing filter is applied in slice and usage in CTU may be determined later.

TABLE 1
Definition of nnpfa_region_type

| Value | Interpretation |
|---|---|
| 0 | Picture, always use post-processing filter in current picture |
| 1 | Slice |
| 2 | CTU |

nnpfa_slice_enabling_flag equal to 1 specifies that post-processing filter is used to the current slice.

nnpfa_slice_enabling_flag equal to 0 specifies that post-processing filter is not used to the current slice.

nnpfa_ctu_enabling_flag equal to 1 specifies that post-processing filter is
used to the current CTU.
nnpfa_ctu_enabling_flag equal to 0 specifies that post-processing filter is
not used to the current CTU.

### 6.4. Embodiment 4

### 8.29.1 Neural-Network Post-Filter Activation SEI Message Syntax

| | Descriptor |
|---|---|
| nn_post_filter_activation( payloadSize ) { | |
| nnpfa_{—}num_{—}minus1 | ue(v) |
| for( n = 0; n < nnpfaNum; n++ ) { | |
| nnpfa_id | ue(v) |
| } | |
| nnpfa_{—}region_{—}type | ue(v) |
| if (nnpfa_{—}region_{—}type == 0) { | |
| nnpfa_{—}picture_{—}index | ue(v) |
| } else if (nnpfa_{—}region_{—}type == 1) { | |
| for (i = 0; i < maxSliceNum; i++) { | |
| nnpfa_{—}slice_{—}index | ue(v) |
| } | |
| } else if (nnpfa_{—}region_{—}type == 2) { | |
| for (i = 0; i < maxCtuNum; i++) { | |
| nnpfa_{—}ctu_{—}index | ue(v) |
| } | |
| } | |
| } | |

### 8.29.2 Neural-Network Post-Filter Activation SEI Message Semanitcs

maxCtuNum is the max number of coding tree unit in current picture.

nnpfa_num_minus1 indicates the maximum number of neural-network post processing filter. The value nnpfa_num_minus1 shall be in the range of 0 to 2³²-2, inclusive. The variable nnpfcNum is derived as:

$$nnpfaNum = nnpfa\_num \_minus1 + 1 \qquad ( 2 )$$

nnpfa_region_type indicates the region type of using the post-processing filter as specified in Table 1. The value of nnpfa_region_type shall be in the range of 0 to 2³²-2, inclusive.

nnpfa_region_type equal to 0 specifies that post-processing filter is applied in picture and usage in picture may be determined later. nnpfa_region_type equal to 1 specifies that post-processing filter is applied in slice and usage in slice may be determined later. nnpfa_region_type equal to 2 specifies that post-processing filter is applied in slice and usage in CTU may be determined later.

TABLE 1
Definition of nnpfa_region_type

| Value | Interpretation |
|---|---|
| 0 | Picture |
| 1 | Slice |
| 2 | CTU |

nnpfa_picture_index indicates the usage of post-processing filter in picture. When nnpfa_picture_index equal to 0 specifies that post-processing filter is not used to the current picture. When nnpfa_picture_index greater than 0 specifies that post-processing filter with the index (nnpfa_picture_index−1) is used to the current picture.

nnpfa_ctu_index indicates the usage of post-processing filter in CTU. When nnpfa_ctu_index equal to 0 specifies that post-processing filter is not used to the current CTU. When nnpfa_ctu_index greater than 0 specifies that post-processing filter with the index (nnpfa_ctu_index−1) is used to the current CTU.

### 6.5. Embodiment 5

| | Descriptor |
|---|---|
| nn_post_filter_activation( payloadSize ) { | |
| nnpfa_id | ue(v) |
| nnpfa_{—}picture_{—}index | u(1) |
| if (nnpfa_{—}picture_{—}index == 0) { | |
| for (i = 0; i < maxCtuNum; i++) { | |
| nnpfa_{—}ctu_{—}index | u(1) |
| } | |
| } | |
| } | |

### 8.29.2 Neural-Network Post-Filter Activation SEI Message Semanitcs

maxCtuNum is the max number of coding tree unit in current picture.

nnpfa_picture_index indicates the usage of post-processing filter in picture. When nnpfa_picture_index equal to 1 specifies that post-processing filter is used in the current picture. When nnpfa picture_index equal to 0 specifies that post-processing filter is adaptively used in CTU.

nnpfa_ctu_index indicates the usage of post-processing filter in CTU. When nnpfa_ctu_index equal to 0 specifies that post-processing filter is not used to the current CTU. When nnpfa_ctu_index equal to 1 specifies that post-processing filter is used to the current CTU.

### 6.6. Embodiment 6

### 8.29.1 Neural-Network Post-Filter Activation SEI Message Syntax

| | Descriptor |
|---|---|
| nn_post_filter_activation( payloadSize ) { | |
| nnpfa_{—}num_{—}minus1 | ue(v) |
| for( n = 0; n < nnpfaNum; n++ ) { | |
| nnpfa_id | ue(v) |
| } | |
| nnpfa_{—}picture_{—}index | ue(v) |
| if (nnpfa_{—}picture_{—}index == nnpfaNum) { | |
| for (i = 0; i < maxCtuNum; i++) { | |
| nnpfa_{—}ctu_{—}index | ue(v) |
| } | |
| } | |
| } | |

### 8.29.2 Neural-Network Post-Filter Activation SEI Message Semanitcs

maxCtuNum is the max number of coding tree unit in current picture.

nnpfa_num_minus1 indicates the maximum number of neural-network post processing filter. The value nnpfa_num_minus1 shall be in the range of 0 to 2³²-2, inclusive. The variable nnpfcNum is derived as:

$$nnpfaNum = nnpfa\_num \_minus1 + 1 \qquad ( 2 )$$

nnpfa_picture_index indicates the usage of post-processing filter in picture. When nnpfa_picture_index smaller than maxCtuNum specifies that post-processing filter with the index (nnpfa_picture_index) is used in the current picture. When nnpfa_picture_index equal to maxCtuNum specifies that post-processing filter is adaptively used in CTU.

nnpfa_ctu_index indicates the usage of post-processing filter in CTU. When nnpfa_ctu_index equal to 0 specifies that post-processing filter is not used to the current CTU. When nnpfa_ctu_index greater than 0 specifies that post-processing filter with the index (nnpfa_ctu_index−1) is used to the current CTU.

### 6.7. Embodiment 7

### 8.29.1 Neural-Network Post-Filter Activation SEI Message Syntax

| | Descriptor |
|---|---|
| nn_post_filter_activation( payloadSize ) { | |
| nnpfa_id | ue(v) |
| nnpfa_{—}region_{—}type | ue(v) |
| if (nnpfa_{—}region_{—}type == 1) { | |
| for (i = 0; i < maxSliceNum; i++) { | |
| nnpfa_{—}slice_{—}enabling_{—}flag | u(1) |
| } | |
| } else if (nnpfa_{—}region_{—}type == 2) { | |
| for (i = 0; i < maxCtuNum; i++) { | |
| nnpfa_{—}ctu_{—}enabling_{—}flag | u(1) |
| } | |
| } | |
| } | |

### 8.29.2 Neural-Network Post-Filter Activation SEI Message Semantics

maxSliceNum is the max number of slices in current picture.

maxCtuNum is the max number of coding tree unit in current picture.

nnpfa_region_type indicates the region type of using the post-processing filter as specified in Table 1. The value of nnpfa_region_type shall be in the range of 0 to 2³²-2, inclusive.

nnpfa_region_type equal to 0 specifies that post-processing filter is used for picture. nnpfa_region_type equal to 1 specifies that post-processing filter is applied for slice and usage in slice may be determined later. nnpfa_region_type equal to 2 specifies that post-processing filter is applied for CTU and usage in CTU may be determined later. Values of nnpfa_region_type that do not appear in Table 1 are reserved for future specification by ITU-T|ISO/IEC and shall not be present in bitstreams conforming to this version of this Specification. Decoders conforming to this version of this Specification shall ignore SEI messages that contain reserved values of nnpfa_region_type.

TABLE 1
Definition of nnpfa_region_type

| Value | Interpretation |
|---|---|
| 0 | The post-processing filter is used for picture level and is |
| | activated for current picture. |
| 1 | The post-processing filter is used for slice level and the |
| | usage of each slice can be determined independently. |
| 2 | The post-processing filter is used for CTU level and the |
| | usage of each CTU can be determined independently. |

nnpfa_slice_enabling_flag equal to 1 specifies that post-processing filter is used to the current slice. nnpfa_slice_enabling_flag equal to 0 specifies that post-processing filter is not used to the current slice. The value of nnpfa_slice_enabling_flag shall be in the range of 0 to 1, inclusive.

nnpfa_ctu_enabling_flag equal to 1 specifies that post-processing filter is used to the current CTU. nnpfa_ctu_enabling_flag equal to 0 specifies that post-processing filter is not used to the current CTU. The value of nnpfa_ctu_enabling_flag shall be in the range of 0 to 1, inclusive.

### 6.8. Embodiment 8

| | Descriptor |
|---|---|
| nn_post_filter_activation( payloadSize ) { | |
| nnpfa_{—}num_{—}minus1 | ue(v) |
| for( n = 0; n < nnpfaNum; n++ ) { | |
| nnpfa_id | ue(v) |
| } | |
| nnpfa_{—}region_{—}type | ue(v) |
| if (nnpfa_{—}region_{—}type == 0) { | |
| nnpfa_{—}picture_{—}index | ue(v) |
| } else if (nnpfa_{—}region_{—}type == 1) { | |
| for (i = 0; i < maxSliceNum; i++) { | |
| nnpfa_{—}slice_{—}index | ue(v) |
| } | |
| } else if (nnpfa_{—}region_{—}type == 2) { | |
| for (i = 0; i < maxCtuNum; i++) { | |
| nnpfa_{—}ctu_{—}index | ue(v) |
| } | |
| } | |
| } | |

### 8.29.2 Neural-Network Post-Filter Activation SEI Message Semantics

maxSliceNum is the max number of slices in current picture.

maxCtuNum is the max number of coding tree unit in current picture.

nnpfa_num_minus1 indicates the number of neural-network post-processing filter. nnpfa_num_minus1 shall be in the range of 0 to 2³²-2, inclusive. The variable nnpfcNum is derived as:

$$nnpfaNum = nnpfa\_num \_minus1 + 1 \qquad ( 1 )$$

nnpfa_region_type indicates the region type of using the post-processing filter as specified in Table 1. The value of nnpfa_region_type shall be in the range of 0 to 2³²-2, inclusive. nnpfa_region_type equal to 0 specifies that post-processing filter is applied in picture and usage in picture may be determined later. nnpfa_region_type equal to 1 specifies that post-processing filter is applied in slice and usage in slice may be determined later. nnpfa_region_type equal to 2 specifies that post-processing filter is applied in CTU and usage in CTU may be determined later. Values of nnpfa_region_type that do not appear in Table 1 are reserved for future specification by ITU-T|ISO/IEC and shall not be present in bitstreams conforming to this version of this Specification. Decoders conforming to this version of this Specification shall ignore SEI messages that contain reserved values of nnpfa_region_type.

TABLE 1
Definition of nnpfa_region_type

| Value | Interpretation |
|---|---|
| 0 | The post-processing filter is used for picture level and multiple |
| | filters can be selected for picture. |
| 1 | The post-processing filter is used for slice level and multiple |
| | filters can be selected for each slice. |
| 2 | The post-processing filter is used for CTU level and multiple |
| | filters can be selected for each CTU. |

nnpfa_picture_index indicates the usage of post-processing filter for picture. When nnpfa_picture_index equal to 0 specifies that post-processing filter is not used for the current picture. When nnpfa_picture_index greater than 0 specifies that post-processing filter with the index (nnpfa_picture_index−1) is used for the current picture. The value of nnpfa_picture_index shall be in the range of 0 to Min(2³²-1, nnpfaNum), inclusive.

nnpfa_slice_index indicates the usage of post-processing filter for slice. When nnpfa_slice_index equal to 0 specifies that post-processing filter is not used for the current slice. When nnpfa_slice_index greater than 0 specifies that post-processing filter with the index (nnpfa_slice_index−1) is used for the current slice. The value of nnpfa_slice_index shall be in the range of 0 to Min(2³²-1, nnpfaNum).

nnpfa_ctu_index indicates the usage of post-processing filter in CTU. When nnpfa_ctu_index equal to 0 specifies that post-processing filter is not used for the current CTU. When nnpfa_ctu_index greater than 0 specifies that post-processing filter with the index (nnpfa_ctu_index−1) is used for the current CTU. The value of nnpfa_ctu_index shall be in the range of 0 to Min(2³²-1, nnpfaNum).

### 6.9. Embodiment 9

### 8.29.1 Neural-Network Post-Filter Activation SEI Message Syntax

| | Descriptor |
|---|---|
| nn_post_filter_activation( payloadSize ) { | |
| nnpfa_id | ue(v) |
| nnpfa_{—}region_{—}type | ue(v) |
| if( nnpfa_{—}region_{—}type = = 1 ) | |
| for( i = 0; i < numSlices; i++) | |
| nnpfa_{—}slice_{—}enabling_{—}flag[ i ] | u(1) |
| else if( nnpfa_{—}region_{—}type = = 2 ) | |
| for( i = 0; i < numCtus; i++) | |
| nnpfa_{—}ctu_{—}enabling_{—}flag[ i ] | u(1) |
| } | |

### 8.29.2 Neural-Network Post-Filter Activation SEI Message Semantics

nnpfa_region_type indicates the region type of using the post-processing filter. nnpfa_region_type equal to 0 indicates that the post-processing filter is used for the current picture. nnpfa_region_type equal to 1 indicates that the post-processing filter is applied for some slices of the current picture. nnpfa_region_type equal to 2 indicates that the post-processing filter is applied for some CTUs of the current picture. The value of nnpfa_region_type shall be in the range of 0 to 31, inclusive. Values of nnpfa_region_type greater than 2 are reserved for future specification by ITU-T|ISO/IEC and shall not be present in bitstreams conforming to this version of this Specification. Decoders conforming to this version of this Specification shall ignore NNPFA SEI messages with nnpfa_region_type greater than 2.

If nnpfa_region_type is equal to 1, the variable numSlices is set equal to the number of slices in the current picture. Otherwise, when nnpfa_region_type is equal to 2, the variable numCTUs is set equal to the number of CTUs in the current picture.

nnpfa_slice_enabling_flag[i] equal to 1 indicates that the post-processing filter is used for the i-th slice of the current picture. nnpfa_slice_enabling_flag[i] equal to 0 indicates that the post-processing filter is not used for the i-th slice of the current picture.

nnpfa_ctu_enabling_flag[i] equal to 1 indicates that the post-processing filter is used for the i-th CTU of the current picture. nnpfa_ctu_enabling_flag equal to 0 indicates that the post-processing filter is not used for the i-th CTU of the current picture.

### 6.10. Embodiment 10

### 8.29.1 Neural-Network Post-Filter Activation SEI Message Syntax

| | Descriptor |
|---|---|
| nn_post_filter_activation( payloadSize ) { | |
| nnpfa_{—}region_{—}type | ue(v) |
| if( nnpfa_{—}region_{—}type > 0 ) | |
| nnpfa_{—}num_{—}minus1 | ue(v) |
| for( i = 0; i <= nnpfa_{—}num_{—}minus1; i++ ) | |
| nnpfa_id[ i ] | ue(v) |
| if( nnpfa_{—}region_{—}type = = 1 ) | |
| for (i = 0; i < numSlices; i++) | |
| nnpfa_{—}slice_{—}index[ i ] | ue(v) |
| else if( nnpfa_{—}region_{—}type = = 2 ) | |
| for( i = 0; i < numCtus; i++ ) | |
| nnpfa_{—}ctu_{—}index[ i ] | ue(v) |
| } | |

### 8.29.2 Neural-Network Post-Filter Activation SEI Message Semantics

nnpfa_region_type indicates the region type of using the post-processing filter. nnpfa_region_type equal to 0 indicates that the SEI message activates one neural-network post-filter (NNPF) that is applied for the current picture. nnpfa_region_type greater than 0 indicates that the SEI message activates one or more NNPFs. When nnpfa_region_type is equal to 1, for each slice of the current picture, it is either indicated that no neural-network post-filtering is applied or the applied NNPF is indicated. When nnpfa_region_type is equal to 2, for each CTU of the current picture, it is either indicated that no neural-network post-filtering is applied or the applied NNPF is indicated. The value of nnpfa_region_type shall be in the range of 0 to 31, inclusive. Values of nnpfa_region_type greater than 2 are reserved for future specification by ITU-T|ISO/IEC and shall not be present in bitstreams conforming to this version of this Specification. Decoders conforming to this version of this Specification shall ignore NNPFA SEI messages with nnpfa_region_type greater than 2.

If nnpfa_region_type is equal to 1, the variable numSlices is set equal to the number of slices in the current picture. Otherwise, when nnpfa_region_type is equal to 2, the variable numCTUs is set equal to the number of CTUs in the current picture.

nnpfa_num_minus1 plus 1 indicates the number of NNPFs activated by the SEI message. The value of nnpfa_num_minus1 shall be in the range of 0 to 255, inclusive. When not present, the value of nnpfa_num_minus1 is inferred to be equal to 0.

nnpfa_id[i] specifies that the i-th neural-network post-processing filter specified by one or more neural-network post-processing filter characteristics SEI messages that pertain to the current picture and have nnpfc_id equal to nnfpa_id[i] may be used for post-processing filtering for the current picture.

nnpfa_slice_index[i] indicates the usage of neural-network post-filtering for the i-th slice of the current picture. nnpfa_slice_index[i] equal to 0 indicates that neural-network post-filtering is not used for the i-th slice of the current picture. nnpfa_slice_index[i] greater than 0 indicates that the NNPF with nnpfc_id equal to nnpfa_id[nnpfa_slice_index[i]−1] is used for the i-th slice of the current picture. The value of nnpfa_slice_index[i] shall be in the range of 0 to nnpfa_num_minus1+1, inclusive.

nnpfa_ctu_index[i] indicates the usage of neural-network post-filtering for the i-th CTU of the current picture. nnpfa_ctu_index[i] equal to 0 indicates that neural-network post-filtering is not used for the i-th CTU of the current picture. nnpfa_ctu_index[i] greater than 0 indicates that the NNPF with nnpfc_id equal to nnpfa_id[nnpfa_ctu_index[i]−1] is used for the i-th CTU of the current picture. The value of nnpfa_ctu_index[i] shall be in the range of 0 to nnpfa_num_minus1+1, inclusive.

### 6.11. Embodiment 11

This embodiment is for the solution items 9 and all the subitems summarized above in Section 5.

### 8.29.1 Neural-Network Post-Filter Activation SEI Message Syntax

| | Descriptor |
|---|---|
| nn_post_filter_activation( payloadSize ) { | |
| nnpfa_target_id | ue(v) |
| nnpfa_cancel_flag | u(1) |
| if( !nnpfa_cancel_flag ) { | |
| nnpfa_persistence_flag | u(1) |
| nnpfa_{—}quality_{—}info_{—}present_{—}flag | u(1) |
| if( nnpfa_{—}quality_{—}info_{—}present_{—}flag ) { | |
| nnpfa_{—}metric_{—}type | u(8) |
| nnpfa_{—}metric_{—}value_{—}diff | i(16) |
| } | |
| } | |
| } | |

### 8.29.2 Neural-Network Post-Filter Activation SEI Message Semanites

The neural-network post-filter activation (NNPFA) SEI message activates or de-activates the possible use of the target neural-network post-processing filter, identified by nnpfa_target_id, for post-processing filtering of a set of pictures.
NOTE 1—There can be several NNPFA SEI messages present for the same picture, for example, when the post-processing filters are meant for different purposes or filter different colour components.

nnpfa_target_id indicates the target neural-network post-processing filter, which is specified by one or more neural-network post-processing filter characteristics SEI messages that pertain to the current picture and have nnpfc_id equal to nnfpa_target_id.

The value of nnpfa_target_id shall be in the range of 0 to 2³²-2, inclusive. Values of nnpfa_target_id from 256 to 511, inclusive, and from 2³¹ to 2³²-2, inclusive, are reserved for future use by ITU-T|ISO/IEC. Decoders conforming to this edition of this document encountering an NNPFA SEI message with nnpfa_target_id in the range of 256 to 511, inclusive, or in the range of 2³¹ to 2³²-2, inclusive, shall ignore the SEI message.

An NNPFA SEI message with a particular value of nnpfa_target_id shall not be present in a current PU unless one or both of the following conditions are true:
Within the current CLVS there is an NNPFC SEI message with nnpfc_id equal to the particular value of nnpfa_target_id present in a PU preceding the current PU in decoding order.
There is an NNPFC SEI message with nnpfc_id equal to the particular value of nnpfa_target_id in the current PU.

When a PU contains both an NNPFC SEI message with a particular value of nnpfc_id and an NNPFA SEI message with nnpfa_target_id equal to the particular value of nnpfc_id, the NNPFC SEI message shall precede the NNPFA SEI message in decoding order.

nnpfa_cancel_flag equal to 1 indicates that the persistence of the target neural-network post-processing filter established by any previous NNPFA SEI message with the same nnpfa_target_id as the current SEI message is cancelled, i.e., the target neural-network post-processing filter is no longer used unless it is activated by another NNPFA SEI message with the same nnpfa_target_id as the current SEI message and nnpfa_cancel_flag equal to 0. nnpfa_cancel_flag equal to 0 indicates that the nnpfa persistence_flag follows.

nnpfa persistence_flag specifies the persistence of the target neural-network post-processing filter for the current layer.

nnpfa persistence_flag equal to 0 specifies that the target neural-network post-processing filter may be used for post-processing filtering for the current picture only.

nnpfa_persistence_flag equal to 1 specifies that the target neural-network post-processing filter may be used for post-processing filtering for the current picture and all subsequent pictures of the current layer in output order until one or more of the following conditions are true:
A new CLVS of the current layer begins.
The bitstream ends.
A picture in the current layer associated with a NNPFA SEI message with the same nnpfa_target_id as the current SEI message and nnpfa_cancel_flag equal to 1 is output that follows the current picture in output order.
NOTE 2—The target neural-network post-processing filter is not applied for this subsequent picture in the current layer associated with a NNPFA SEI message with the same nnpfa_target_id as the current SEI message and nnpfa_cancel_flag equal to 1.

nnpfa_quality_info_present_flag equal to 1 specifies that one or more syntax elements that indicate the quality information of the post processing filter associated with the nnpfa_target_id are present. nnpfa_quality_info_present_flag equal to 0 specifies that no syntax elements that indicate the quality information of the post processing filter associated with the nnpfa_target_id are present.

nnpfa_metric_type indicates the type of the objective quality metric as shown in the following table:

TABLE X
specification of nnpfa_metric_type

| Value | Description |
|---|---|
| 0 | PSNR |
| 1 | SSIM |
| 2 | wPSNR |
| 3-255 | User-defined |

nnpfa_metric_value_diff specifies the difference of metric values, with the difference being equal to Q_{WNNPF}−Q_{WONNPF}, where Q_{WNNPF} denotes the averaged metric value across all the pictures to which this NNPFA SEI message applies after applying the associated NNPF and Q_{WONNPF} denotes the averaged metric value across the same set of pictures without applying the associated NNPF.

When nnpfa_metric_type is equal to 0, the 16-bit signed integer nnpfa_metric_value_diff is interpreted as a floating-point V_{PSNR} value (in dB) as follows, with m set equal to nnpfa metric_value_diff:

$${V}_{P S N R} = \frac{m}{100}$$

When nnpfa_metric_type is equal to 1, the 16-bit signed integer nnpfa_metric_value_diff is interpreted as a floating-point V_{SSIM} value as follows, with m set equal to nnpfa metric_value_diff:

$${V}_{S S I M} = \frac{m}{100}$$

When nnpfa_metric_type is equal to 2, the 16-bit signed integer nnpfa_metric_value_diff is interpreted as a floating-point wPSNR value (in dB) as follows, with m set equal to nnpfa metric_value_diff:

$${V}_{w P S N R} = \frac{m}{100}$$

### 6.12. Embodiment 12

This embodiment is for the solution items 9 and all their subitems summarized above in Section 5.

### 8.29.1 Neural-Network Post-Filter Activation SEI Message Syntax

| | Descriptor |
|---|---|
| nn_post_filter_activation( payloadSize ) { | |
| nnpfa_target_id | ue(v) |
| nnpfa_cancel_flag | u(1) |
| if( !nnpfa_cancel_flag ) { | |
| nnpfa_persistence_flag | u(1) |
| nnpfa_{—}quality_{—}info_{—}present_{—}flag | u(1) |
| if( nnpfa_{—}quality_{—}info_{—}present_{—}flag ) { | |
| nnpfa_{—}metric_{—}number | u(8) |
| for( n = 0; n < nnpfa_{—}metric_{—}number; n++ ) | |
| { | |
| nnpfa_{—}metric_{—}type[ i ] | u(8) |
| nnpfa_{—}metric_{—}value_{—}diff[ i ] | i(16) |
| } | |
| } | |
| } | |
| } | |

### 8.29.2 Neural-Network Post-Filter Activation SEI Message Semanitcs

nnpfa_quality_info_present_flag equal to 1 specifies that one or more syntax elements that indicate the quality information of the post processing filter associated with the nnpfa_target_id are present. nnpfa_quality_info_present_flag equal to 0 specifies that no syntax elements that indicate the quality information of the post processing filter associated with the nnpfa_target_id are present.

nnpfa_metric_number specifies the number of signalled metric types.

nnpfa_metric_type[i] indicates the i-th type of objective quality metric as shown in the following table:

TABLE X
specification of nnpfa_metric_type

| Value | Description |
|---|---|
| 0 | PSNR |
| 1 | SSIM |
| 2 | wPSNR |
| 3-255 | User-defined |

nnpfa_metric_value_diff[i] specifies the difference of metric values of the i-th type of objective quality metric, with the difference being equal to Q_{WNNPF}−Q_{WONNPF}, where Q_{WNNPF} denotes the averaged metric value across all the pictures to which this NNPFA SEI message applies after applying associated NNPF and Q_{WONNPF} denotes the averaged metric value across the same set of pictures without using associated NNPF.

When nnpfa_metric_type[i] is equal to 0, the 16-bit signed integer nnpfa_metric_value_diff[i] is interpreted as a floating-point V_{PSNR} value (in dB) as follows, with m set equal to nnpfa metric_value_diff[i]:

$${V}_{P S N R} = \frac{m}{100}$$

When nnpfa_metric_type[i] is equal to 1, the 16-bit signed integer nnpfa_metric_value_diff[i] is interpreted as a floating-point V_{SSIM} value as follows, with m set equal to nnpfa metric_value_diff[i]:

$${V}_{S S I M} = \frac{m}{100}$$

When nnpfa_metric_type[i] is equal to 2, the 16-bit signed integer nnpfa_metric_value_diff[i] is interpreted as a floating-point wPSNR value (in dB) as follows, with m set equal to nnpfa metric_value_diff[i]:

$${V}_{w P S N R} = \frac{m}{100}$$

### 6.13. Embodiment 13

This embodiment is for the solution items 9 and all their subitems summarized above in Section 5.

### 8.29.1 Neural-Network Post-Filter Activation SEI Message Syntax

| | Descriptor |
|---|---|
| nn_post_filter_activation( payloadSize ) { | |
| nnpfa_target_id | ue(v) |
| nnpfa_cancel_flag | u(1) |
| if( !nnpfa_cancel_flag ) { | |
| nnpfa_persistence_flag | u(1) |
| nnpfa_{—}quality_{—}info_{—}present_{—}flag | u(1) |
| if( nnpfa_{—}quality_{—}info_{—}present_{—}flag ) { | |
| nnpfa_{—}metric_{—}type | u(8) |
| nnpfa_{—}metric_{—}value_{—}without_{—}nnpf | u(16) |
| nnpfa_{—}metric_{—}value_{—}with_{—}nnpf | u(16) |
| } | |
| } | |
| } | |

### 8.29.2 Neural-Network Post-Filter Activation SEI Message Semanitcs

nnpfa_quality_info_present_flag equal to 1 specifies that one or more syntax elements that indicate the quality information of the post processing filter associated with the nnpfa_target_id are present. nnpfa_quality_info_present_flag equal to 0 specifies that no syntax elements that indicate the quality information of the post processing filter associated with the nnpfa_target_id are present.

nnpfa_metric_type indicates the type of the objective quality metric as shown in the following table:

TABLE X
specification of nnpfa_metric_type

| Value | Description |
|---|---|
| 0 | PSNR |
| 1 | SSIM |
| 2 | wPSNR |
| 3-255 | User-defined |

nnpfa_metric_value_without_nnpf specifies the averaged metric value across all the pictures to which this NNPFA SEI message applies without applying associated NNPF.

When nnpfa_metric_type is equal to 0, the 16-bit unsigned integer nnpfa metric_value_without_nnpf is interpreted as a floating-point V_{PSNR} value (in dB) as follows, with m set equal to nnpfa metric_value_without_nnpf:

$${V}_{P S N R} = \frac{m}{100}$$

When nnpfa_metric_type is equal to 1, the 16-bit unsigned integer nnpfa metric_value_without_nnpf is interpreted as a floating-point V_{SSIM} value as follows, with m set equal to nnpfa metric_value_without_nnpf:

$${V}_{S S I M} = \frac{m}{100}$$

When nnpfa_metric_type is equal to 2, 2 the 16-bit unsigned integer nnpfa metric_value_without_nnpf is interpreted as a floating-point wPSNR value (in dB) as follows, with m set equal to nnpfa metric_value_without_nnpf:

$${V}_{w P S N R} = \frac{m}{100}$$

nnpfa metric_value_with_nnpf specifies the averaged metric value across all the pictures to which this NNPFA SEI message applies by applying the associated NNPF.

When nnpfa_metric_type is equal to 0, the 16-bit unsigned integer nnpfa metric_value_with_nnpf is interpreted as a floating-point V_{PSNR} value (in dB) as follows, with m set equal to nnpfa metric_value_with_nnpf:

$${V}_{P S N R} = \frac{m}{100}$$

When nnpfa_metric_type is equal to 1, the 16-bit unsigned integer nnpfa metric_value_with_nnpf is interpreted as a floating-point V_{SSIM} value as follows, with m set equal to nnpfa metric_value_with_nnpf:

$${V}_{S S I M} = \frac{m}{100}$$

When nnpfa_metric_type is equal to 2, the 16-bit unsigned integer nnpfa metric_value_with_nnpf is interpreted as a floating-point wPSNR value (in dB) as follows, with m set equal to nnpfa metric_value_with_nnpf:

$${V}_{w P S N R} = \frac{m}{100}$$

More details of the embodiments of the present disclosure will be described below which are related to neural-network post-processing filter (NNPF). The embodiments of the present disclosure should be considered as examples to explain the general concepts and should not be interpreted in a narrow way. Furthermore, these embodiments can be applied individually or combined in any manner.

As used herein, the term “video unit” may represent a color component, a sub-picture, a picture, a slice, a tile, a coding tree unit (CTU), a CTU row, groups of CTU, a coding unit (CU), a prediction unit (PU), a transform unit (TU), a coding tree block (CTB), a coding block (CB), a prediction block (PB), a transform block (TB), a sub-block of a video block, a sub-region within a video block, a video processing unit comprising multiple samples/pixels, and/or the like. A video unit may be rectangular or non-rectangular. Moreover, the term “neural-network post-processing filter” and “neural-network post-filter” may be used interchangeably.

As used herein, a chroma component may comprise a Cb component and/or a Cr component. For example, the Cb component may represent a blue-difference chroma component and the Cr component may represent a red-difference chroma component. In another example, Cb and Cr components may be substituted by U and V components. It should be understood that the Cb component and/or the Cr component may represent any other suitable color component. The scope of the present disclosure is not limited in this respect.

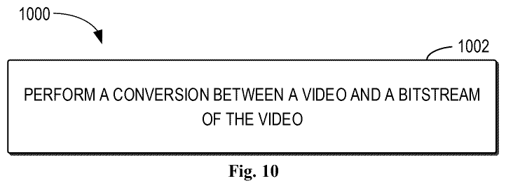

FIG. 10 illustrates a flowchart of a method 1000 for video processing in accordance with some embodiments of the present disclosure. As shown in FIG. 10, at 1002, a conversion between a video and a bitstream of the video is performed. In some embodiments, the conversion may include encoding the video into the bitstream. Alternatively or additionally, the conversion may include decoding the video from the bitstream.

At least one neural-network post-processing filter (NNPF) is applied on at least one video unit associated with the video. The bitstream comprises a first indication indicating whether quality information of the at least one video unit associated with the applying of the at least one NNPF is present in the bitstream. By way of example rather than limitation, the first indication may be implemented as a syntax element in the bitstream.

In some embodiments, the at least one video unit may comprise at least one picture associated with the video. For example, the at least one picture may be used as an input for the NNPF. In some embodiments, the at least one picture may comprise at least one decoded picture of the video. Alternatively, the at least one picture may comprise at least one cropped decoded picture of the video. For example, the decoded picture and/or the cropped decoded picture may be outputted by a decoder that decodes the video from the bitstream. In some further embodiments, the at least one picture may comprise an output of a further NNPF used to filter one or more decoded pictures or cropped decoded pictures of the video. For example, the NNPF is concatenated with the further NNPF. It should be understood that the possible implementations of the at least one video unit associated with the video described here are merely illustrative and therefore should not be construed as limiting the present disclosure in any way.

In some embodiments, if the first indication indicates that the quality information is not present in the bitstream, at least one indication indicating the quality information may be not present in the bitstream. If the first indication indicates that the quality information is present in the bitstream, at least one indication indicating the quality information may be present in the bitstream. Alternatively, the at least one indication indicating the quality information may be present in the bitstream independently from the first indication. That is, regardless of the first indication, the quality information is always indicated in the bitstream.

In some embodiments, the quality information may comprise one or more metric types for measuring quality of the at least one video unit. For example, the one or more metric types may comprise peak signal-to-noise ratio (PSNR), structural similarity (SSIM), multi scale structural similarity (MS-SSIM), video multi-method assessment fusion (VMAF), and/or the like. Alternatively, one or more predetermined metric types may be used and not indicated in the bitstream.

Additionally or alternatively, the quality information may comprise one or more quality changes of the at least one video unit that correspond to the one or more metric types. Each of the one or more quality changes is caused by the applying of the at least one NNPF and measured based on the corresponding metric type. In a case where the quality change indicates a quality improvement, this quality change may also be regard as a gain obtained by the applying of the at least one NNPF.

In one example embodiment, one of the one or more quality changes may be determined based on a difference between quality of the at least one video unit after the at least one NNPF being applied and quality of the at least one video unit without the at least one NNPF being applied. In another example embodiment, one of the one or more quality changes may be determined based on a difference between quality of the at least one video unit without the at least one NNPF being applied and quality of the at least one video unit after the at least one NNPF being applied.

In some additional or alternative embodiments, the quality information may comprise one or more quality values of the at least one video unit after the at least one NNPF being applied. The one or more quality values correspond to the one or more metric types, and each of the one or more quality values is measured based on the corresponding metric type. It should be understood that the quality information may comprise any other suitable information, and the scope of the present disclosure is not limited in this respect.

In view of the above, an indication indicating whether quality information of at least one video unit associated with the applying of the at least one NNPF is present in the bitstream. Compared with the conventional solution, the proposed method can advantageously enable the application of NNPF based on the quality information, and thus the coding quality can be improved.

In some embodiments, the at least one video unit may comprise a whole video sequence of the video. In this case, the at least one indication indicates the quality information of the whole video sequence. In some further embodiments, the at least one video unit may comprise a single picture of the video. In this case, the at least one indication indicates the quality information of the single picture. Alternatively, the at least one video unit may comprise a plurality of pictures of the video. In this case, the at least one indication indicates the quality information of the plurality of pictures. It should be understood that the at least one video may also be a portion of picture, and the scope of the present disclosure is not limited in this respect.

In some embodiments, the one or more metric types may comprise a plurality of metric types, and the one or more quality changes may also comprise a plurality of quality changes. In addition, the bitstream may comprise a second indication indicating the number of the plurality of metric types. Moreover, the at least one indication indicating the quality information may follow the second indication in the bitstream. In other words, the at least one indication is signaled after the second indication.

In some embodiments, one of more of the above-mentioned indications (e.g., the first indication, the second indication, and/or the at least one indication) may be comprised in a video message unit in the bitstream. By way of example, the video message unit may be a supplemental enhancement information (SEI) message, such as a neural-network post-filter activation (NNPFA) SEI message, or the like. It should be understood that the above-mentioned indication(s) may be comprised in any other suitable video message unit, and the scope of the present disclosure is not limited in this respect.

In view of the above, the solutions in accordance with some embodiments of the present disclosure can advantageously improve coding efficiency of the quality information.

In some embodiments, the bitstream may further comprise at least one first syntax element indicating a type of the at least one video unit. One of candidates for the type may be a first region type, which may be a new region type different from the existing region types in VVC standard, such as a picture, a slice, a coding tree unit, and the like. For example, the at least one first syntax element may be implemented as a syntax element nnpfa_region_type.

It should be understood that the name for an indication and/or a syntax element is used only for illustration rather than limitation, the indications and the syntax elements mentioned throughout the present disclosure may be represented by any other suitable string different from the example in this disclosure. The scope of the present disclosure is not limited in this respect.

In some embodiments, if the type of the at least one video unit is the first region type, the at least one video unit may comprise one or more regions. For example, a region in the one or more regions may be represented by information comprising a dimension of the region, a position of the region, and/or a coordinate of the region. By way of example rather than limitation, the dimension of the region may comprise a width of the region and/or a height of the region. Additionally or alternatively, the dimension of the region may comprise horizontal samples of the region and/or vertical samples of the region. A position of the region may comprise a coordinate of a start point of the region and/or a coordinate of an end point of the region. In some embodiments, all of the one or more regions may have a same dimension.

In this case, the same dimension may be indicated in the bitstream. Alternatively, the one or more regions may have different dimensions. In this case, a dimension for each of the one or more regions may be indicated in the bitstream.

In some embodiments, a region in the one or more regions may be overlapped with a further region. Alternatively, a region in the one or more regions may be not overlapped with a further region.

In some embodiments, if the at least one first syntax element is equal to a first value (such as 3 or the like), no NNPF may be applied for a current picture and/or a slice of the current picture and/or a CTU of the current picture, or an NNPF applied for the current picture may be indicated. If the at least one first syntax element is equal to a second value (such as 4 or the like), no NNPF may be applied for a sub-region of the current picture, or an NNPF applied for the current picture may be indicated.

In some embodiments, a value of the at least one first syntax element may be in a first predetermined range, and values of the at least one first syntax element greater than a third value may be reserved and absent from the bitstream. Additionally, an NNPFA SEI message with the at least one first syntax element greater than the third value may be ignored. By way of example rather than limitation, the first predetermined range may be from 0 to 31, the third value may be one of 2, 3, or 4. It should be understood that the specific values recited herein are intended to be exemplary rather than limiting the scope of the present disclosure.

In some embodiments, a syntax element nnpfa_picture_enabling_flag[i] in an NNPFA SEI message in the bitstream indicates a usage of NNPF at a picture level. For example, only one NNPF may be indicated by a syntax element nnpfa_id in the NNPFA SEI message. In some further embodiments, a syntax element nnpfa_picture_index[i] in an NNPFA SEI message in the bitstream indicates a usage of NNPF at a picture level. For example, one or more NNPFs may be indicated by a syntax element nnpfa_id[i] in the NNPFA SEI message.

In some embodiments, a syntax element nnpfa_slice_enabling_flag[i] in an NNPFA SEI message in the bitstream indicates a usage of NNPF at a slice level, and only one NNPF may be indicated by a syntax element nnpfa_id in the NNPFA SEI message. In some further embodiments, a syntax element nnpfa_slice_index[i] in an NNPFA SEI message in the bitstream indicates a usage of NNPF at a slice level, and one or more NNPFs may be indicated by a syntax element nnpfa_id[i] in the NNPFA SEI message.

In some embodiments, a syntax element nnpfa_ctu_enabling_flag[i] in an NNPFA SEI message in the bitstream indicates a usage of NNPF at a coding tree unit (CTU) level, and only one NNPF may be indicated by a syntax element nnpfa_id in the NNPFA SEI message. In some embodiments, a syntax element nnpfa_ctu_index[i] in an NNPFA SEI message in the bitstream indicates a usage of NNPF at a CTU level, and one or more NNPFs may be indicated by a syntax element nnpfa_id[i] in the NNPFA SEI message.

In some embodiments, if the type of the at least one video unit is the first region type, an NNPFA SEI message in the bitstream may comprise a syntax element indicating activation of the at least one

NNPF at a region level. By way of example rather than limitation, a syntax element nnpfa_region_enabling_flag[i] in the NNPFA SEI message indicates a usage of NNPF at the region level. For example, only one NNPF may be indicated by a syntax element nnpfa_id in the NNPFA SEI message. Alternatively, a syntax element nnpfa_region_index[i] in an NNPFA SEI message in the bitstream indicates a usage of NNPF at the region level. For example, one or more NNPFs may be indicated by a syntax element nnpfa_id[i] in the NNPFA SEI message.

In some embodiments, if the at least one first syntax element is equal to a fourth value, a syntax element nnpfa_picture_index[i] and/or a syntax element nnpfa_picture_enabling_flag[i] may be indicated in the bitstream. If the at least one first syntax element is equal to a fifth value, a syntax element nnpfa_slice_index[i] and/or a syntax element nnpfa_slice_enabling_flag[i] may be indicated in the bitstream. If the at least one first syntax element is equal to a sixth value, a syntax element nnpfa_ctu_index[i] and/or a syntax element nnpfa_ctu_enabling_flag[i] may be indicated in the bitstream. If the at least one first syntax element is equal to a seventh value, a syntax element nnpfa_region_index[i] may be indicated in the bitstream. By way of example rather than limitation, the fourth value may be 0 or 3, or the fifth value may be 1 or 3, or the sixth value may be 2 or 3, or the seventh value may be 4.

In some embodiments, a syntax element indicating whether NNPF is used in current region may be required to be smaller than an eighth value, the eight value may be determined based on the number of NNPFs. For example, the syntax element should be smaller than nnpfa_num_minus1+2, where the syntax element nnpfa_num_minus1 is equal to the number of NNPFs minus one.

In some embodiments, a syntax element indicating whether NNPF is used in a subregion of the current region equal to the eighth value indicates that the NNPF is used in the subregion. By way of example rather than limitation, the syntax element may be nnpfa_slice_index[i] or nnpfa_ctu_index[i].

In some embodiments, the bitstream may comprise a syntax element nnpfa_picture_enabling_flag indicating whether NNPF is used at a picture level. For example, the syntax element nnpfa_picture_enabling_flag equal to a first value indicates that the NNPF may be used for a subregion of a current picture. By way of example, the subregion may be in slice level, sub block level, CTU level, coding tree block (CTB) level, or patch level. In some embodiments, i may be an integer, and a usage of the i-th subregion of the current picture may be indicated by a syntax element nnpfa_slice_enabling_flag[i], a syntax element nnpfa_ctu_enabling_flag[i], or a syntax element nnpfa_region_enabling_flag[i].

The syntax element nnpfa_picture_enabling_flag equal to a second value indicates that the NNPF may be used for the current picture. The syntax element nnpfa_picture_enabling_flag equal to a third value indicates that the NNPF may be not used for the current picture. By way of example rather than limitation, the first value may be 2, the second value may be 1, or the third value may be 0.

In some embodiments, the bitstream may comprise a syntax element nnpfa_picture_index indicating whether NNPF is used at a picture level. For example, the syntax element nnpfa_picture_index equal to a first value (such as 0 or the like) indicates that the NNPF may be not used for a current picture. The syntax element nnpfa_picture_index larger than the first value indicates that the NNPF with nnpfc_id equal to nnpfa_id[nnpfa_picture_index−1] may be used for the current picture. Alternatively, the syntax element nnpfa_picture_index larger than the first value and smaller than a second value indicates that the NNPF with nnpfc_id equal to nnpfa_id[nnpfa_picture_index−1] may be used for the current picture. The second value may be determined based on the number of NNPFs, such as nnpfa_num_minus1+2 or the like. The syntax element nnpfa_picture_index equal to the second value indicates that the NNPF may be allowed to be used for a sub-region of the current picture.

In some embodiments, the subregion may be in slice level, sub block level, CTU level, CTB level, patch level, or the like. A usage of the i-th subregion of the current picture may be indicated by a syntax element nnpfa_slice_index[i], a syntax element nnpfa_ctu_index[i], or a syntax element nnpfa_region_index[i].

In some embodiments, a value of the syntax element nnpfa_picture_index may be in a range determined based on the number of NNPFs. In one example, a value of the syntax element nnpfa_picture_index may be in the range of 0 to nnpfa_num_minus1+1, inclusive. In another example, a value of the syntax element nnpfa_picture_index may be in the range of 0 to nnpfa_num_minus1+2, inclusive.

In some embodiments, a syntax element nnpfa_slice_enabling_flag[i] in the bitstream equal to a first value indicates that NNPF may be used for a sub-region of the i-th slice of a current picture, and i may be an integer. For example, the subregion may be in sub block level, CTU level, CTB level, or patch level. The bitstream may comprise a syntax element nnpfa_ctu_enabling_flag[j] indicating a usage of the j-th sub-region of the i-th slice of the current picture, and j may be an integer.

In some embodiments, the bitstream may comprise a syntax element nnpfa_slice_index[i] indicating whether NNPF is used at a slice level. For example, the syntax element nnpfa_slice_index[i] equal to a first value (such as 0 or the like) indicates that the NNPF may be not used for the i-th slice of a current picture. The syntax element nnpfa_slice_index[i] larger than the first value indicates that the NNPF with nnpfc_id equal to nnpfa_id[nnpfa_slice_index[i]−1] may be used for the i-th slice of the current picture. Alternatively, the syntax element nnpfa_slice_index[i] larger than the first value and smaller than a second value indicates that the NNPF with nnpfc_id equal to nnpfa_id[nnpfa_slice_index[i]−1] may be used for the i-th slice of the current picture. The second value may be determined based on the number of NNPFs, such as nnpfa_num_minus1+2 or the like. The syntax element nnpfa_slice_index[i] equal to the second value indicates that the NNPF may be allowed to be used for a sub-region of the i-th slice of the current picture.

In some embodiments, the subregion may be in sub block level, CTU level, CTB level, or patch level. A usage of the j-th sub-region of the i-th slice of the current picture may be indicated by a syntax element nnpfa_ctu_index[j], and j may be an integer. In some embodiments, a value of the syntax element nnpfa_slice_index[i] may be in a range determined based on the number of NNPFs, such as a range of 0 to nnpfa_num_minus1+2, inclusive.

In some embodiments, an NNPFA SEI message in the bitstream may comprise at least one syntax element indicating whether NNPF is used at a first region level corresponding to the first region type. In one example, a syntax element at the first region level may be dependent on a syntax element at a level higher than the first region level, such as a picture level, a slice level or the sequence level. In another example, a syntax element in the bitstream indicates whether NNPF is applied at the first region level.

In a further example, a syntax element in the bitstream indicates an index of an NNPF applied at the first region level. In a still further example, a syntax element in the bitstream indicates whether NNPF is applied at the first region level or a level lower than the first region level. In a still further example, a syntax element at a first region level corresponding to the first region type may be not indicated in the bitstream.

In some embodiments, the bitstream may comprise a syntax element nnpfa_region_enabling_flag[i] indicating a usage of NNPF at the first region level. For example, the syntax element nnpfa_region_enabling_flag[i] equal to a first value (such as 1 or the like) indicates that the NNPF may be used for the i-th region of a current picture, where i may be an integer. The syntax element nnpfa_region_enabling_flag[i] equal to a second value (such as 0 or the like) indicates that the NNPF may be not used for the i-th region of the current picture.

In some embodiments, the bitstream may comprise a syntax element nnpfa_region_index[i] indicating a usage of NNPF at the first region level. For example, the syntax element nnpfa_region_index[i] equal to a first value (such as 0 or the like) indicates that the NNPF may be not used for the i-th region of a current picture, where i may be an integer. The syntax element nnpfa_region_index[i] larger than the first value indicates that the NNPF with nnpfc_id equal to nnpfa_id[nnpfa_region_index[i]−1] may be used for the i-th region of a current picture. In some embodiments, a value of the syntax element nnpfa_region_index[i] may be in a range determined based on the number of NNPFs, such as the range of 0 to nnpfa_num_minus1+1, inclusive.

In some embodiments, the NNPFA SEI message may further comprise one or more syntax elements indicating dimension information and/or position information of at least one region at the first region level. In one example, the one or more syntax elements may comprise a second syntax element indicating horizontal samples or a width of the i-th region of the at least one region, where i may be an integer. By way of example rather than limitation, the second syntax element may be represented as nnpfa_region_width[i]. Additionally or alternatively, the one or more syntax elements may comprise a third syntax element indicating vertical samples or a height of the i-th region of the at least one region, and i may be an integer. By way of example rather than limitation, the third syntax element may be represented as nnpfa_region_height[i].

In a further example, the one or more syntax elements may comprise a fourth syntax element indicating a horizontal coordinate of a starting point of the i-th region of the at least one region, and i may be an integer. By way of example rather than limitation, the fourth syntax element may be represented as nnpfa_region_x0[i]. Additionally or alternatively, the one or more syntax elements may comprise a fifth syntax element indicating a vertical coordinate of a starting point of the i-th region of the at least one region, and i may be an integer. By way of example rather than limitation, the fifth syntax element may be represented as nnpfa_region_y0[i].

In some embodiments, the one or more syntax elements may comprise a sixth syntax element indicating a horizontal coordinate of an ending point of the i-th region of the at least one region, and i may be an integer. By way of example rather than limitation, the sixth syntax element may be represented as nnpfa_region_x1[i]. Additionally or alternatively, the one or more syntax elements may comprise a seventh syntax element indicating a vertical coordinate of an ending point of the i-th region of the at least one region, and i may be an integer. By way of example rather than limitation, the seventh syntax element may be represented as nnpfa_region_y1[i].

In some embodiments, the one or more syntax elements may comprise an eighth syntax element indicating whether all of the at least one region have a same dimension. By way of example rather than limitation, the eighth syntax element may be represented as nnpfa_region_dim_flag. For example, the eighth syntax element equal to a first value (such as 0 or the like) indicates that all of the at least one region have a same dimension. The eighth syntax element equal to a second value (such as 1 or the like) indicates that the at least one region have different dimensions.

In some embodiments, the one or more syntax elements may comprise a ninth syntax element indicating whether all of the at least one region may be overlapped. By way of example rather than limitation, the ninth syntax element may be represented as nnpfa_region_overlap_flag. For example, the ninth syntax element equal to a first value (such as 0 or the like) indicates that all of the at least one region may be overlapped. The ninth syntax element equal to a second value (such as 1 or the like) indicates that the at least one region may be overlapped.

According to further embodiments of the present disclosure, a non-transitory computer-readable recording medium is provided. The non-transitory computer-readable recording medium stores a bitstream of a video which is generated by a method performed by an apparatus for video processing. In the method, a conversion between the video and the bitstream is performed. At least one neural-network post-processing filter (NNPF) is applied on at least one video unit associated with the video, and the bitstream comprises a first indication indicating whether quality information of the at least one video unit associated with the applying of the at least one NNPF is present in the bitstream.

According to still further embodiments of the present disclosure, a method for storing bitstream of a video is provided. In the method, a conversion between the video and the bitstream is performed. At least one neural-network post-processing filter (NNPF) is applied on at least one video unit associated with the video, and the bitstream comprises a first indication indicating whether quality information of the at least one video unit associated with the applying of the at least one NNPF is present in the bitstream. Moreover, the bitstream is stored in a non-transitory computer-readable recording medium.

Implementations of the present disclosure can be described in view of the following clauses, the features of which can be combined in any reasonable manner.

Clause 1. A method for video processing, comprising: performing a conversion between a video and a bitstream of the video, wherein at least one neural-network post-processing filter (NNPF) is applied on at least one video unit associated with the video, and the bitstream comprises a first indication indicating whether quality information of the at least one video unit associated with the applying of the at least one NNPF is present in the bitstream.

Clause 2. The method of clause 1, wherein the quality information comprises at least one of the following: one or more metric types for measuring quality of the at least one video unit, one or more quality changes of the at least one video unit that correspond to the one or more metric types, each of the one or more quality changes being caused by the applying of the at least one NNPF and measured based on the corresponding metric type, or one or more quality values of the at least one video unit after the at least one NNPF being applied, the one or more quality values corresponding to the one or more metric types, and each of the one or more quality values being measured based on the corresponding metric type.

Clause 3. The method of any of clauses 1-2, wherein the first indication indicates that the quality information is present in the bitstream, and at least one indication indicating the quality information is present in the bitstream.

Clause 4. The method of any of clauses 1-3, wherein the at least one video unit comprises one of the following: a whole video sequence of the video, a single picture of the video, or a plurality of pictures of the video.

Clause 5. The method of any of clauses 2-4, wherein the one or more metric types comprise at least one of the following: peak signal-to-noise ratio (PSNR), structural similarity (SSIM), multi scale structural similarity (MS-SSIM), or video multi-method assessment fusion (VMAF).

Clause 6. The method of any of clauses 2-4, wherein one of the one or more quality changes is determined based on one of the following: a difference between quality of the at least one video unit after the at least one NNPF being applied and quality of the at least one video unit without the at least one NNPF being applied, or a difference between quality of the at least one video unit without the at least one NNPF being applied and quality of the at least one video unit after the at least one NNPF being applied.

Clause 7. The method of any of clauses 2-6, wherein the one or more metric types comprise a plurality of metric types, and the one or more quality changes comprise a plurality of quality changes.

Clause 8. The method of clause 7, wherein the bitstream comprises a second indication indicating the number of the plurality of metric types.

Clause 9. The method of clause 8, wherein at least one indication indicating the quality information follows the second indication in the bitstream.

Clause 10. The method of any of clauses 1-2, wherein the first indication indicates that the quality information is not present in the bitstream, and at least one indication indicating the quality information is not present in the bitstream.

Clause 11. The method of any of clauses 1-9, wherein at least one indication indicating the quality information is present in the bitstream independently from the first indication.

Clause 12. The method of any of clauses 2-11, wherein the at least one indication is comprised in a video message unit in the bitstream.

Clause 13. The method of clause 12, wherein the video message unit is a supplemental enhancement information (SEI) message.

Clause 14. The method of clause 13, wherein the SEI message is a neural-network post-filter activation (NNPFA) SEI message.

Clause 15. The method of any of clauses 1-14, wherein the bitstream further comprises at least one first syntax element indicating a type of the at least one video unit, and one of candidates for the type is a first region type different from a picture, a slice and a coding tree unit.

Clause 16. The method of clause 15, wherein if the type of the at least one video unit is the first region type, the at least one video unit comprises one or more regions.

Clause 17. The method of clause 16, wherein a region in the one or more regions is represented by information comprising at least one of the following: a dimension of the region, a position of the region, or a coordinate of the region.

Clause 18. The method of clause 17, wherein the dimension of the region comprises at least one of a width of the region or a height of the region, or a position of the region comprises at least one of a coordinate of a start point of the region or a coordinate of an end point of the region.

Clause 19. The method of any of clauses 16-18, wherein a region in the one or more regions is overlapped with a further region, or a region in the one or more regions is not overlapped with a further region.

Clause 20. The method of any of clauses 16-20, wherein all of the one or more regions have a same dimension.

Clause 21. The method of clause 20, wherein the same dimension is indicated in the bitstream.

Clause 22. The method of any of clauses 16-20, wherein the one or more regions have different dimensions.

Clause 23. The method of clause 22, wherein a dimension for each of the one or more regions is indicated in the bitstream.

Clause 24. The method of any of clauses 15-23, wherein if the at least one first syntax element is equal to a first value, no NNPF is applied for a current picture and/or a slice of the current picture and/or a CTU of the current picture, or an NNPF applied for the current picture is indicated, or if the at least one first syntax element is equal to a second value, no NNPF is applied for a sub-region of the current picture, or an NNPF applied for the current picture is indicated.

Clause 25. The method of clause 24, wherein the first value is 3, or the second value is 4.

Clause 26. The method of any of clauses 15-25, wherein a value of the at least one first syntax element is in a first predetermined range, and values of the at least one first syntax element greater than a third value are reserved and absent from the bitstream.

Clause 27. The method of clause 26, wherein an NNPFA SEI message with the at least one first syntax element greater than the third value is ignored.

Clause 28. The method of any of clauses 26-27, wherein the first predetermined range is from 0 to 31, or the third value is one of 2, 3, or 4.

Clause 29. The method of any of clauses 1-28, wherein a syntax element nnpfa_picture_enabling_flag[i] in an NNPFA SEI message in the bitstream indicates a usage of NNPF at a picture level.

Clause 30. The method of clause 29, wherein only one NNPF is indicated by a syntax element nnpfa_id in the NNPFA SEI message.

Clause 31. The method of any of clauses 1-28, wherein a syntax element nnpfa_picture_index[i] in an NNPFA SEI message in the bitstream indicates a usage of NNPF at a picture level.

Clause 32. The method of clause 31, wherein one or more NNPFs are indicated by a syntax element nnpfa_id[i] in the NNPFA SEI message.

Clause 33. The method of any of clauses 1-32, wherein a syntax element nnpfa_slice_enabling_flag[i] in an NNPFA SEI message in the bitstream indicates a usage of NNPF at a slice level, and only one NNPF is indicated by a syntax element nnpfa_id in the NNPFA SEI message.

Clause 34. The method of any of clauses 1-23, wherein a syntax element nnpfa_slice_index[i] in an NNPFA SEI message in the bitstream indicates a usage of NNPF at a slice level, and one or more NNPFs are indicated by a syntax element nnpfa_id[i] in the NNPFA SEI message.

Clause 35. The method of any of clauses 1-34, wherein a syntax element nnpfa_ctu_enabling_flag[i] in an NNPFA SEI message in the bitstream indicates a usage of NNPF at a coding tree unit (CTU) level, and only one NNPF is indicated by a syntax element nnpfa_id in the NNPFA SEI message.

Clause 36. The method of any of clauses 1-35, wherein a syntax element nnpfa_ctu_index[i] in an NNPFA SEI message in the bitstream indicates a usage of NNPF at a CTU level, and one or more

NNPFs are indicated by a syntax element nnpfa_id[i] in the NNPFA SEI message.

Clause 37. The method of any of clauses 15-36, wherein if the type of the at least one video unit is the first region type, an NNPFA SEI message in the bitstream comprises a syntax element indicating activation of the at least one NNPF at a region level.

Clause 38. The method of clause 37, wherein a syntax element nnpfa_region_enabling_flag[i] in the NNPFA SEI message indicates a usage of NNPF at the region level.

Clause 39. The method of clause 38, wherein only one NNPF is indicated by a syntax element nnpfa_id in the NNPFA SEI message.

Clause 40. The method of clause 37, wherein a syntax element nnpfa_region_index[i] in an NNPFA SEI message in the bitstream indicates a usage of NNPF at the region level.

Clause 41. The method of clause 40, wherein one or more NNPFs are indicated by a syntax element nnpfa_id[i] in the NNPFA SEI message.

Clause 42. The method of any of clauses 15-41, wherein if the at least one first syntax element is equal to a fourth value, at least one of a syntax element nnpfa_picture_index[i] or a syntax element nnpfa_picture_enabling_flag[i] is indicated in the bitstream, or if the at least one first syntax element is equal to a fifth value, at least one of a syntax element nnpfa_slice_index[i] or a syntax element nnpfa_slice_enabling_flag[i] is indicated in the bitstream, or if the at least one first syntax element is equal to a sixth value, at least one of a syntax element nnpfa_ctu_index[i] or a syntax element nnpfa_ctu_enabling_flag[i] is indicated in the bitstream, or if the at least one first syntax element is equal to a seventh value, a syntax element nnpfa_region_index[i] is indicated in the bitstream.

Clause 43. The method of clause 42, wherein the fourth value is 0 or 3, or the fifth value is 1 or 3, or the sixth value is 2 or 3, or the seventh value is 4.

Clause 44. The method of any of clauses 1-43, wherein a syntax element indicating whether NNPF is used in current region is required to be smaller than an eighth value, the eight value being determined based on the number of NNPFs.

Clause 45. The method of clause 44, wherein a syntax element indicating whether NNPF is used in a subregion of the current region equal to the eighth value indicates that the NNPF is used in the subregion.

Clause 46. The method of clause 45, wherein the syntax element is nnpfa_slice_index[i] or nnpfa_ctu_index[i].

Clause 47. The method of any of clauses 1-46, wherein the bitstream comprises a syntax element nnpfa_picture_enabling_flag indicating whether NNPF is used at a picture level.

Clause 48. The method of clause 47, wherein the syntax element nnpfa_picture_enabling_flag equal to a first value indicates that the NNPF is used for a subregion of a current picture, or the syntax element nnpfa_picture_enabling_flag equal to a second value indicates that the NNPF is used for the current picture, or the syntax element nnpfa_picture_enabling_flag equal to a third value indicates that the NNPF is not used for the current picture.

Clause 49. The method of clause 48, wherein the subregion is in slice level, sub block level, CTU level, coding tree block (CTB) level, or patch level.

Clause 50. The method of any of clauses 48-49, wherein i is an integer, and a usage of the i-th subregion of the current picture is indicated by one of the following: a syntax element nnpfa_slice_enabling_flag[i], a syntax element nnpfa_ctu_enabling_flag[i], or a syntax element nnpfa_region_enabling_flag[i].

Clause 51. The method of any of clauses 48-50, wherein the first value is 2, the second value is 1, or the third value is 0.

Clause 52. The method of any of clauses 1-46, wherein the bitstream comprises a syntax element nnpfa_picture_index indicating whether NNPF is used at a picture level.

Clause 53. The method of clause 52, wherein the syntax element nnpfa_picture_index equal to a first value indicates that the NNPF is not used for a current picture, or the syntax element nnpfa_picture_index larger than the first value indicates that the NNPF with nnpfc_id equal to nnpfa_id[nnpfa_picture_index−1] is used for the current picture, or the syntax element nnpfa_picture_index larger than the first value and smaller than a second value indicates that the NNPF with nnpfc_id equal to nnpfa_id[nnpfa_picture_index−1] is used for the current picture, the second value being determined based on the number of NNPFs, or the syntax element nnpfa_picture_index equal to the second value indicates that the NNPF is allowed to be used for a sub-region of the current picture.

Clause 54. The method of clause 53, wherein the first value is 0.

Clause 55. The method of any of clauses 53-54, wherein the subregion is in slice level, sub block level, CTU level, CTB level, or patch level.

Clause 56. The method of any of clauses 53-55, wherein a usage of the i-th subregion of the current picture is indicated by one of the following: a syntax element nnpfa_slice_index[i], a syntax element nnpfa_ctu_index[i], or a syntax element nnpfa_region_index[i].

Clause 57. The method of any of clauses 52-56, wherein a value of the syntax element nnpfa_picture_index is in a range determined based on the number of NNPFs.

Clause 58. The method of any of clauses 1-46, wherein a syntax element nnpfa_slice_enabling_flag[i] in the bitstream equal to a first value indicates that NNPF is used for a sub-region of the i-th slice of a current picture, and i is an integer.

Clause 59. The method of clause 58, wherein the subregion is in sub block level, CTU level, CTB level, or patch level.

Clause 60. The method of any of clauses 58-59, wherein the bitstream comprises a syntax element nnpfa_ctu_enabling_flag[j] indicating a usage of the j-th sub-region of the i-th slice of the current picture, and j is an integer.

Clause 61. The method of any of clauses 1-46, wherein the bitstream comprises a syntax element nnpfa_slice_index[i] indicating whether NNPF is used at a slice level.

Clause 62. The method of clause 61, wherein the syntax element nnpfa_slice_index[i] equal to a first value indicates that the NNPF is not used for the i-th slice of a current picture, or the syntax element nnpfa_slice_index[i] larger than the first value indicates that the NNPF with nnpfc_id equal to nnpfa_id[nnpfa_slice_index[i]−1] is used for the i-th slice of the current picture, or the syntax element nnpfa_slice_index[i] larger than the first value and smaller than a second value indicates that the NNPF with nnpfc_id equal to nnpfa_id[nnpfa_slice_index[i]−1] is used for the i-th slice of the current picture, the second value being determined based on the number of NNPFs, or the syntax element nnpfa_slice_index[i] equal to the second value indicates that the NNPF is allowed to be used for a sub-region of the i-th slice of the current picture.

Clause 63. The method of clause 62, wherein the first value is 0.

Clause 64. The method of any of clauses 62-63, wherein the subregion is in sub block level, CTU level, CTB level, or patch level.

Clause 65. The method of any of clauses 62-64, wherein a usage of the j-th sub-region of the i-th slice of the current picture is indicated by a syntax element nnpfa_ctu_index[j], and j is an integer.

Clause 66. The method of any of clauses 61-65, wherein a value of the syntax element nnpfa_slice_index[i] is in a range determined based on the number of NNPFs.

Clause 67. The method of any of clauses 15-66, wherein an NNPFA SEI message in the bitstream comprises at least one syntax element indicating whether NNPF is used at a first region level corresponding to the first region type.

Clause 68. The method of clause 67, wherein a syntax element at the first region level is dependent on a syntax element at a level higher than the first region level.

Clause 69. The method of any of clauses 67-68, wherein a syntax element in the bitstream indicates whether NNPF is applied at the first region level.

Clause 70. The method of any of clauses 67-69, wherein a syntax element in the bitstream indicates an index of an NNPF applied at the first region level.

Clause 71. The method of any of clauses 67-70, wherein a syntax element in the bitstream indicates whether NNPF is applied at the first region level or a level lower than the first region level.

Clause 72. The method of any of clauses 15-66, wherein a syntax element at a first region level corresponding to the first region type is not indicated in the bitstream.

Clause 73. The method of any of clauses 67-71, wherein the bitstream comprises a syntax element nnpfa_region_enabling_flag[i] indicating a usage of NNPF at the first region level.

Clause 74. The method of clause 73, wherein the syntax element nnpfa_region_enabling_flag[i] equal to a first value indicates that the NNPF is used for the i-th region of a current picture, i being an integer, or the syntax element nnpfa_region_enabling_flag[i] equal to a second value indicates that the NNPF is not used for the i-th region of the current picture, i being an integer.

Clause 75. The method of clause 74, wherein the first value is 1, and the second value is 0.

Clause 76. The method of any of clauses 67-71, wherein the bitstream comprises a syntax element nnpfa_region_index[i] indicating a usage of NNPF at the first region level.

Clause 77. The method of clause 76, wherein the syntax element nnpfa_region_index[i] equal to a first value indicates that the NNPF is not used for the i-th region of a current picture, i being an integer, or the syntax element nnpfa_region_index[i] larger than the first value indicates that the NNPF with nnpfc_id equal to nnpfa_id[nnpfa_region_index[i]-1] is used for the i-th region of a current picture.

Clause 78. The method of clause 77, wherein the first value is 0.

Clause 79. The method of any of clauses 76-78, wherein a value of the syntax element nnpfa_region_index[i] is in a range determined based on the number of NNPFs.

Clause 80. The method of any of clauses 67-79, wherein the NNPFA SEI message further comprises one or more syntax elements indicating at least one of dimension information or position information of at least one region at the first region level.

Clause 81. The method of clause 80, wherein the one or more syntax elements comprises a second syntax element indicating horizontal samples or a width of the i-th region of the at least one region, and i is an integer.

Clause 82. The method of clause 81, wherein the second syntax element is represented as nnpfa_region_width[i].

Clause 83. The method of any of clauses 80-82, wherein the one or more syntax elements comprises a third syntax element indicating vertical samples or a height of the i-th region of the at least one region, and i is an integer.

Clause 84. The method of clause 83, wherein the third syntax element is represented as nnpfa_region_height[i].

Clause 85. The method of any of clauses 80-84, wherein the one or more syntax elements comprises a fourth syntax element indicating a horizontal coordinate of a starting point of the i-th region of the at least one region, and i is an integer.

Clause 86. The method of clause 85, wherein the fourth syntax element is represented as nnpfa_region_x0[i].

Clause 87. The method of any of clauses 80-86, wherein the one or more syntax elements comprises a fifth syntax element indicating a vertical coordinate of a starting point of the i-th region of the at least one region, and i is an integer.

Clause 88. The method of clause 87, wherein the fifth syntax element is represented as nnpfa_region_y0[i].

Clause 89. The method of any of clauses 80-88, wherein the one or more syntax elements comprises a sixth syntax element indicating a horizontal coordinate of an ending point of the i-th region of the at least one region, and i is an integer.

Clause 90. The method of clause 89, wherein the sixth syntax element is represented as nnpfa_region_x1[i].

Clause 91. The method of any of clauses 80-90, wherein the one or more syntax elements comprises a seventh syntax element indicating a vertical coordinate of an ending point of the i-th region of the at least one region, and i is an integer.

Clause 92. The method of clause 91, wherein the seventh syntax element is represented as nnpfa_region_y1[i].

Clause 93. The method of any of clauses 80-92, wherein the one or more syntax elements comprises an eighth syntax element indicating whether all of the at least one region have a same dimension.

Clause 94. The method of clause 93, wherein the eighth syntax element is represented as nnpfa_region_dim_flag.

Clause 95. The method of any of clauses 93-94, wherein the eighth syntax element equal to a first value indicates that all of the at least one region have a same dimension, or the eighth syntax element equal to a second value indicates that the at least one region have different dimensions.

Clause 96. The method of clause 95, wherein the first value is 0, or the second value is 1.

Clause 97. The method of any of clauses 80-96, wherein the one or more syntax elements comprises a ninth syntax element indicating whether all of the at least one region are overlapped.

Clause 98. The method of clause 97, wherein the ninth syntax element is represented as nnpfa_region_overlap_flag.

Clause 99. The method of any of clauses 97-98, wherein the ninth syntax element equal to a first value indicates that all of the at least one region are overlapped, or the ninth syntax element equal to a second value indicates that the at least one region are overlapped.

Clause 100. The method of clause 99, wherein the first value is 0, or the second value is 1.

Clause 101. The method of any of clauses 1-100, wherein the conversion includes encoding the video into the bitstream.

Clause 102. The method of any of clauses 1-100, wherein the conversion includes decoding the video from the bitstream.

Clause 103. An apparatus for video processing comprising a processor and a non-transitory memory with instructions thereon, wherein the instructions upon execution by the processor, cause the processor to perform a method in accordance with any of clauses 1-102.

Clause 104. A non-transitory computer-readable storage medium storing instructions that cause a processor to perform a method in accordance with any of clauses 1-102.

Clause 105. A non-transitory computer-readable recording medium storing a bitstream of a video which is generated by a method performed by an apparatus for video processing, wherein the method comprises: performing a conversion between the video and the bitstream, wherein at least one neural-network post-processing filter (NNPF) is applied on at least one video unit associated with the video, and the bitstream comprises a first indication indicating whether quality information of the at least one video unit associated with the applying of the at least one NNPF is present in the bitstream.

Clause 106. A method for storing a bitstream of a video, comprising: performing a conversion between the video and the bitstream, wherein at least one neural-network post-processing filter (NNPF) is applied on at least one video unit associated with the video, and the bitstream comprises a first indication indicating whether quality information of the at least one video unit associated with the applying of the at least one NNPF is present in the bitstream; and storing the bitstream in a non-transitory computer-readable recording medium.

### Example Device

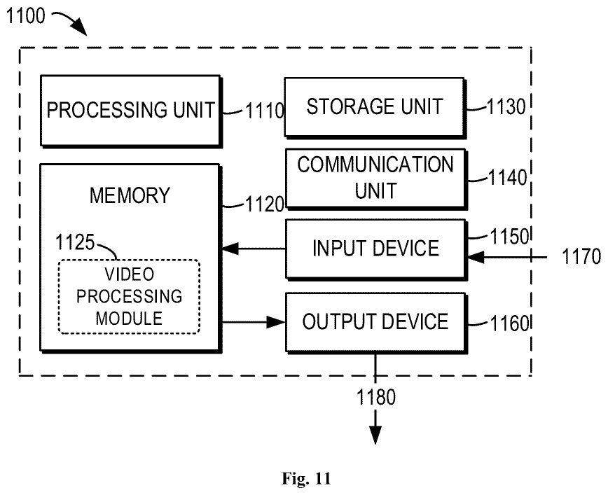

FIG. 11 illustrates a block diagram of a computing device 1100 in which various embodiments of the present disclosure can be implemented. The computing device 1100 may be implemented as or included in the source device 110 (or the video encoder 114 or 200) or the destination device 120 (or the video decoder 124 or 300).

It would be appreciated that the computing device 1100 shown in FIG. 11 is merely for purpose of illustration, without suggesting any limitation to the functions and scopes of the embodiments of the present disclosure in any manner.

As shown in FIG. 11, the computing device 1100 includes a general-purpose computing device

1100. The computing device 1100 may at least comprise one or more processors or processing units 1110, a memory 1120, a storage unit 1130, one or more communication units 1140, one or more input devices 1150, and one or more output devices 1160.

In some embodiments, the computing device 1100 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 1100 can support any type of interface to a user (such as “wearable” circuitry and the like).

The processing unit 1110 may be a physical or virtual processor and can implement various processes based on programs stored in the memory 1120. In a multi-processor system, multiple processing units execute computer executable instructions in parallel so as to improve the parallel processing capability of the computing device 1100. The processing unit 1110 may also be referred to as a central processing unit (CPU), a microprocessor, a controller or a microcontroller.

The computing device 1100 typically includes various computer storage medium. Such medium can be any medium accessible by the computing device 1100, including, but not limited to, volatile and non-volatile medium, or detachable and non-detachable medium. The memory 1120 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 1130 may be any detachable or non-detachable medium and may include a machine-readable medium such as a memory, flash memory drive, magnetic disk or another other media, which can be used for storing information and/or data and can be accessed in the computing device 1100.

The computing device 1100 may further include additional detachable/non-detachable, volatile/non-volatile memory medium. Although not shown in FIG. 11, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 1140 communicates with a further computing device via the communication medium. In addition, the functions of the components in the computing device 1100 can be implemented by a single computing cluster or multiple computing machines that can communicate via communication connections. Therefore, the computing device 1100 can operate in a networked environment using a logical connection with one or more other servers, networked personal computers (PCs) or further general network nodes.

The input device 1150 may be one or more of a variety of input devices, such as a mouse, keyboard, tracking ball, voice-input device, and the like. The output device 1160 may be one or more of a variety of output devices, such as a display, loudspeaker, printer, and the like. By means of the communication unit 1140, the computing device 1100 can further communicate with one or more external devices (not shown) such as the storage devices and display device, with one or more devices enabling the user to interact with the computing device 1100, or any devices (such as a network card, a modem and the like) enabling the computing device 1100 to communicate with one or more other computing devices, if required. Such communication can be performed via input/output (I/O) interfaces (not shown).

In some embodiments, instead of being integrated in a single device, some or all components of the computing device 1100 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 1100 may be used to implement video encoding/decoding in embodiments of the present disclosure. The memory 1120 may include one or more video coding modules 1125 having one or more program instructions. These modules are accessible and executable by the processing unit 1110 to perform the functionalities of the various embodiments described herein.

In the example embodiments of performing video encoding, the input device 1150 may receive

video data as an input 1170 to be encoded. The video data may be processed, for example, by the video coding module 1125, to generate an encoded bitstream. The encoded bitstream may be provided via the output device 1160 as an output 1180.

In the example embodiments of performing video decoding, the input device 1150 may receive an encoded bitstream as the input 1170. The encoded bitstream may be processed, for example, by the video coding module 1125, to generate decoded video data. The decoded video data may be provided via the output device 1160 as the output 1180.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

I/we claim:

1. A method for video processing, comprising:
performing a conversion between a video and a bitstream of the video, wherein at least one neural-network post-processing filter (NNPF) is applied on at least one video unit associated with the video, and the bitstream comprises a first indication indicating whether quality information of the at least one video unit associated with the applying of the at least one NNPF is present in the bitstream.

2. The method of claim 1, wherein the quality information comprises at least one of the following:
one or more metric types for measuring quality of the at least one video unit,
one or more quality changes of the at least one video unit that correspond to the one or more metric types, each of the one or more quality changes being caused by the applying of the at least one NNPF and measured based on the corresponding metric type, or
one or more quality values of the at least one video unit after the at least one NNPF being applied, the one or more quality values corresponding to the one or more metric types, and each of the one or more quality values being measured based on the corresponding metric type.

3. The method of claim 1, wherein the first indication indicates that the quality information is present in the bitstream, and at least one indication indicating the quality information is present in the bitstream.

4. The method of claim 1, wherein the at least one video unit comprises one of the following:
a whole video sequence of the video,
a single picture of the video, or
a plurality of pictures of the video.

5. The method of claim 2, wherein the one or more metric types comprise at least one of the following:
peak signal-to-noise ratio (PSNR), structural similarity (SSIM), multi scale structural similarity (MS-SSIM), or video multi-method assessment fusion (VMAF), or
wherein one of the one or more quality changes is determined based on one of the following: a difference between quality of the at least one video unit after the at least one NNPF being applied and quality of the at least one video unit without the at least one NNPF being applied, or a difference between quality of the at least one video unit without the at least one NNPF being applied and quality of the at least one video unit after the at least one NNPF being applied.

6. The method of claim 2, wherein the one or more metric types comprise a plurality of metric types, and the one or more quality changes comprise a plurality of quality changes.

7. The method of claim 6, wherein the bitstream comprises a second indication indicating the number of the plurality of metric types.

8. The method of claim 7, wherein at least one indication indicating the quality information follows the second indication in the bitstream.

9. The method of claim 1, wherein the first indication indicates that the quality information is not present in the bitstream, and at least one indication indicating the quality information is not present in the bitstream.

10. The method of claim 1, wherein at least one indication indicating the quality information is present in the bitstream independently from the first indication.

11. The method of claim 2, wherein the at least one indication is comprised in a video message unit in the bitstream.

12. The method of claim 11, wherein the video message unit is a supplemental enhancement information (SEI) message.

13. The method of claim 12, wherein the SEI message is a neural-network post-filter activation (NNPFA) SEI message.

14. The method of claim 1, wherein the bitstream further comprises at least one first syntax element indicating a type of the at least one video unit, and one of candidates for the type is a first region type different from a picture, a slice and a coding tree unit, or
wherein a syntax element nnpfa_picture_enabling_flag[i] in an NNPFA SEI message in the bitstream indicates a usage of NNPF at a picture level, or
wherein a syntax element nnpfa_picture_index[i] in an NNPFA SEI message in the bitstream indicates a usage of NNPF at a picture level, or
wherein a syntax element nnpfa_slice_enabling_flag[i] in an NNPFA SEI message in the bitstream indicates a usage of NNPF at a slice level, and only one NNPF is indicated by a syntax element nnpfa_id in the NNPFA SEI message, or
wherein a syntax element nnpfa_slice_index[i] in an NNPFA SEI message in the bitstream indicates a usage of NNPF at a slice level, and one or more NNPFs are indicated by a syntax element nnpfa_id[i] in the NNPFA SEI message, or
wherein a syntax element nnpfa_ctu_enabling_flag[i] in an NNPFA SEI message in the bitstream indicates a usage of NNPF at a coding tree unit (CTU) level, and only one NNPF is indicated by a syntax element nnpfa_id in the NNPFA SEI message, or
wherein a syntax element nnpfa_ctu_index[i] in an NNPFA SEI message in the bitstream indicates a usage of NNPF at a CTU level, and one or more NNPFs are indicated by a syntax element nnpfa_id[i] in the NNPFA SEI message.

15. The method of claim 1, wherein a syntax element indicating whether NNPF is used in current region is required to be smaller than an eighth value, the eight value being determined based on the number of NNPFs, or
wherein the bitstream comprises a syntax element nnpfa picture_enabling_flag indicating whether NNPF is used at a picture level, or
wherein the bitstream comprises a syntax element nnpfa picture_index indicating whether NNPF is used at a picture level, or
wherein a syntax element nnpfa_slice_enabling_flag[i] in the bitstream equal to a first value indicates that NNPF is used for a sub-region of the i-th slice of a current picture, and i is an integer, or
wherein the bitstream comprises a syntax element nnpfa_slice_index[i] indicating whether NNPF is used at a slice level.

16. The method of claim 1, wherein the conversion includes encoding the video into the bitstream.

17. The method of claim 1, wherein the conversion includes decoding the video from the bitstream.

18. An apparatus for video processing comprising a processor and a non-transitory memory with instructions thereon, wherein the instructions upon execution by the processor, cause the processor to perform acts comprising:
performing a conversion between a video and a bitstream of the video, wherein at least one neural-network post-processing filter (NNPF) is applied on at least one video unit associated with the video, and the bitstream comprises a first indication indicating whether quality information of the at least one video unit associated with the applying of the at least one NNPF is present in the bitstream.

19. A non-transitory computer-readable storage medium storing instructions that cause a processor to perform acts comprising:
performing a conversion between a video and a bitstream of the video, wherein at least one neural-network post-processing filter (NNPF) is applied on at least one video unit associated with the video, and the bitstream comprises a first indication indicating whether quality information of the at least one video unit associated with the applying of the at least one NNPF is present in the bitstream.

20. A non-transitory computer-readable recording medium storing a bitstream of a video which is generated by a method performed by an apparatus for video processing, wherein the method comprises:
performing a conversion between the video and the bitstream, wherein at least one neural-network post-processing filter (NNPF) is applied on at least one video unit associated with the video, and the bitstream comprises a first indication indicating whether quality information of the at least one video unit associated with the applying of the at least one NNPF is present in the bitstream.
